(19) United States
(12) Patent Application Publication
(10) Pub. No.: US 2025/0006019 A1
(43) Pub. Date: Jan. 2, 2025

(54) Ultrasonic Transducer Array Transmission Techniques

(71) Applicant: Ultraleap Limited, Bristol (GB)

(72) Inventors: Benjamin John Oliver Long, Bristol (GB); Rob Malkin, Bristol (GB); Brian Kappus, Campbell, CA (US); Hanson Bharth, Bristol (GB); Andrew Hart, Bristol (GB)

(21) Appl. No.: 18/746,275

(22) Filed: Jun. 18, 2024

Related U.S. Application Data
(60) Provisional application No. 63/646,592, filed on May 13, 2024.
(60) Provisional application No. 63/646,267, filed on May 13, 2024.
(60) Provisional application No. 63/637,233, filed on Apr. 22, 2024.
(60) Provisional application No. 63/637,086, filed on Apr. 22, 2024.
(60) Provisional application No. 63/636,562, filed on Apr. 19, 2024.
(60) Provisional application No. 63/572,717, filed on Apr. 1, 2024.
(60) Provisional application No. 63/509,202, filed on Jun. 20, 2023.

(51) Int. Cl. G08B 6/00

(52) U.S. Cl. CPC G08B 6/00

(57) ABSTRACT

Reducing the maximum output of transducers near boundaries is described. In further refinements, the distribution of the transducer's maximum amplitude is determined by analyzing the Fourier dual of band-limited functions. This enables the Gibbs phenomena, or side lobes, to be effectively mitigated. Further, apodization is used to adjust transducer amplitudes, which in the context of emitting phased arrays, yields output with specific side lobe structure. A modification to the general principles of the method of apodization that are capable of working around transducer limitation will be described. Further, a shared horn structure modifies the distribution of acoustic power over emission angle from a group of transducers. The structure is passive in nature and is shared with multiple transducers, redirecting the acoustic power from multiple transducers into a certain area, reducing the required number of transducers to achieve a required acoustic pressure in a certain area thereby reducing the cost of the system. Further, constructing an approach that creates regions of low amplitude in the acoustic field is commercially interesting, as it is necessary to reduce background levels sufficiently to result in total elimination of ultrasonic interference in desired locations. Using the technique of specifying “null points,” control points of zero desired field, are a way to eliminate ultrasonic energy at a specific point and reduce ultrasonic interference in the neighbor of such a point. Further, suppression techniques may be used to tamp down unintended fringing fields from high levels of ultrasound.

### RELATED APPLICATIONS

This application claims the benefit of the following seven U.S. Provisional Patent Applications, each of which is incorporated by reference in its entirety:
1. U.S. Provisional Ser. No. 63/509,202, filed on Jun. 20, 2023;
2. U.S. Provisional Ser. No. 63/572,717, filed on Apr. 1, 2024;
3. U.S. Provisional Ser. No. 63/636,562, filed on Apr. 19, 2024;
4. U.S. Provisional Ser. No. 63/637,086, filed on Apr. 22, 2024;
5. U.S. Provisional Ser. No. 63/637,233, filed on Apr. 22, 2024;
6. U.S. Provisional Ser. No. 63/646,267, filed on May 13, 2024; and
7. U.S. Provisional Ser. No. 63/646,592, filed on May 13, 2024

### FIELD OF THE DISCLOSURE

This application is directed to various forms and functions of ultrasonic transducer array techniques used in an ultrasonic transducer system that produces mid-air haptic effects.

### BACKGROUND

A mid-air haptic feedback system creates tactile sensations in the air. One way to create mid-air haptic feedback is using ultrasound. A phased array of ultrasonic transducers is used to exert an acoustic radiation force on a target. This continuous distribution of sound energy, which will be referred to herein as an “acoustic field”, is useful for a range of applications, including haptic feedback.

It is known to control an acoustic field by defining one or more control points in a space within which the acoustic field may exist. Each control point is assigned an amplitude value equating to a desired amplitude of the acoustic field at the control point. Transducers are then controlled to create an acoustic field exhibiting the desired amplitude at each of the control points.

Tactile sensations on human skin can be created by using a phased array of ultrasound transducers to exert an acoustic radiation force on a target in mid-air. Ultrasound waves are transmitted by the transducers, with the phase emitted by each transducer adjusted such that the waves arrive concurrently at the target point in order to maximize the acoustic radiation force exerted.

Specifically, a phased array of at least two ultrasonic transducers is described for exerting an acoustic field to at least one control point in midair, where phases from ultrasonic waves having side lobes emitted by the at least two ultrasonic transducers are adjusted such that the ultrasonic waves arrive concurrently at the at least one control point.

### SUMMARY

Nonlinear distortion present in the signal chain of various types of acoustic microphones can produce audible-frequency signals when exposed to inaudible-frequency ultrasound. These microphones exist in a wide variety of applications such as smartphones and hearing aids. This distortion is widely varied in character and depends on the specifics of both the source of ultrasound and the specifics of the microphone and signal chain. This effect is henceforth named “ultrasonic interference” and represents a potential barrier for widespread adoption of high-intensity airborne ultrasound applications such as mid-air haptics and acoustic levitation. Ultrasonic interference occurs when a susceptible microphone is in the vicinity of a region of high ultrasonic energy, even if the microphone is not sensitive to the ultrasonic range and typically scales in magnitude relative to the ultrasonic level.

Most sophisticated applications of high-intensity airborne ultrasound such as mid-air haptics and acoustic levitation require the use of a phased array of ultrasonic transducers. In these applications, the phased array of transducers produces an acoustic force, albeit fundamentally different for each, which generates the desired effect. In mid-air haptics, the force generated causes a user to perceive contact on their hand, and for the force to be perceivable, the ultrasonic energy must be at sufficiently high levels. A typical use case for mid-air haptics in an automotive setting might be for instance to control the central infotainment system. In this example an ultrasonic array may be embedded within the vehicle and a user may receive haptic feedback to signal a navigation option or to confirm selection. To generate mid-air haptics, a localized region of high ultrasonic energy is required which results in a background field that also receives reduced but still significant ultrasound energy. In order to make a highly directive interaction zone for mid-air haptics an array of ultrasonic transducers is used as the acoustic source. Returning to the example, the user in the cabin of a vehicle may be subject to ultrasonic interference if they have an actively listening microphone which is susceptible to it. This disclosure outlines a method to mitigate the leakage of high energy ultrasound by manipulating the acoustic field emitted from the array by considering the distribution of the transducer's amplitudes.

The acoustic field radiating from an array of ultrasonic transducers depends on the array layout as well as the amplitude and phase of the ultrasound emitted by the transducers. There are two main causes for high energy noise in the fringing field, the first is side lobes and the second is grating lobes. Side lobes arise from the discontinuities in the energy emitted from the array, which includes the edge transducers and its surroundings i.e. the area surrounding an ultrasonic array may be thought of as transducers with zero amplitude. Side lobe behavior is due to the Gibbs phenomena which refers to the oscillations that occur when taking a Fourier transform of a discontinuity, as a Fourier transform is a necessary part of the mathematical description of the emitted field. Grating lobes, on the other hand, are caused by the effects of diffraction and therefore arise due to the insufficient density of the field sampling by transducers over a surface area and may be eliminated by ensuring the elements are critically spaced. (Critical spacing, or spatial Nyquist, is where inter-element spacing, d, is less than or equal to half a wavelength, d≤λ/2=(½)c/f, where c is the speed of sound in the medium and f is the carrier frequency.)

If one considers only critically spaced periodic array layouts, then the acoustic field is determined by the Fourier transform of the transducer's collective amplitude and phase. Therefore, a method has been developed to control the acoustic field emitted by the array by considering the Fourier dual of band-limited functions.

In a critically spaced periodic array of ultrasonic transducers the background acoustic field produced is defined by the Fourier transform of the transducer's collective amplitude and phase. To reduce the unwanted ultrasonic interference, the amount of the field receiving high energy ultrasound must be reduced while maintaining the quality of the focus.

The solution presented here reduces the maximum output of transducers near boundaries. In further refinements, the distribution of the transducer's maximum amplitude is determined by analyzing the Fourier dual of band-limited functions. This enables the Gibbs phenomena, or side lobes, to be effectively mitigated. A Gibbs metric has been defined as the mean of the side lobes, which illustrates the effectiveness of each amplitude tapering distribution for reducing Gibbs phenomena.

Further, in particular, apodization is a method used to shape the output field generated by a phased array such that side lobe energy is reduced. In general side lobe energy, if it is sufficiently powerful, may generate unwanted ultrasonic interference in the context of phased array of ultrasonic transducers, such as those used in the creation of ultrasonically driven haptics, which includes haptics in mid-air. Additionally, significant energy output may be required at one or more focal points and apodizing reduces this output at the foci, as apodization reduces the total emitted power. In particular, applications may necessitate that some spatial regions require less interference than others while also producing a relatively high energy density at the focus. In essence, these applications require that some regions of space be energy dense (foci), some regions of space be substantially free of acoustic energy (a null point, space or region), and some regions of space have negligible acoustic energy.

An apodization of the phased array output by applying a spatial function whose Fourier dual is band limited in spatial frequency as a modulation by design yields substantial reductions in side lobes and thus suppresses noise, however, it also reduces the maximum output an array may generate and influences the shape of the resulting foci and field. A suitable apodization function must be chosen to be band limited in space, so as to be representable with minimal error when applied to a physically finite array of ultrasonic transducers. In some applications, one may require only some regions to be quiescent, so an optimal reduction of the apodization to allow side lobe energy in other locations may be apt to maximize the emitted power from the array and thus enable high energy density to be produced in the focal region while also reducing unwanted interference in these zones.

In this disclosure, a method to solve this problem by only apodizing in the direction orthogonal to an intended null region, a zone in which low energy density is desired, is described. This approach allows us to achieve higher noise suppression for the quiet region than any previously developed method, where this is defined as the contrast, which may be measured in decibels, between the focal region and the desired low energy density zone.

Apodization is a method to taper element amplitudes to suppress side lobe levels in phased array systems. This existing method has been successful in reducing ambient interference substantially, however, energy at the foci is also reduced substantially. This may be partly ameliorated by rescaling the amplitudes of the signals output by the transducer elements, but physical constraints lead to clipped solutions if the prescribed output is larger than the maximum allowable drive in the physical system. These clipped solutions can introduce new discontinuities that raise the background field due to the Gibbs phenomenon again, and so must be avoided. In this disclosure, a method to maximize foci pressure by only applying an apodization on necessary regions on the surface of the array is described.

Null points may reduce the interference in a chosen region by assembling a set of control points in the region and solving a linear system to derive the element amplitudes to achieve a given pressure at one or more foci while having substantially zero output at the one or more null points (a set of zero pressure control points) to effect reduced interference (theoretically to zero at one or more exact points, while also lowering levels nearby) in the quiet region. Although this approach achieves the required objective, creating a null region in this way is computationally costly; the computational cost scales quickly with the size of the null region, as the region must be sampled effectively by null points to effectively reduce the unwanted ambient field within the region. This means there is an implied requirement that the region is small to allow the computational cost to be tractable, so in the physical system where the small region is occupied by an object sensitive to ultrasonic interference, this requires any such object to be spatially tracked in time through the physical space to high precision. This makes this existing approach difficult to commercially exploit, due to the added complexity of the high-fidelity object tracking system in the loop.

In contrast, targeted apodization, the technique described in this disclosure, eliminates the need for the deployment of a method with high computational cost, enables less precise or no spatial tracking and extends the null region to an open arc from the array as can be seen in FIGS. 20A and 20B, described further below.

Thus, apodization is a method to suppress side lobe levels from an ultrasonic array by tapering element amplitudes, as well as reducing the pressure the array can produce. This disclosure develops an approach to only apodize where necessary, typically in the orthogonal direction of a desired quiet region, which lessens the reduction in pressure output. This is illustrated for several different positions of quiet regions and also superpositions of multiple quiet regions.

Apodization is a method used to shape the output field such that side lobe energy is reduced. This side lobe energy, if it is sufficiently powerful, may generate unwanted ultrasonic interference. Therefore, transducer failures that break the pattern required to generate the beneficial effects of apodization will have the side effect of creating unwanted ultrasonic field artifacts from the other transducer elements due to the missing but expected field.

This could be solved by ensuring that all transducers have a useful lifetime that exceeds their expected lifetime by enough of a degree as to render this unlikely, but this carries significant cost pressures to create and prove out such transducer elements and array designs that are sufficiently robust to the expected wear and tear during their lifetime.

Further, manufacturing variability will mean that transducer devices may have different levels of performance which leads to variation in amplitude across the generated field. These variations will also impact the reproduction of beneficial apodization effects.

It is therefore potentially important to be able to allow for failed or deviating transducers while maintaining the side lobes with lower energy that are characteristic of apodized arrays.

Apodization is used to adjust transducer amplitudes, which in the context of emitting phased arrays, yields output with specific side lobe structure. However, the method of apodization in existing contexts assumes a uniform array and when the array arrangement deviates even slightly from this, such as in the case of dead or malfunctioning transducers, the desired specific lobe noise characteristics are not achieved. In this disclosure, a modification to the general principles of the method of apodization that are capable of working around such limitation will be described.

Further, the best option to increase the acoustic pressure in a certain zone is to increase the number of transducers. This increases the cost of the system. The rotation (tilt) of transducers must also be considered to increase the acoustic pressure in a certain zone. Manufacturing arrays with transducers at a tilt or various tilts is difficult for a number of reasons: tilted transducers take up more space than non-tilted transducers and so the spacing of the transducers must be increased to accommodate this, which leads to problems with grating foci. Also manufacturing arrays with tilted transducers is more difficult using standard pick and place technology, requires more components to facilitate the tilt and increases the cost of array manufacture.

Acoustic pressure in areas outside the desired zone is undesirable as it is an inefficient distribution of acoustic power. It also contributes to unwanted effects such as microphone interference. Reducing the amount of acoustic power in unwanted areas is beneficial in three ways: it reduces the power wasted, therefore reducing the number of transducers for a required amount of pressure; by reducing acoustic pressure in areas which are not in the interaction zone it reduces microphone interference; it also reduces unwanted grating foci as these cannot form where there is no acoustic pressure.

Tactile mid-air haptics using ultrasound requires that acoustic pressure is confined to a focal point. In order to provide this confinement while also providing focal point movement a phased array is used. The phased array must provide sufficient confinement in two dimensions in order to confine the ultrasound to form a point. This is known as a focal point or control point. The requirement of having a 2D phased array increases the cost and size of the phased array system as more transducers need to be used to provide the confinement in both dimensions. As well as the phased array needing to be sufficiently wide to provide sufficient confinement (as the size of the focal point is inversely proportional to the size of the array) the transducers must be spaced sufficiently close to each other in order to prevent unwanted grating lobes. So, the size of the interaction zone where effective haptics can be produced is dependent on the number of transducer elements however, freedom of placement of those transducer elements is limited and sufficient 2D array aperture as well as a minimum transducer spacing is also required. These requirements increase the cost and size of the phased array.

New Description of the Technical problem. Acoustic phased arrays are used to create concentrated acoustic pressure locations in a particular region of space. The magnitude and location of the acoustic pressure can be varied by varying the magnitude and phase of the output from each transducer which constitutes the phased array. It is a requirement of these phased arrays to obtain a sufficiently high enough pressure at a range of locations in 3D space around the phased array. The limits in space where it is possible to obtain a sufficiently high enough acoustic pressure is defined as the Interaction Zone. In most applications it is beneficial to increase the size of the interaction zone for as low cost a phased array as possible.

More transducers increase the interaction zone volume, but also increase the cost of the system as the transducers are a substantial contribution to the total system cost. Reducing the number of transducers required in a phased array in order to obtain a certain Interaction Zone without increasing the system cost is the main problem this invention solves.

Methods to increase the volume of the interaction zone without increasing the number of transducers are to modify the properties of the transducers which make up the phased array. Transducer design is specialized and the construction of new acoustic transducers at sufficiently low-cost points requires large volume manufacture, not always suitable when designing products intended for low volume applications. Obtaining increased performance from a transducer, without the requirement of specialized skill set or costly manufacturing process to design a bespoke transducer for every application is another benefit of the invention.

The properties of the transducers to modify in order to increase the interaction zone of a given array would be the on-axis output power of the transducer, the minimum spacing possible between transducers and the directivity of the transducers. Due to the non-uniform directivity function of most transducers, the tilt applied to transducers relative to each other can also vary the resulting interaction zone. Tilting transducers is often difficult due to manufacturing constraints as pick and place machines and PCBs are often used to construct acoustic phased arrays which are not conducive to applying angular tilts on components, making the construction of such arrays difficult and expensive.

Modifying the directivity and angle of emission of transducers can be used to improve the interaction zone obtained. In order to increase the directivity of transducers, using the baffled piston analytical model, it is required to increase the radius of the piston, which will increase the size of the transducer. The baffled piston model is given by:

$${p}_{j} ( r , θ , t ) = {\underbrace{\frac{{A}_{j} ik {ρ}_{0} c π {{a}_{Tx}}^{2} {U}_{p} {e}^{i ( ω t - kr )}}{2 π r}}}_{amplitude} \cdot {\underbrace{\frac{2 {J}_{1} ( k \cdot {a}_{Tx} \cdot sin ( θ ) )}{k \cdot {a}_{Tx} \cdot sin ( θ )}}}_{directivity}$$

where, pⱼ(r, θ, t) is the complex pressure at a point r distance in space from the transducer at polar angle θ, J₁ is the Bessel function of the first kind, k is the wave-number, a_{Tx} is the radius of the transducer, ω is the angular frequency, i=\sqrt{−1}, Uₚ is the maximum possible amplitude of the piston velocity, Aⱼ is the amplitude of the driving signal, ρ₀ is the density of air and c is the speed of sound.

From the above equation, it can be seen that to increase the directivity of a transducer, one must also increase the radius of the transducer, which increases the size, meaning the spacing between the transducers also increases. It is not obvious therefore, what impact increasing one of the variables has on the resulting interaction zone, as all are interconnected, and the resultant interaction zone change is difficult to determine.

These problems mean that it is difficult to vary the acoustic field generated from individual transducers in a phased array in order to maximize the interaction zone for a given cost.

Meta materials have been used to shape a sound field in order to bend it around an object (SoundBender: Dynamic Acoustic Control Behind Obstacles, Norasikin et al.). The metamaterial was used because it allows for greater spacing resolution than transducers provide. However, the fact that the points on the metamaterial structure had incident power from multiple transducers was detrimental to the performance of the system, therefore the metamaterial was not shared between multiple transducers. Although acoustic sound was shaped into a specific region, no optimization for system cost was used and extra transducers were added outside the metamaterial edges to increase the performance of the system at the expense of greater system cost (the extra transducers would provide inefficient acoustic power incident onto the metamaterial as the majority of the power was not incident upon it). Therefore, they were successful in combining a phased array with a metamaterial structure but not for the purpose of saving cost, but for the purpose of increasing array performance. The metamaterial did not impart a benefit to multiple transducer elements, but the benefit was only given to one transducer, and other transducers received a slight reduction in performance due to it. In this way the metamaterial could not be considered to be shared and therefore each useful region of the metamaterial had a small effective area in order to limit power incident from multiple transducers. The current state of the art is to use one or more passive acoustic structure per transducer. The innovative step in this invention is to share the same structure with multiple transducers, increasing the effective area of the structure as seen from a single transducer, increasing the efficiency and lowering the cost of the system.

The paper, Acoustic levitation with optimized reflective metamaterials, Polychronopoulos et al., Acoustic levitation with optimized reflective metamaterials, Scientific Reports|(2020) 10:4254, demonstrates the use of a reflective surface to optimize the position and stability of one or more levitating beads. The solution is static and relies on pre-computing the optimum metamaterial surface to produce a single solution. The study uses multiple transducers, but keeps them emitting in plane wave with each other, although other phase distributions are possible no method is presented for a dynamic phased array use. Therefore, they remove one of the key benefits of phased arrays, a movable solution.

To the best of the inventor's knowledge, no paper or patent directly references using some passive acoustic structure to produce a 2D plane of acoustic power, or a 2D haptic interaction zone, in order to reduce transducer count and microphone interference. This invention enables a small phased array size with a low transducer count to produce a 2D interaction zone where fully controllable haptic sensations can be generated within the 2D interaction zone. Rotating this 2D interaction zone to provide a 3D interaction zone at a much-reduced cost has also never been presented.

The solution is a shared horn structure which modifies the distribution of acoustic power over emission angle from a group of transducers. The structure is passive in nature (does not require electrical power) and is shared with multiple transducers, redirecting the acoustic power from multiple transducers into a certain area, reducing the required number of transducers to achieve a required acoustic pressure in a certain area thereby reducing the cost of the system. The shared horn structure would be useful in many applications where concentrating ultrasound provides a useful benefit, such as mid-air haptics using ultrasound, parametric audio, levitation of small particles and acoustic imaging.

Further, by defining one of more control points in space, the acoustic field can be controlled. Each point can be assigned a value equating to a desired amplitude at the control point. A physical set of transducers can then be controlled to create an acoustic field exhibiting the desired amplitude at the control points.

This is achieved by solving a complex-valued linear system, where a phased array system comprised of the physical set of transducers may be actuated using sinusoids defined by complex-valued excitations to generate the desired diffraction field that meets the required amplitudes at the locations of the control points.

Constructing an approach that creates regions of low amplitude in the acoustic field is commercially interesting, as it is necessary to reduce background levels sufficiently to result in total elimination of ultrasonic interference in desired locations. Using the technique of specifying “null points,” control points of zero desired field, are a way to eliminate ultrasonic energy at a specific point and reduce ultrasonic interference in the neighbor of such a point. However, the use of null points is computationally expensive at present and this invention outlines an approach to reduce that cost by considering only the ‘array factor’ when determining the activation coefficients for a null point. This allows an approximation to be used in the solution for the null points in certain circumstances which may be commercially relevant, resulting in substantial computational savings.

Previous formula for null points.

Writing the problem definition of the multiple control point system in mathematics, p_{q}(χⱼ) may be used to describe a complex-valued scalar linear acoustic quantity p measured at a position offset from the transducer element q by the translation vector χⱼ, which may evaluate to be acoustic pressure or an acoustic particle velocity in a direction chosen for each j, the matrix A may be written:

$$A = [ \begin{matrix}{p}_{1} ( {χ}_{1} ) & … & {p}_{N} ( {χ}_{1} ) \\ ⋮ & ⋱ & ⋮ \\ {p}_{1} ( {χ}_{m} ) & … & {p}_{N} ( {χ}_{m} )\end{matrix} ] ,$$

As this is matrix A is not square, and the degrees of freedom number more than the constraints, this is termed a ‘minimum norm’ system. It is ‘minimum norm’ because as there are infinitely many solutions, the most expeditious solution is the one which achieve the correct answer using the least ‘amount’ of x—the solution x with minimum norm. To achieve this, some linear algebra is used to create a square system from the minimum norm system Ax=b.

The previous method for constructing null points was based on the multi-control point method, where the target pressure, bᵢ, is set to zero. To construct the matrix A, the function, p_{q}(χⱼ), calculates the contribution that each transducer makes at each control/null point. The formula for doing so is as follows,

$$\begin{matrix}p ( r , θ , t ) = \frac{i}{2} {ρ}_{0} c {U}_{0} \frac{a}{r} ka {e}^{i ( ω t - kr )} [ \frac{2 {J}_{1} ( ka sin θ )}{ka sin θ} ] , \\ = P ( r , t ) [ H ( θ ) ] .\end{matrix}$$

The variables are density, ρ₀, speed of sound, c, transducer velocity, U₀, transducer radius, a and wavenumber k. Note that this is required to be computed N×m number of times, which may typically be 256×50 and the angular dependence H(θ) is the most computationally expensive component. Hence, herein a method is proposed to obviate the need to calculate the angular dependence for each null point.

### Proposed Method for Null Points/Steering

Null points are typically far from the focus, so one may leverage the array factor formulation for radiating (ultrasonic or otherwise) arrays. The acoustic field generated by an array of radiating transducers is calculated by,

$$\begin{matrix}p ( r , θ , t ) = {\sum }_{n = 1}^{N} {A}_{n} P ( {r}_{n} , t ) H ( {θ}_{n} ) , \\ = \frac{i}{2} {ρ}_{0} {cU}_{0} \frac{a}{r} ka {e}^{i ω t} H ( θ ) {\sum }_{n = 1}^{N} {A}_{n} {e}^{- {ikr}_{n}} , \\ = P ( r , t ) H ( θ ) {\sum }_{n = 1}^{N} {AF}_{n} ( r ) .\end{matrix}$$

The subscript n denotes the relative positions for the n-th transducer with Aₙ being the complex activation coefficient for the n-th transducer. The far field property has been used to approximate rₙ, θₙ≈r, θ to simplify the summation, as this is a definition of far field behavior. The summation of AFₙ(r) is well-known to be the array factor.

Next, it is observed that functions P(r, t), H(θ) are independent of each transducer and may be observed as a multiplicative factor. Hence, it may be removed as a common factor such that matrix calculation needed for linear system is:

$$A = [ \begin{matrix}P ( {χ}_{1} ) H ( {χ}_{1} ) {AF}_{1} ( {χ}_{1} ) & ⋯ & P ( {χ}_{1} ) H ( {χ}_{1} ) {AF}_{N} ( {χ}_{1} ) \\ ⋮ & ⋱ & ⋮ \\ P ( {χ}_{m} ) H ( {χ}_{m} ) {AF}_{1} ( {χ}_{m} ) & ⋯ & P ( {χ}_{m} ) H ( {χ}_{m} ) {AF}_{N} ( {χ}_{m} )\end{matrix} ] ,$$

Then considering each row of the linear system independently,

$$P ( {χ}_{i} ) H ( {χ}_{i} ) A {F}_{i} {X}_{i} = {b}_{i} ,$$

$${AF}_{i} {X}_{i} = \frac{{b}_{i}}{P ( {χ}_{i} ) H ( {χ}_{i} )} .$$

When calculating a null point, bᵢ=0, hence the right-hand-side becomes zero and the angular dependence of each individual transducer is no longer required. To summarize, the matrix becomes,

$$A = [ \begin{matrix}{e}^{- ik \vert {r}_{1} - {R}_{1} \vert} & … & {e}^{- ik \vert {r}_{1} - {R}_{N} \vert} \\ ⋮ & ⋱ & ⋮ \\ {e}^{- ik \vert {r}_{m} - {R}_{1} \vert} & … & {e}^{- ik \vert {r}_{m} - {R}_{N} \vert}\end{matrix} ] ,$$

which is far simpler to implement and lends itself well for further extensions.

Further, ultrasonic phased arrays can be used to create arbitrary acoustic fields. These can be used for haptic feedback, parametric audio, acoustic trapping, etc. To achieve compelling effects, it is often the case that high levels of ultrasound are needed. Objects, microphones, animals, and/or people in the area of the ultrasound field could be sensitive to these levels.

In many cases, even if the ultrasound is directed elsewhere, fringing (unintentional) fields can still cause problems.

These unintended fringing fields can be attributed to two separable causes, side lobe effects and grating lobe effects.

Using enough individually addressable elements that create both an interaction region for mid-air haptics and achieve close enough spacing to suppress grating lobes that may cause unwanted device interference is costly in materials and drive electronics. In this disclosure, acoustic structures that allow a smaller number of larger transducing elements to achieve either or both of these goals are described.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIGS. 1A-1D show plots related to an array driven with uniform amplitude input signals and the output acoustic field pressures generated.

FIGS. 2A-2D show plots related to an array driven with a triangle window in amplitude input signals and the output acoustic field pressures generated.

FIGS. 3A-3D show plots related to an array driven using input signal amplitudes derived from a Gaussian function and the output acoustic field pressures generated.

FIGS. 4A-4D show plots related to an array driven with transducer amplitudes obtained from a minimum energy solution and output acoustic field pressures generated.

FIGS. 5A and 5B show the Gibbs metric for an array comparing scale of amplitude tapering using the Tukey or tapered cosine function with a varying cosine fraction parameter.

FIG. 6 shows a plot of the Fast Fourier Transform (FFT) of a Kaiser window with varying parameter p=πα.

FIGS. 7A and 7B show the Gibbs metric for an array with a discontinuity within the array that corresponds to a malfunctioning transducer element.

FIGS. 8A and 8B show the performance of a simplified window with a hexagonal array.

FIGS. 9A-9D show a comparison of the effectiveness of windowing for rectilinear and hexagonally packed arrays.

FIGS. 10A-10D show the transducer amplitudes for a circular array driven with and without amplitudes sampled from a Gaussian function.

FIGS. 11A-11D show the directivity patterns for the acoustic field and a smoothed dotted outline showing the side lobe power trend following the mathematical theorem that connects mathematical function smoothness and side lobe power.

FIG. 12 shows example evaluations of the bump functions for various shape factors when r_{N}=1.5.

FIGS. 13A-13D show figures comparing the effectiveness of a bump function window on some exemplar non-uniformly packed arrays.

FIGS. 14A and 14B show an example of a two-dimensional apodization applied to an array.

FIGS. 15A and 15B show an example of dimensional reduction applied to the apodization.

FIGS. 16A-16D show element amplitudes for an apodization targeted at a volume off axis.

FIGS. 17A-17D show element amplitudes for a superposition of axial apodizations in order to generate two non-orthogonal null regions.

FIGS. 18A-18D show element amplitudes for a one-dimensional apodization in which the apodization is curved.

FIGS. 19A and 19B show the acoustic field distribution surrounding an ultrasonic array with no apodization.

FIGS. 20A and 20B show the acoustic field distribution surrounding an ultrasonic array with one-dimensional axial apodization.

FIGS. 21A and 21B show the acoustic field distribution surrounding an ultrasonic array with untargeted (global) two-dimensional apodization.

FIGS. 22A and 22B show a schematic of apodization and uniform amplitude drives.

FIGS. 23A-23D show effects of element failure on an ambient field.

FIG. 24 shows an example of a 2D apodization function compensating for two failed transducers.

FIGS. 25A-25D show Helmholtz modes of the boundary value problem corresponding to a square lattice of 62×62 transducers with a 1% failure rate.

FIGS. 26A-26D show Helmholtz modes of the boundary value problem corresponding to a square lattice of 62×62 transducers where 1% of the transducers are reduced in their amplitude capability by a random amount.

FIGS. 27A-27F show distributing the maximum amplitude capability over all transducers with different Gaussian distributions.

FIGS. 28A and 28B show the effect of dynamic windowing to correct multiple element failures on an ambient field.

FIGS. 29A and 29B show the effect of dynamic windowing to correct a single element failure on an ambient field.

FIGS. 30A and 30B show the effect of dynamic windowing to correct edge element failures on an ambient field.

FIGS. 31A and 31B show the effect of dynamic windowing to correct element failure on an ambient field.

FIGS. 32A and 32B show the effect of simplified windowing to correct a single element failure on an ambient field.

FIGS. 33A and 33B show the effect of simplified windowing to correct multiple element failures on an ambient field.

FIGS. 34A and 34B show the effect of superposition of windows to correct element failure on an ambient field.

FIG. 35 shows the concept for redistribution of acoustic pressure to increase the haptic interaction zone.

FIG. 36 shows the distribution of pressure in the two dimensions using horns showing a broad emission in one dimension and narrow in the other.

FIG. 37 shows a 3D interaction zone created by rotating a 2D sheet of ultrasound.

FIG. 38 shows a shared horn structure with transducers 3D view.

FIG. 39 shows a shared horn structure with transducers 3D view underside.

FIG. 40 shows an end view of shared horn structure on top of transducers with specific horn geometry.

FIG. 41 shows a side view of shared horn structure on top of transducers.

FIG. 42 shows shared horns.

FIG. 43 shows a shared horn underside.

FIG. 44 shows a shared horn top down.

FIG. 45 shows a shared horn end view.

FIG. 46 shows a shared horn top down with transducers.

FIG. 47 shows a simulated pressure output from the horn array design in the non-confined axis.

FIG. 48 shows a simulated interaction zone output from the shared horn array in the confined axis.

FIG. 49 shows a simulated interaction zone for an 18×3 array without any horns for comparison.

FIG. 50 shows a simulated interaction zone of 3×18 array without horns for comparison low width array dimension.

FIG. 51 shows a diagram of the geometry of the parabolic horn used for the analytical model.

FIG. 52 shows a modeled frequency response of a horn.

FIG. 53 shows measured and modeled directivity behavior of a horn.

FIG. 54 shows a parameter sweep using the analytical model for a variety of horn angles and horn lengths affecting on-axis gain.

FIG. 55 shows on-axis gain versus horn length, difference in analytical model and measured gain for horns of various lengths.

FIG. 56 shows measured versus modeled horn on axis gain.

FIG. 57 shows the directivity of an array with a single null point.

FIGS. 58A and 58B show the acoustic field from a cube of null points.

FIG. 59 shows a plot of a continuous window function.

FIG. 60 shows a plot of a discrete window function.

FIGS. 61A-61C show a multiplicative decomposition of a continuous window function into per transducer and discrete window functions.

FIGS. 62A-62D show of a schematic of a waveguide design

FIG. 63 shows a schematic for a single acoustic duct.

FIG. 64 shows insertion loss in a conical duct of varying length.

FIG. 65 shows attenuation in a conical duct of varying length.

FIG. 66 shows attenuation in a conical duct of varying length.

FIG. 67 shows an error function in a conical duct of varying length.

FIG. 68 shows a simulation of the acoustic field within a conical duct.

FIG. 69 shows a plot of the outputted amplitude at the aperture of conical duct for varying length.

FIGS. 70A and 70B show duct lengths required to generate a waveguide.

FIG. 71 shows an error function of outputted amplitude of the waveguide aperture.

FIGS. 72A and 72B show an acoustic (fringing) field on a cylinder surrounding the array whose element pitch is greater than critical spacing (half wavelength).

FIGS. 73A and 73B show an acoustic (fringing) field on a cylinder surrounding the array whose element pitch is less than critical spacing (half wavelength).

FIGS. 74A and 74B show an acoustic (fringing) field on a cylinder surrounding the array whose element pitch is greater than critical spacing (half wavelength) and has Chebyshev apodization applied.

FIGS. 75A and 75B show an acoustic (fringing) field on a cylinder surrounding the array whose element pitch is less than critical spacing (half wavelength) and has Chebyshev apodization applied.

FIGS. 76A and 76B show an illustration of an encoding of a potentially discontinuous function of length in duct helicity.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. Amplitude Tapering for Ultrasonic Interference Suppression

Ultrasonic interference is due to sufficiently high levels of ultrasound to produce distortion within microphone systems. Ultrasound at useful levels for applications like mid-air haptics and levitation is typically more than enough to produce interference, if the microphone is placed near the volume where the ultrasound is interacting usefully, where peak pressures can easily exceed 1000 Pascals. Away from this useful region, which will be denoted the “ambient field”, there can still exist ultrasound at levels high enough to produce interference. This is due to the nature of phased array physics, but it can be mitigated and controlled through careful manipulation of the activation of transducers near boundaries. In this disclosure, methods to manipulate the maximum output of transducers across a phased array to minimize the ambient field while maintaining the pressure possible in a useful region near the array will be presented.

The ultrasonic energy in the ambient field is due to Gibbs phenomena, which can be described by a discrete Fourier transform over a discontinuity. This results in oscillatory behavior from overshooting and undershooting around the discontinuity. It is proven that the oscillatory behavior decreases as the number of samples increases but the oscillatory behavior always remains. The relationship to Fourier series means that Gibbs phenomena apply to an array of transducers and is responsible for side lobes, as the boundary of the array behaves as a discontinuity from the space surrounding it.

To identify more easily that side lobes are due to Gibbs phenomena, one may consider the domain surrounding the array as a larger array with zero amplitude outside the real array location. The elements at the edge of the real array location becomes a sharp discontinuity when considering the signal emitted from the larger array. The edge discontinuity may be mitigated by imposing a smooth decay for the element amplitudes as they approach the boundary. Mitigating the discontinuity results in a reduction, but never eradication, of Gibbs phenomena or side lobes.

Suppressing the discontinuity to the surrounding surface may be done via amplitude tapering the elements near to the boundary. In this disclosure, shapes, limits, and methods will be described to maximize the effectiveness of the taper while minimizing the impact of the amplitude reduction on the operational output of the system in various configurations. In some embodiments of this invention, the shape of this taper is called a ‘window’ and related to windowing functions in the mathematical literature. The literature refers to window functions in many ways, such as apodization or tapering function, with the key characteristic that a window function is non-zero in an interval and zero outside of it (compact support in mathematical literature). The use of such functions in signal processing is extremely valuable as they model reality more closely and it allows one to leverage infinite domain Fourier analysis. The use of windowing is widespread and especially prominent in signal processing, phased arrays and statistics, with applications in both the frequency and time domain. For phased arrays, windowing is a method in the far-field limit (beamforming) to reduce the impact of Gibbs phenomena on theoretical arrays but its application in focusing is atypical, thus the demonstration of it mitigating ultrasonic interference for mid-air haptics is not obvious.

Some degree of amplitude tapering is present in state-of-the-art acoustic phased arrays due to focus solutions which attempt to minimize the energy draw of the system. This shall be referred to as the minimum energy solution. Window methods, by contrast, focus on mitigating side lobe levels. The side lobe decay rate is determined by the continuity and boundedness of the highest differentiability class of the window function. The relationship is expanded upon later in this invention disclosure. The key differences from the window function approach to energy minimization solution is the boundedness and differentiability of the amplitudes to its surroundings, i.e. the function must be smooth. In energy minimization there are no such requirements and often there is a discontinuity to its surroundings, even before considering the derivatives.

Another distinguishing feature between the minimum energy solution and windowing is the decay rate of the side lobe level. This is defined as the relative peak amplitude of each progressive sidelobe. This is worked out in detail below. It is worth noting that there are some anomalous windows to this definition, such as Dolph-Chebyshev, Taylor and Kaiser windows, which exhibit boundedness properties on side lobes as opposed to decay rate.

A generic windowing function may be defined for a two-dimensional array as a map, w:(x, y)→W where W∈[0,1], which assigns the values to the elements on the array:

|Aₙ|=w(xₙ,yₙ).

The value Aₙ then determines the modulation used to prescribe the output amplitude to each individual transducer with xₙ and yₙ referring to the nth transducer's position, with the maximum position for the transducers denoted by x_{N} and y_{N}. The range of output of this mapping is from 0 to 1, with 1 representing full-output and 0 representing no-output. This value is the maximum output allowed from each transducer, scaled relative to full output. An effective window function w(xₙ, yₙ) generally returns larger values when the transducer is near to the centroid of the transducer array layout and smoothly decays at the boundary. In the case of convex or concave arrays the centroid may be found by considering the principal components of the spatial distribution of the transducer array layout and projecting the centroid along the axis that provides the shortest distance or dominant axis. Alternatively, if there exists a conformal map which takes convex or concave array and maps it to a flat 2D surface, then one may find the centroid of the flat 2D surface, project it onto the convex or concave array and use it as the notional center for the array. The decay may range from a linear profile to cosine, or even exponential.

With a given window assigned to the array, solving for useful fields may proceed through any typical method, using the knowledge that some transducers are now limited in output. In practice, this is done by modifying each modelled transducer output by the windowing modulation factor before solving. This will generate solutions where the output of a windowed transducer may be asked for “full” output, meaning the maximum output allowed with window modulation. In that case, the window modulation may need to be applied before driving to produce the correct results, depending on the handling of “full output” in the system. In some cases, such as solving for a focus only based on phase, the windowing contribution may be ignored, but this makes the focus pressure value unknown.

The smooth decay of a windowing function is important for sidelobe-reduction performance, but it is not necessary to start the smooth decay from the very center of the array. In one embodiment of this invention, a region within the array may contain a uniform region with many transducers capable of producing full output, which is adjacent to the windowed taper region near any boundary. This full-output region helps to maintain the region of useful ultrasound and increase possible pressure from the array. In one embodiment, the shape and size of this region can be evaluated empirically by matching its edges to a taper function which can be varied. In another embodiment, a well-known windowing function can be used with its values scaled by a constant larger than 1. In this case, any values which come out larger than 1 would be set to 1, establishing a uniform region. This embodiment allows for a single parameter (scaling of the window function) to be adjusted and optimized, minimizing the optimization difficulty.

Many windowing functions are derived and described in one dimension while most ultrasonic arrays have physical extent in at least 2 dimensions. Mapping the 1-dimensional function to a multidimensional array can be done with several methods. In one embodiment, the distance from the origin of the array can be used to map 3 dimensions to 1 dimension for the windowing function. In another embodiment, the largest value of either x or y in absolute magnitude can be used as the mapping coordinate. The windowing function can be different for one dimension versus the other which can be useful for arrays of high aspect ratio.

Take, for example, a triangle window function defined by:

$$w ( {r}_{n} , {r}_{N} ) = ( 1 - \frac{{r}_{n}}{{r}_{N}} ) ,$$

$${r}_{n} = \sqrt{{x}_{n}^{2} + {y}_{n}^{2}} .$$

Here rₙ is the radial distance to the array center of each element and r_{N} is the maximum radius where the window modulation becomes zero. This produces a linear ramp to zero from the origin. This can be applied as is to a 2- or 3-dimensional array with rₙ representing the distance from the origin of the array to each transducer. In a different embodiment of this window, say for a 2-dimensional array, r may be mapped to cartesian coordinates and then multiply the result. This results in:

$${w}^{′} ( {x}_{n} , {y}_{n} , {x}_{N} , {y}_{N} ) = w ( {x}_{n} , {x}_{N} ) w ( {y}_{n} , {y}_{N} ) = ( 1 - \frac{{x}_{n}}{{x}_{N}} ) ( 1 - \frac{{y}_{n}}{{y}_{N}} ) ,$$

where x_{N} and y_{N} are the scaling parameters in the x and y dimension respectively. These are necessarily larger than the corresponding dimensions in the array itself, otherwise some transducers would have a modulation of zero, an undesirable result. The selection of a particular dimensional scaling (r_{N}, x_{N}, y_{N} etc) can vary depending on the application as a larger scaling will result in increased focal point pressure, but worse sidelobe reduction performance. In another embodiment, instead of multiplication, a 2-dimensional mapping of a 1-dimensional window function could select one of the two dimensional outputs based on an evaluation function such as the minimum. This would take the form:

$${w}^{′} ( {x}_{n} , {y}_{n} , {x}_{N} , {y}_{N} ) = min [ w ( {x}_{n} , {x}_{N} ) , w ( {y}_{n} , {y}_{N} ) ]$$

where the min function outputs the minimum value within the two inputs. For completeness, a scaling factor, as discussed above, can be included by multiplying by a fixed constant greater than 1 and setting a ceiling of 1 for the modulation. In this example this takes the form:

$${w}^{″} ( {r}_{n} , {r}_{N} , A ) = min [ 1 , A w ( {r}_{n} , {r}_{N} ) ] ,$$

with an amplitude scaling factor of A.

Window functions approach zero within a finite interval. Applying a zero modulation to a transducer would prevent any output from that transducer rendering it useless, and therefore should be avoided. In one embodiment, any window function used has its primary dimension scaled such that the outermost transducer still lies within a non-zero region of the function. In another embodiment a fixed value is added to the window function within the domain of the array, resulting in a minimum, non-zero driving condition.

The introduction of examples of specific windowing functions and methods for use in acoustic phased arrays may now proceed, followed by an analytic comparison of the relative effectiveness of each using an exemplar transducer arrangement. The details given are adaptable to different transducer arrangements using methods discussed elsewhere in this invention.

The simplest window function only considers the transducers in direct contact with an edge or discontinuity. In this embodiment, these transducers have a fixed less-than-one modulation applied. The optimum value will depend on the typical activation of the array which is related to the size of its desired interaction volume and physical arrangement.

The next embodiment of this invention involves both the transducers in direct contact with an edge or discontinuity but also the transducers in direct contact with the edge transducer. To improve the effectiveness of the windowing, applying a windowing modulation over a larger length (such as two transducers) will be more effective than just considering the edge. In this embodiment, the edge transducer has a modulation of x and the adjacent transducer has a modulation of (1+x)/2 which splits the difference between the modulated transducer and full activation, effectively applying a linear ramp to the edge of the array. In another embodiment, other functions may be used other than linear to relate the edge transducer modulation to the adjacent transducer modulation. Example functions include trigonometric functions, polynomials, and exponentials. The only limitation is that the edge transducer must have a modulation equal to or less than in absolute value compared to the adjacent transducer modulation.

In another embodiment, the modulation follows a triangle pattern. This is defined by:

$$w ( {r}_{n} , {r}_{N} , A ) = min [ 1 , A ( 1 - \frac{{r}_{n}}{{r}_{N}} ) ] ,$$

where rₙ is the distance from the origin of the array, ry is the spatial scaling factor and A is the amplitude scaling factor. The triangle window function creates a linear ramp to the limit of the spatial scaling factor and has the advantage of being relatively easy to implement. The radial dimension may be mapped to cartesian coordinates with methods mentioned above.

In another embodiment, the modulation samples a Gaussian distribution. This is defined by:

$$w ( {r}_{n} , σ , A ) = min [ 1 , A {e}^{- \frac{1}{2} {( \frac{{r}_{n}}{σ} )}^{2}} ] ,$$

where rₙ is the distance from the origin of the array, σ is the spatial scaling factor, and A is the amplitude scaling factor. This window function creates a Gaussian profile and has increased performance relative to the triangle window function. The radial dimension may be mapped to cartesian coordinates with methods mentioned above.

In another embodiment, the modulation follows a cosine pattern. This is defined by:

$$w ( {r}_{n} , {r}_{N} , A ) = min [ 1 , A cos ( \frac{π {r}_{n}}{2 {r}_{N}} ) ] ,$$

where rₙ is the distance from the origin of the array, r_{N} is the spatial scaling factor and A is the amplitude scaling factor. This window function is easier to implement compared to the Gaussian, while still yielding higher sidelobe performance compared to the triangle window. The radial dimension may be mapped to cartesian coordinates with methods mentioned above.

In another embodiment, the modulation has a region with full output, with an edge taper that follows a cosine pattern. This is also commonly known as a Tukey window. This is defined by:

$$w ( {r}_{n} , {r}_{N} , α ) = cos ( \frac{π ( {r}_{n} - α {r}_{N} )}{{r}_{N} - α {r}_{N}} ) , \qquad {r}_{n} \geq α {r}_{N}$$

$$w ( {r}_{n} , {r}_{N} , α ) = 1 , \qquad {r}_{n} < α {r}_{N}$$

where rₙ is the distance from the origin of the array, r_{N} is the spatial scaling factor and α is a constant between 0 and 1 which represents the fractional distance to r_{N} where there is a modulation factor of 1. The advantage of this method is that it gives explicit control of the region with no attenuation while still allowing for a controlled ramp to the boundary.

In another embodiment, a cosine-sum window is used. This is defined by a series of cosine functions which are scaled by constants and summed to produce a window function. An example of this is the well-known Blackman-Harris window. This is defined by:

$$w ( {r}_{n} , {r}_{N} , A ) = min [ 1 , A \{ {a}_{0} - {a}_{1} cos ( \frac{π {r}_{n}}{{r}_{N}} - 1 ) + {a}_{2} cos ( \frac{2 π {r}_{n}}{{r}_{N}} - 1 ) - {a}_{3} cos ( \frac{3 π {r}_{n}}{{r}_{N}} - 1 ) \} ] ,$$

where rₙ is the distance from the origin of the array, r_{N} is the spatial scaling factor, A is the amplitude scaling factor, and a₀, a₁, a₂, and a₃ are constants given by 0.35875, 0.48829, 0.14128, and 0.01168 respectively. The Blackman-Harris window has excellent sidelobe performance relative to many other window functions. Variations on coefficients for any cosine-sum which produce favorable performance in reducing sidelobe levels are considered part of this invention.

In another embodiment, a window function may be generated through the solution to a linear boundary value problem. A window function, w(x, y), symmetric or otherwise, may be constructed by the solution of a partial differential equation, where the definition of the problem is:

[symbol]

w(x,y)=f(x,y),(x,y)∈Ω,

subject to:

w(x,y)=g(x,y),(x,y)∈∂Ω.

With the linear operator [symbol] acting in the domain Ω subject to boundary conditions on the boundary ∂Ω, with g (x, y) some specified behavior. Note that additional boundary conditions may be imposed on the continuity of the window function to design functions with the required side lobe decay rate.

To illustrate, consider a 1D example of a second order ordinary differential equation of the Helmholtz:

$$\frac{{d}^{2} w ( x )}{{dx}^{2}} = {λ}^{2} w ( x ) , x ϵ Ω ,$$

subject to:

w(x)=w₁,x∈∂Ω.

Solving this gives:

$$w ( x ) = {Ae}^{- λ x} + {Be}^{λ x} ,$$

with w₁ determining the constants A and B, and λ is a tunable parameter, yielding a function with advantageous differentiability properties. Extending this approach to higher orders enables further boundary conditions to be specified, with the fourth order example being:

$$a \frac{{d}^{4} w ( x )}{{dx}^{4}} + b \frac{{d}^{3} w ( x )}{{dx}^{3}} + c \frac{{d}^{2} w ( x )}{{dx}^{2}} + d \frac{dw ( x )}{dx} + e w ( x ) = 0 , x ϵ Ω ,$$

$$subject to :$$

$$w ( x ) = {w}_{1} , \frac{dw ( x )}{dx} = {w}_{2} , x ϵ \partial Ω .$$

Considering the ansatz e^{λx} converts the fourth order ODE into a fourth order polynomial which has a general solution in the form:

$$w ( x ) = {Ae}^{{λ}_{1} x} + {Be}^{{λ}_{2} x} + {Ce}^{{λ}_{3} x} + {De}^{{λ}_{4} x} ,$$

where λᵢ are the roots to the fourth order polynomial and A, B, C, D are constants to be determined from the boundary conditions. The continuity and differentiability at the boundary may be determined by the order of the differential equation, with differential equations of order 2n leading to solutions continuous to the nth derivative. Hence, herein is developed a constructive method to generate window functions with any specified side lobe decay rate. In some sense this approach may be considered an exponential basis for window construction. To cover infinitely smooth solutions, the use of the bump/test function is proposed, typically used in mathematical analysis. The bump function is defined as follows:

$$w ( {x}_{n} , {y}_{n} ) = \{ \begin{matrix}{e}^{- \frac{a}{{x}_{N}^{2} - {x}_{n}^{2}}} {e}^{- \frac{a}{{y}_{N}^{2} - {y}_{n}^{2}} ,} & {}^{( {x}_{n} , {y}_{n} ) ∈ Ω ,} \\ 0 , & ( {x}_{n} , {y}_{n} ) ∉ Ω .\end{matrix}$$

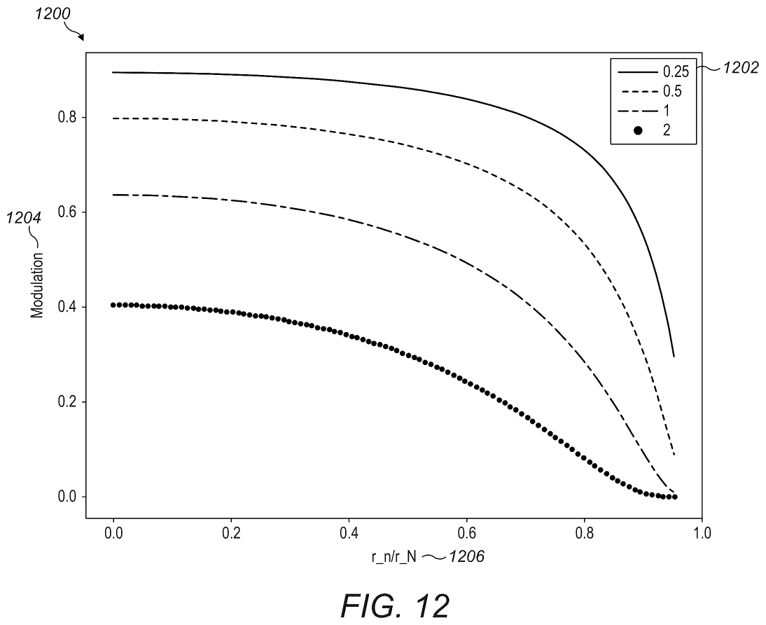

This function is infinitely differentiable and thus the side lobes are exponentially decaying. Rewriting this in the above notation, this becomes:

$$w ( {r}_{n} , {r}_{N} , a ) = min [ 1 , {Ae}^{- \frac{a}{{r}_{N}^{2} - {r}_{n}^{2}}} ] ,$$

where rₙ is the distance from the origin, r_{N} is the spatial scaling factor, A is the amplitude scaling factor, and a is a constant which affects both shape and amplitude. Example evaluations of this function with various a is shown in FIG. 12, described below. Note that the output of the bump window is undefined at rₙ=r_{N}.

Other possible common windowing functions which can be applied to ultrasonic arrays to reduce sidelobes include but are not limited to Parzen, Welch, Hann, Hamming, Blackman, Nuttall, Blackman-Nuttall, Blackman-Harris, Slepian, Kaiser, Chebyshev, Poisson, Bartlett, Bartlett-Hann, Planck-Bessel, Hann-Poisson, and GAP (generalized adaptive polynomial) functions. The literature is broad on the application of window functions in signal processing and applying it to the spatial array layout ensures that the acoustic field emitted from the array exhibits the same features as that of the Fourier Transform of the window function. An example of applying window function shaped amplitudes in the spatial domain may be implemented in the form w(xₙ, yₙ) where the function's domain is defined on the element's coordinates, or w(xₙ, yₙ, x_{N}, y_{N}) where the function's range is defined on the element's position in the sequence. Note that 2D window functions may be constructed from 1D window functions via the radial or separable methods outlined previously.

To discuss the relative effectiveness of the various window embodiments discussed, the introduction of a simulation framework is necessary. The ultrasonic acoustic field emitted from an array of ultrasonic transducers is accurately modelled by a linear summation of individually modelled transducers. The far-field acoustic pressure field from the nth transducer, Pₙ(r, θ, z, t), is modelled by:

$${P}_{n} ( r , θ , z , t ) = {A}_{n} p ( r ) H ( θ ) {e}^{- i ω t - ikr} ,$$

where p(r) represents the axial pressure amplitude, H(θ) represents the directivity for the transducer, k is the wavenumber, ω is the angular frequency, Aₙ is the complex activation coefficient for the nth transducer, and (r, θ, z) is the position to the field location in cylindrical coordinates. Due to linearity, the acoustic field emitted from the array may be found as:

$$P ( r , θ , z , t ) = {\sum }_{n = 1}^{N} {P}_{n} ( {r}_{n} , {θ}_{n} , {z}_{n} , t ) , \qquad [ 1 ]$$

where N the total number of transducers and (rₙ, θₙ, zₙ) refers to the position from the nth transducer to the field location. This formula is used to simulate the acoustic field. To simulate the impact in mid-air haptics, a typical focus location may be considered and a sample of the field in a 20 cm sided cube surrounding it is generated. Note the sample dataset may be generated either in simulation or experimentally.

The oscillatory behavior caused by the Gibbs phenomena is sufficient for causing ultrasonic interference. Thus, a method is constructed to detect and mitigate the ultrasonic interference by shaping the amplitude for each transducer. In order to measure the noise due to Gibbs phenomena, a metric has been developed which takes the average value of a side lobe region of a sample of pressure field. To do so the pressure values contained in “SideLobes” is the acoustic pressure field that exists between the main lobe and grating lobes. The discrete case is considered here as a matrix of sampled pressure values. The measure of the average value of the side lobes is:

$$Gibbs Metric = \frac{1}{Vol ( Ω )} \int \int {\int }_{Ω} SideLobes dV = \frac{1}{N} {\sum }_{n = 1}^{N} SideLobes [ n ] ,$$

which is given in the continuous case with the discretization shown. The metric has the same units as the pressure field considered. In order to implement this approach, one must locate the side lobe region which is outlined in the following:

1. Take a set of sample points in a region of interest, for example a 200 mm line of points centered at the focal point sampled at a rate of 4 sample points per wavelength. However, the minimum number of sample points is 2 per wavelength. This will output an array of pressure values.

2. Remove the main lobe if it is present in the dataset. To locate the main lobe region, the nearest inflexion points to a focal point is located and removed from a dataset of sample points passing through the focus. An example implementation is to apply an algorithm which begins at the focus and compares neighboring pressure values until a monotonically decreasing sequence is broken. Once the main lobe is located remove it from the dataset.

3. Then calculate the Gibbs Metric for the remaining dataset by using the formula above, with N referring to the number of points remaining in the dataset and “SideLobes” being the remaining pressure values. This will return the average side lobe level, which will be in the units of the pressure field being considered. The units are decibels in the cases examined here but hold for Pascal units too.

Hence, the Gibbs metric is extremely dependent on the sample grid size and number of sample points taken. Nonetheless it serves as a useful metric for comparing tapering profiles, especially in the presence of grating lobes as grating lobes produce an order of magnitude more energy than side lobes. Physically, the Gibbs metric is the average of the noise floor emitted from the array. Note that one could also apply the metric to any measurement of the field, for example the square of the pressure may be considered.

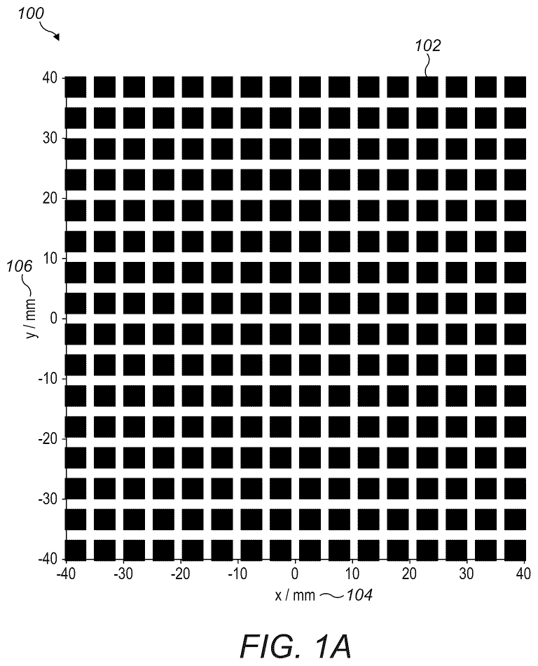

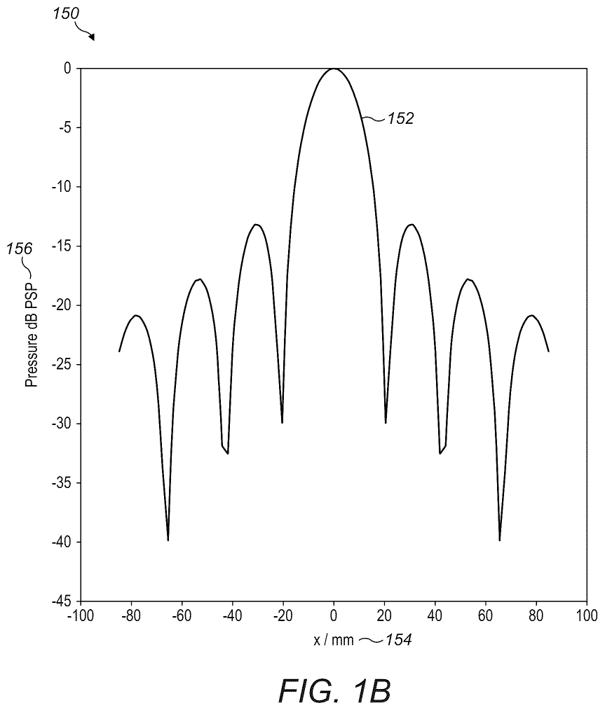

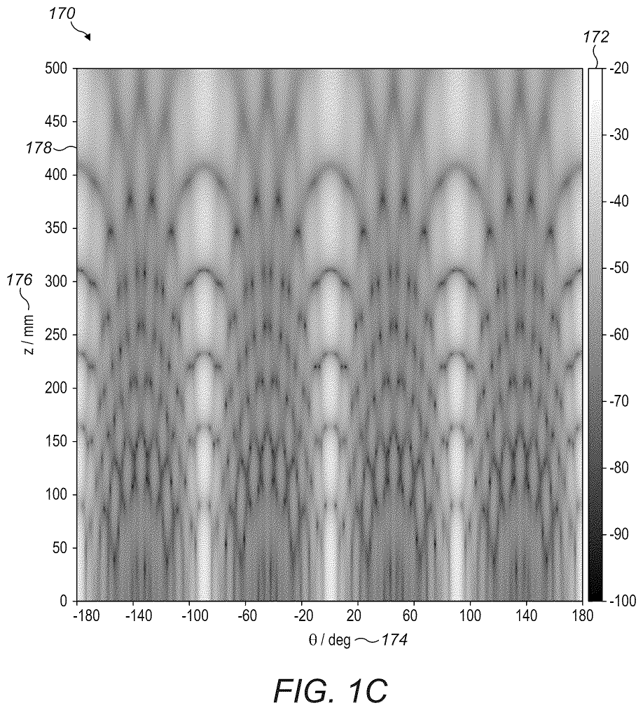

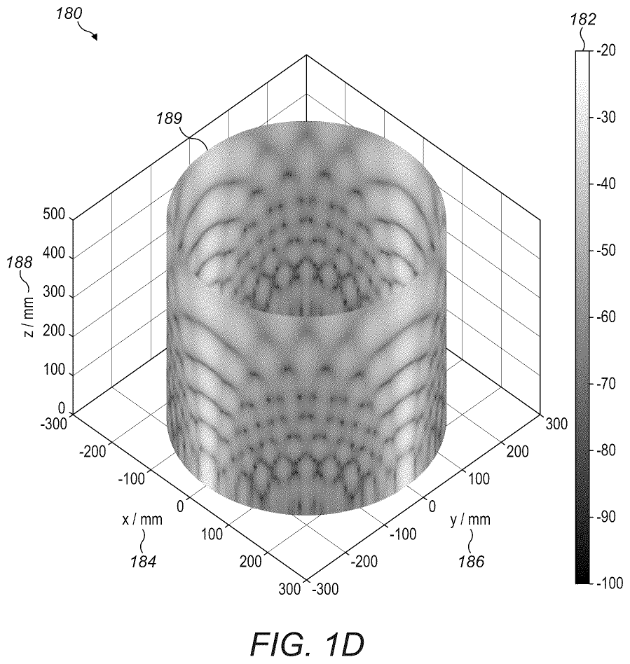

The Gibbs phenomena is shown for the fringing field, which becomes regions of high energy ultrasound displayed on a cylinder surrounding the array. The Gibbs metric calculated on the field shown in FIG. 1 is −22 for an array with no amplitude tapering.

FIG. 1A shows a schematic 100 of the transducer amplitudes for an array 102 driven with a uniform amplitude distribution, showing the existence and extent of Gibbs phenomena. The array is rectilinear with critical spacing. The x-axis 104 is in mm and the y-axis 106 is in mm.

FIG. 1B shows a graph 150 of directivity 152 of a uniform amplitude distribution. The x-axis 154 is in mm, the y-axis 156 is in normalized pressure dB PSP. (As used herein “PSP” means peak sound pressure (as a deviation from atmospheric pressure), which is for a single frequency the same as the amplitude of the deviation, as opposed to a root mean squared value as is used when the suffix is ‘SPL’ which is smaller by a factor of the square root of two). The level is normalized with the reference set as the focus pressure, which allows comparison of the amount of suppression achieved by different techniques to be more readily illustrated.

FIG. 1C shows a plot 170 of an unwrapped acoustic field 178 for a uniformly driven array. The x-axis 174 is in degrees (θ), the y-axis 176 is z in mm, and the key 172 is in normalized dB with the reference level being the focus pressure.

FIG. 1D shows a plot 180 of an acoustic field for a uniformly driven array. The field 189 is shown via an x-axis 184 in mm, a y-axis 186 in mm, and a z-axis 188 in mm. The key 182 is in normalized dB with the reference level being the focus pressure.

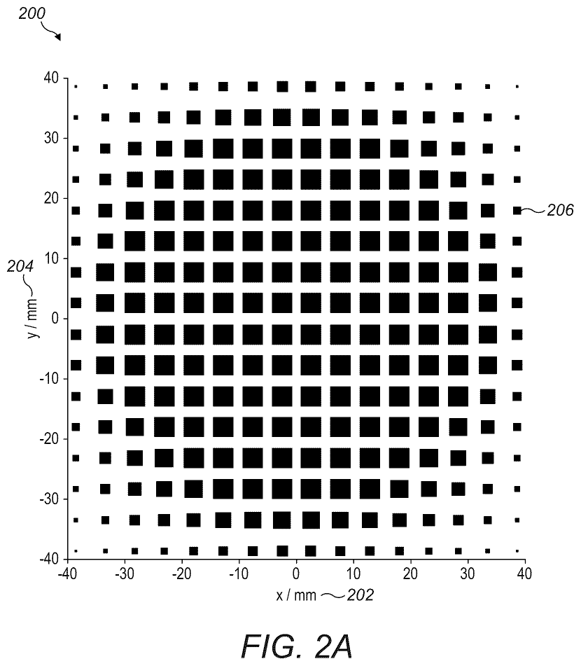

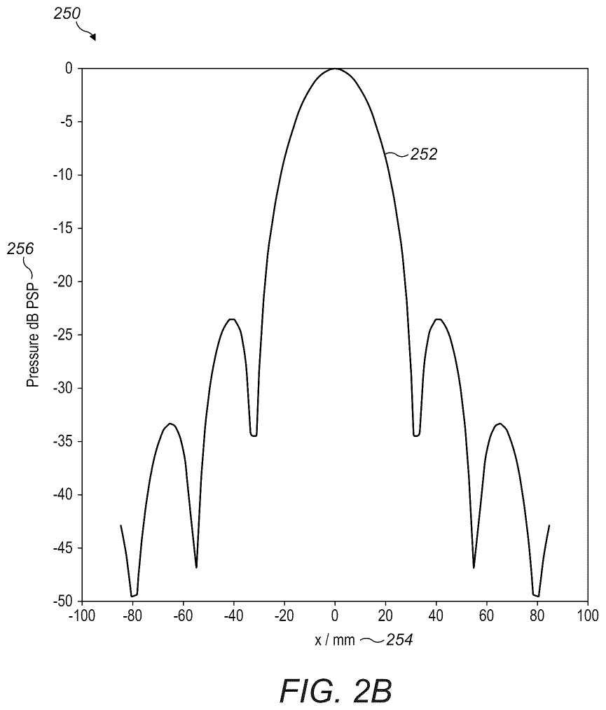

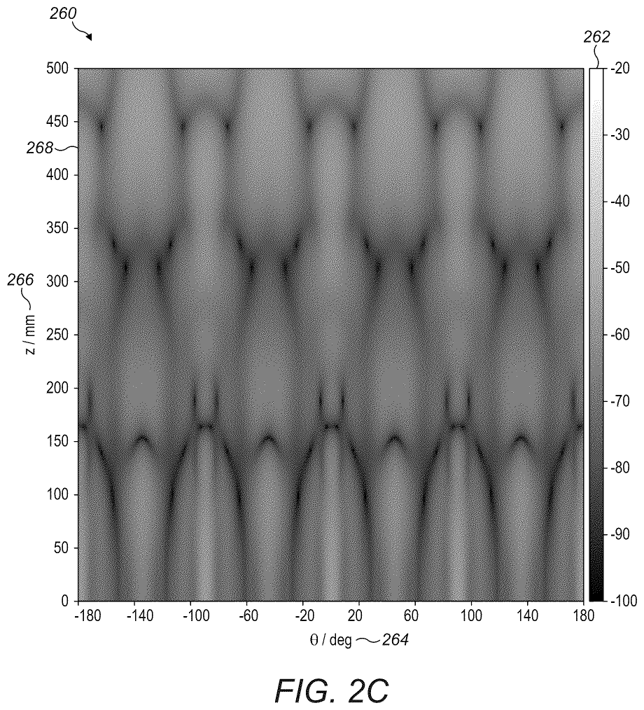

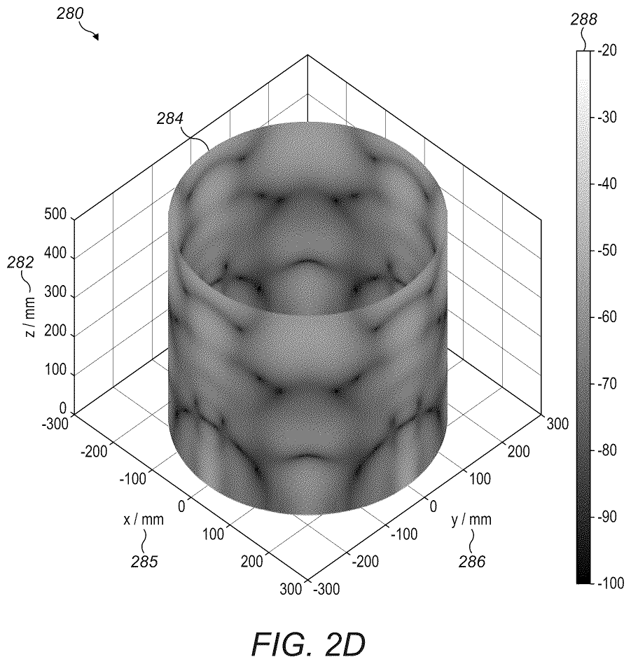

FIGS. 2A-2D show the transducer amplitudes for an array driven with a triangle window, showing a reduction of Gibbs phenomena to the uniform case in FIGS. 1A-1D. The array is rectilinear and critically spaced. The Gibbs phenomena shown in the fringing field becomes regions of much lower energy compared to the uniformly driven case, which is reflected in the lower Gibbs metric of −35.37.

FIG. 2A shows a schematic 200 of the transducer amplitudes for an array 206 driven with a triangle window. The array is rectilinear with critical spacing. The x-axis 202 is in mm and the y-axis 204 is in mm.

FIG. 2B shows a graph 250 of directivity 252 of an array driven with a triangle window. The x-axis 254 is in mm, the y-axis 256 is in normalized pressure dB PSP, with the reference level set as the focus pressure.

FIG. 2C shows a plot 260 of an unwrapped acoustic field 268 for an array driven with a triangle window. The x-axis 264 is in degrees (θ), the y-axis 266 is z in mm, and the key 262 is in normalized dB with the reference level being the focus pressure.

FIG. 2D shows a plot 280 of an acoustic field for an array driven with a triangle window. The field 284 is shown via an x-axis 285 in mm, a y-axis 286 in mm, and a z-axis 282 in mm. The key 288 is in normalized dB with the reference level being the focus pressure.

Note the application of the simple triangle window has removed the high energy components seen in FIGS. 1C and 1D.

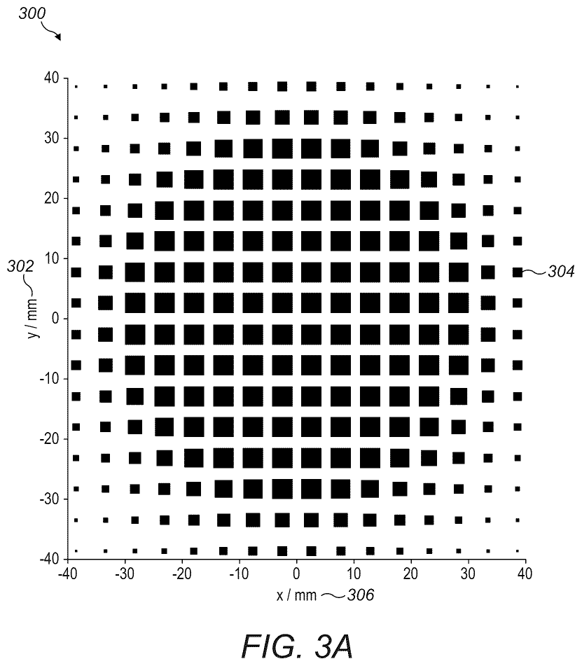

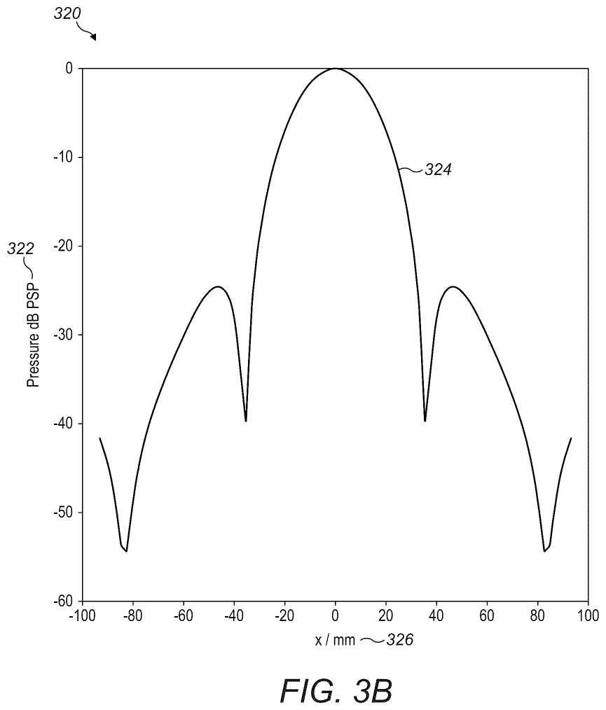

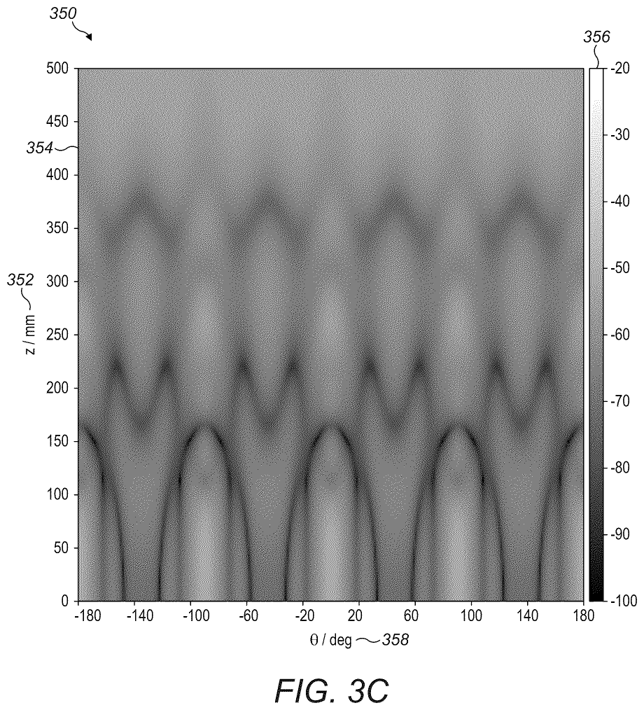

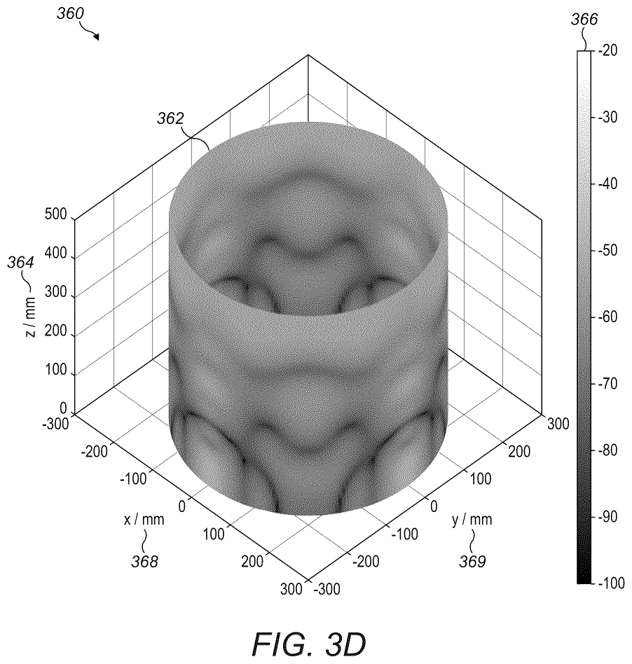

FIGS. 3A-3D show the transducer amplitudes for an array driven with amplitudes sampled from a two-dimensional Gaussian function, showing a reduction of Gibbs phenomena. The array is rectilinear and critically spaced. The Gibbs phenomena is shown in the fringing field and has much lower energy compared to the uniformly driven case. This is reflected in the reduced Gibbs metric of −35.98, which is much lower than the uniformly driven array.

FIG. 3A shows a schematic 300 of the transducer amplitudes for an array 304 driven with element amplitudes suitably chosen to produce a Gaussian window. The x-axis 306 is in mm and the y-axis 302 is in mm.

FIG. 3B shows a graph 320 of directivity 324 of an array driven with amplitudes that follow a Gaussian window. The x-axis 326 is in mm, the y-axis 322 is in normalized pressure dB PSP, with the reference level set as the focus pressure.

FIG. 3C shows a plot 350 of an unwrapped acoustic field 354 for an array driven with a Gaussian window. The x-axis 358 is in degrees (O)), the y-axis 352 is z in mm, and the key 356 is in normalized dB with the reference level being the focus pressure.

FIG. 3D shows a plot 360 of an acoustic field for an array driven with a Gaussian window. The field 362 is shown via an x-axis 368 in mm, a y-axis 369 in mm, and a z-axis 364 in mm. The key 366 is in normalized dB with the reference level being the focus pressure.

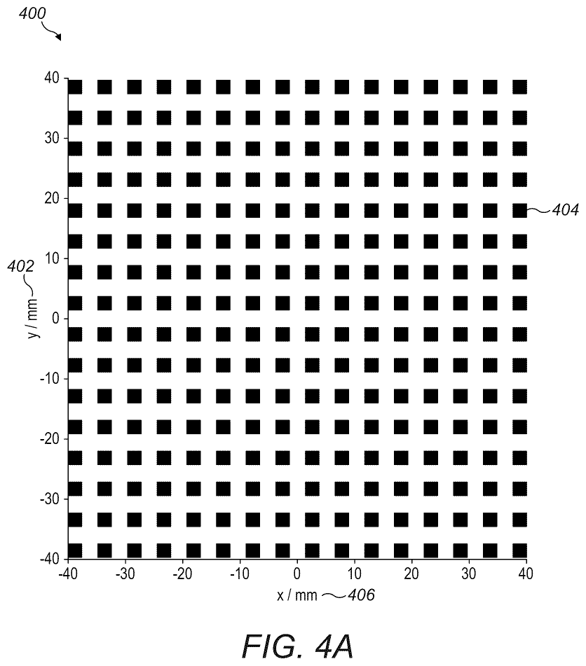

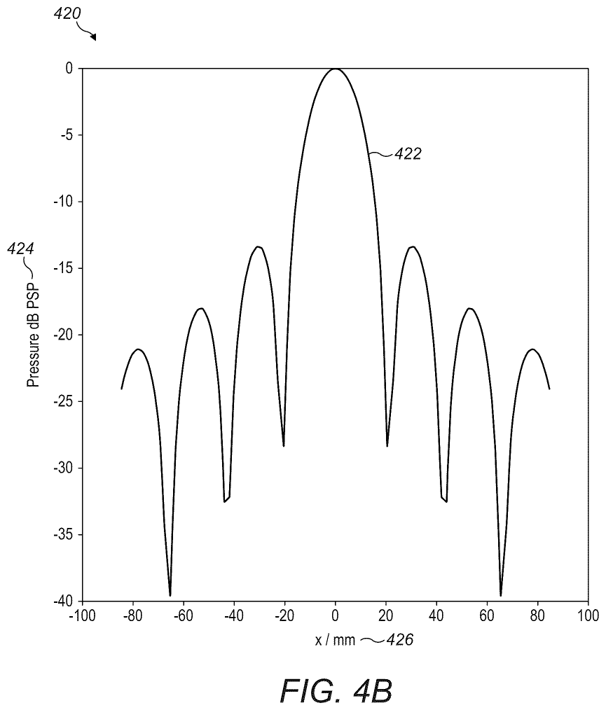

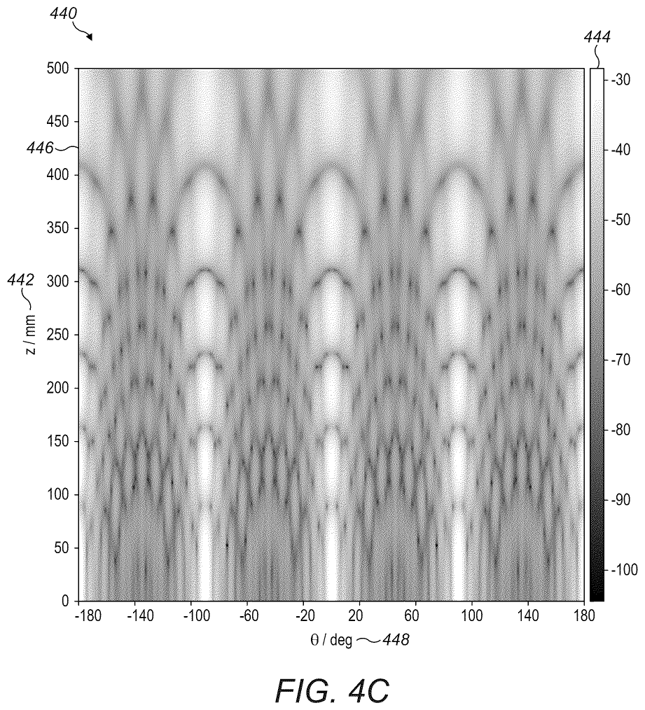

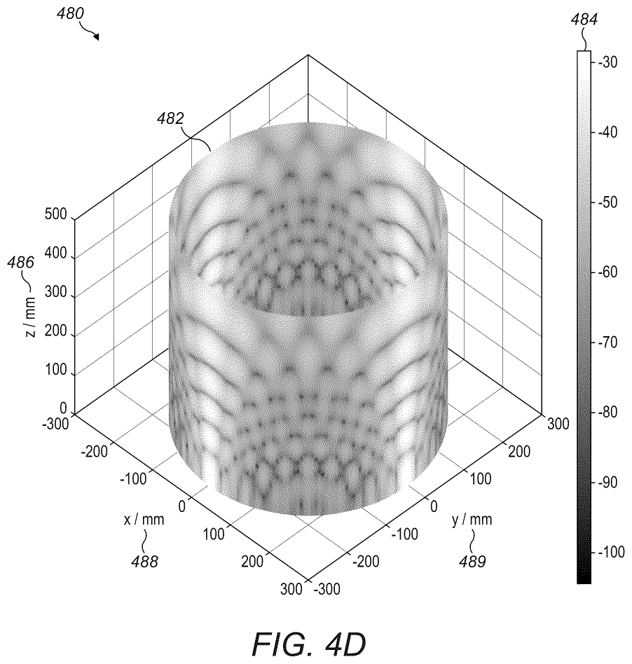

FIGS. 4A-4D show the transducer amplitudes for an array with amplitudes driven with minimum energy solution, showing no reduction of Gibbs phenomena to the uniform case. The array is rectilinear and critically spaced. The focus location impacts the distribution of the element amplitudes; with focus locations much closer to the array, the minimum energy solution will produce results with more pronounced amplitude tapering. The behavior of the Gibbs phenomena in the fringing is like the uniformly driven case, with a similar Gibbs metric.

FIG. 4A shows a schematic 400 of the transducer amplitudes for an array 404 driven with a minimum energy solution. The x-axis 406 is in mm and the y-axis 402 is in mm.

FIG. 4B shows a graph 420 of directivity 422 of an array driven with minimum energy solution. The x-axis 426 is in mm, the y-axis 424 is in normalized pressure dB PSP, with the reference level set as the focus pressure.

FIG. 4C shows a plot 440 of an unwrapped acoustic field 446 for an array driven with a minimum energy solution. The x-axis 448 is in degrees (θ), the y-axis 442 is z in mm, and the key 444 is in normalized dB, with the reference level set as the focus pressure.

FIG. 4D shows a plot 480 of an acoustic field for an array driven with a minimum energy solution. The field 482 is shown via an x-axis 488 in mm, a y-axis 489 in mm, and a z-axis 486 in mm. The key 484 is in normalized dB, with the reference level set as the focus pressure.

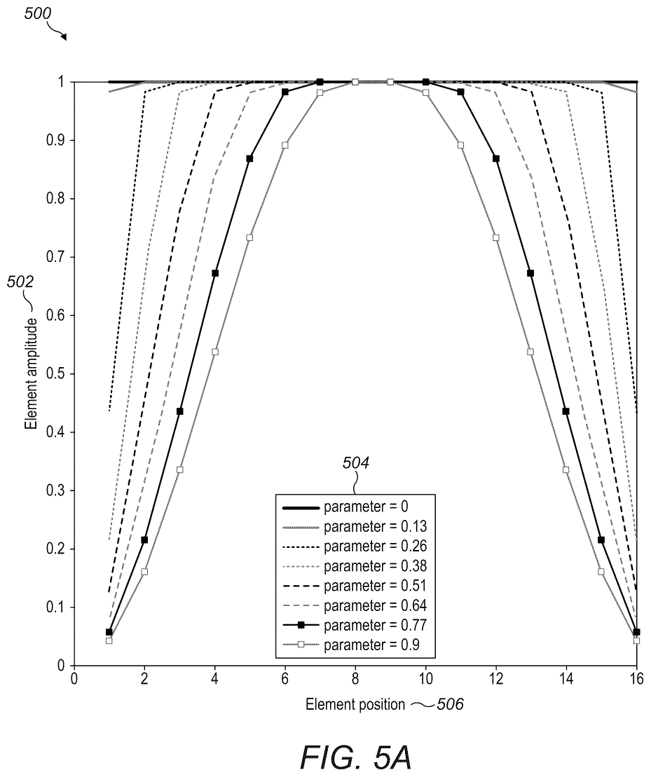

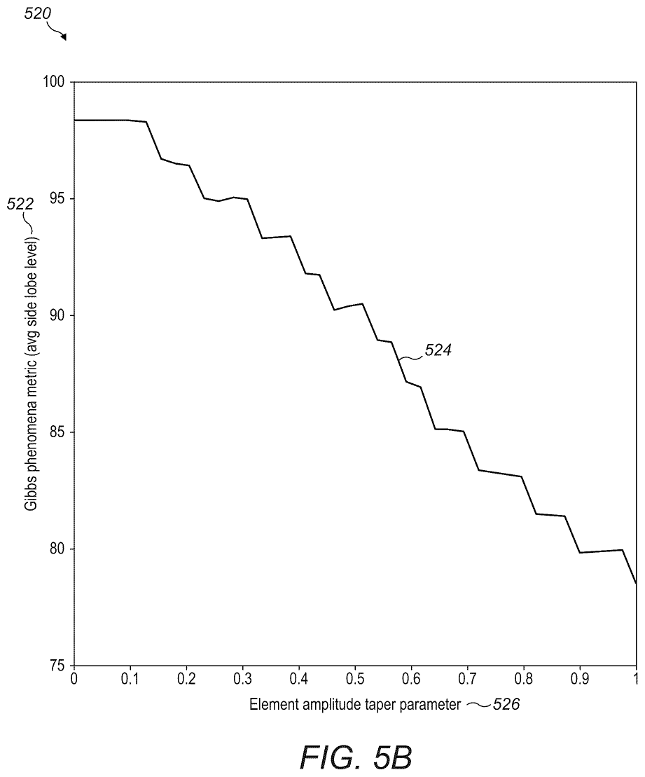

FIGS. 5A-5B show the Gibbs metric for an array comparing scale of amplitude tapering. The tapering function used is the Tukey window function with a varying parameter. Increasing the tapering causes the average side lobe level to decrease so the Gibbs metric decreases with it. Thus, it is seen that the ultrasonic interference may be reduced by tapering the transducer amplitudes.

FIG. 5A shows a plot 500 of increasingly tapered element amplitudes corresponding to the Tukey or tapered cosine function with a varying cosine fraction parameter 504 as an illustrative transect through an array, i.e. a row of transducers. The x-axis 506 is the transducer element position number. The y-axis 502 is the normalized element amplitude as a fraction of their maximum permissible input drive. As the parameter increases, it can be seen that the transducers at the edge are reduced in amplitude as the taper becomes more pronounced.

FIG. 5B shows a plot 520 of a Gibbs metric for element amplitudes 524. The x-axis 526 is the element amplitude taper parameter or varying cosine fraction parameter as defined in FIG. 5A. The y-axis 502 is the Gibbs phenomena metric or “Gibbs metric” which is a measure of the average side lobe level, however in this instance this is measured in absolute dB rather than relative dB.

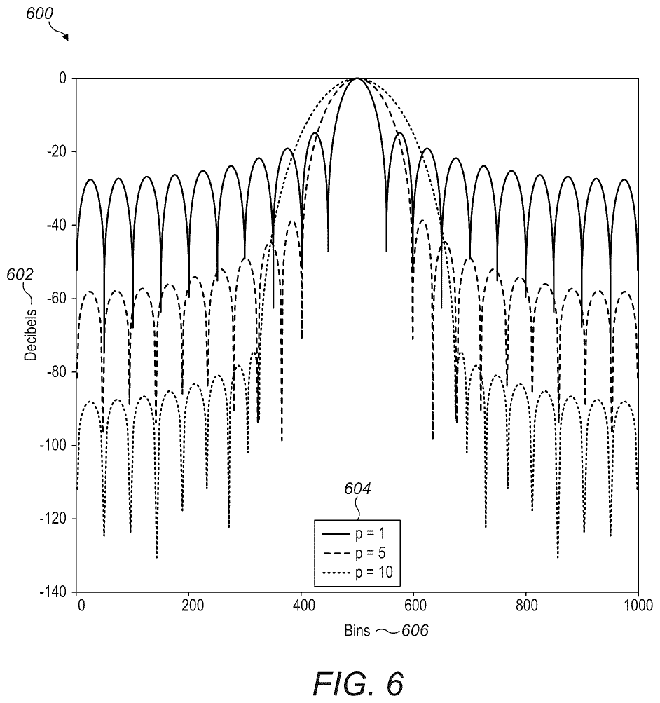

FIG. 6 shows a plot 600 of the Fast Fourier Transform (FFT) of a Kaiser window for parameters p=1, p=5, and p=10 (or a plot of the Fourier dual of Kaiser window) 604. The x-axis 606 is in bins. The y-axis 602 is in normalized decibels, with the reference level set as the main lobe level. The main lobe width increases with parameter values whereas the side lobes' average amplitude decreases. The Kaiser window concentrates the energy in the main lobe from the side lobes which results in a complete variation of main and side lobes. This example demonstrates the effect that amplitude tapering has not only on the side lobes but on the main lobe itself.

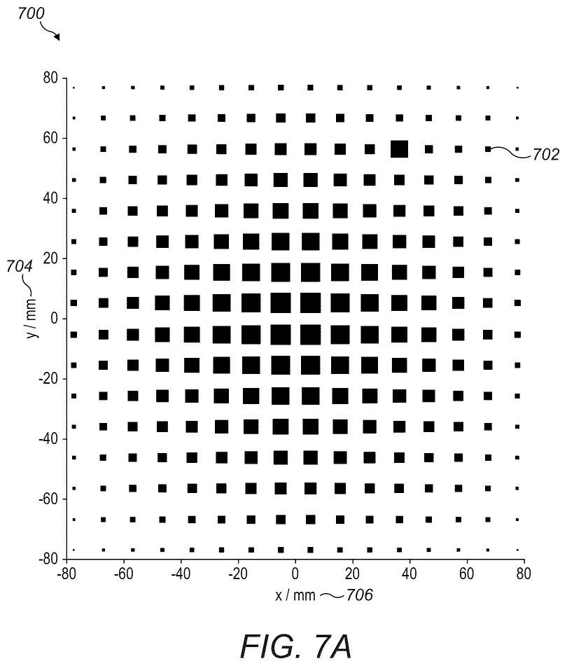

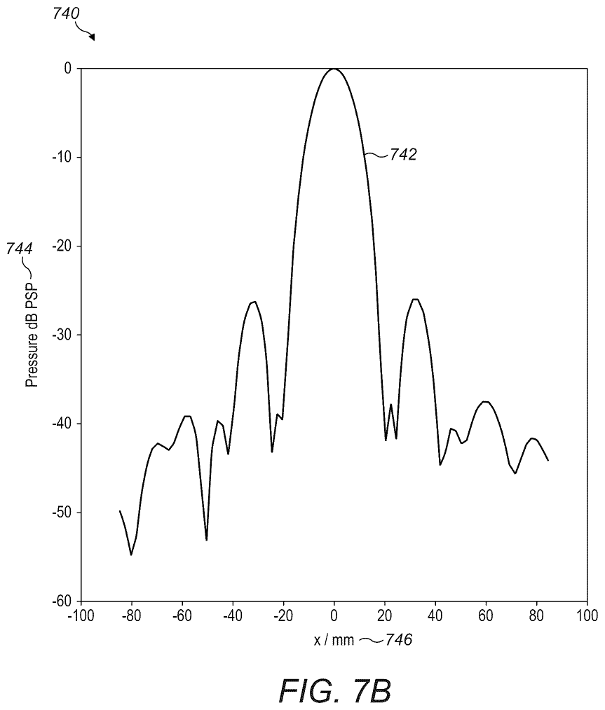

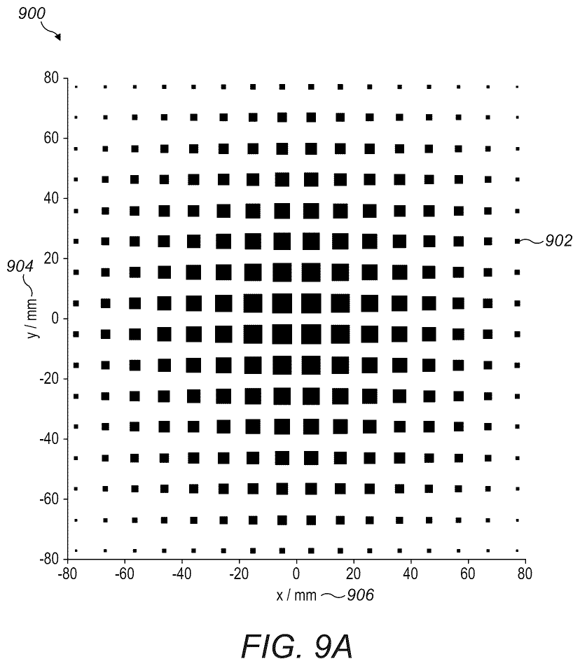

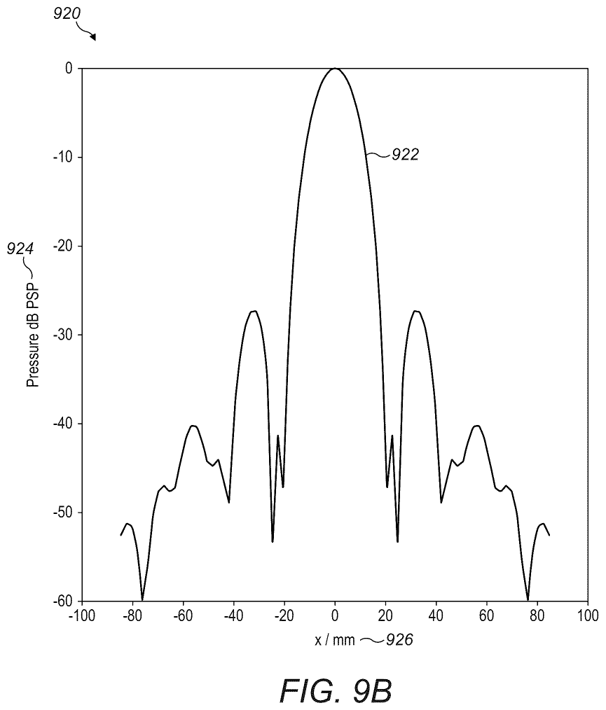

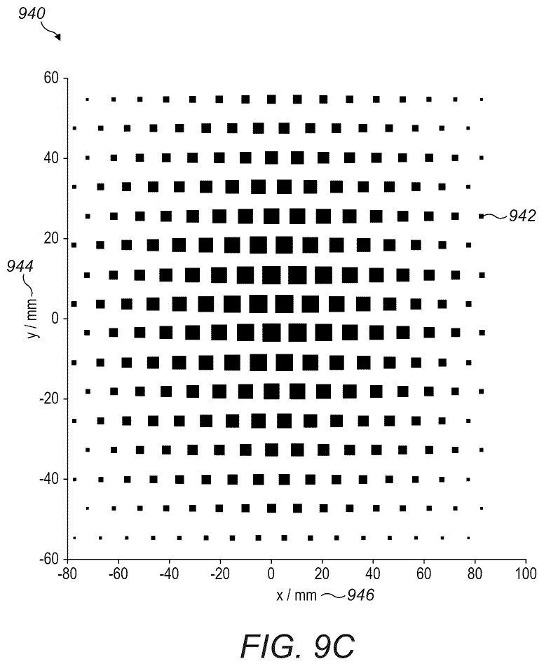

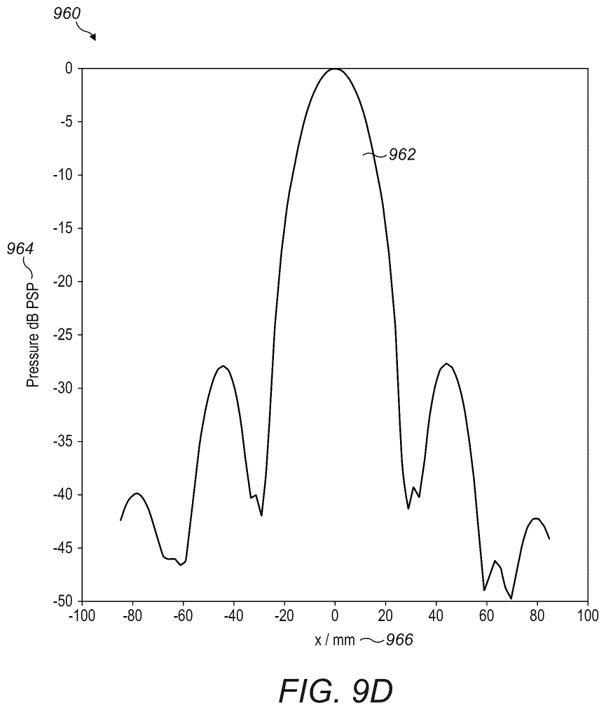

FIGS. 7A-7B show the Gibbs metric for an array with a discontinuity within the array. The array is rectilinear without critical spacing. The element amplitudes are that of the triangle window with a misfiring element at (38 mm, 58 mm). A single misfiring element adds sufficient Gibbs phenomena to decrease the effectiveness of the window, with the Gibbs metric increasing compared to the results in FIGS. 9A-9D, however despite the misfiring element the Gibbs metric is much lower than the uniformly driven case.

FIG. 7A shows a plot 700 of the element amplitudes 702 for a misfiring element 701 for triangle window. The x-axis 706 is in mm. The y-axis 704 is in mm.

FIG. 7B shows a plot 740 of directivity 742 for the misfiring array. The x-axis 746 is in mm, the y-axis 744 is in normalized pressure dB PSP, with the reference level set as the focus pressure.

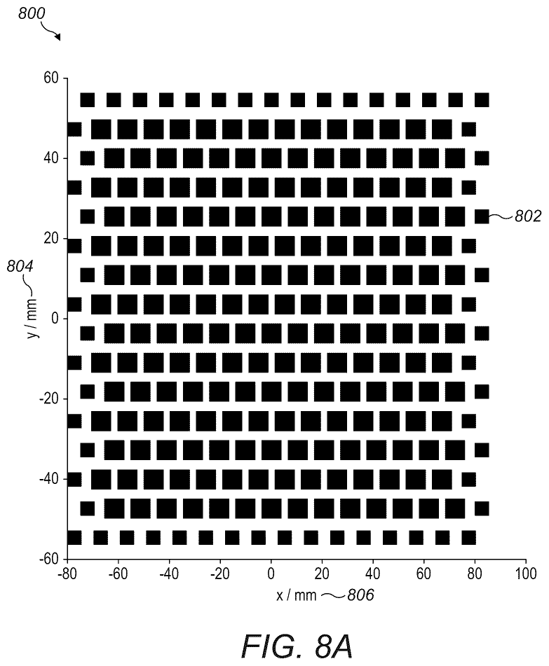

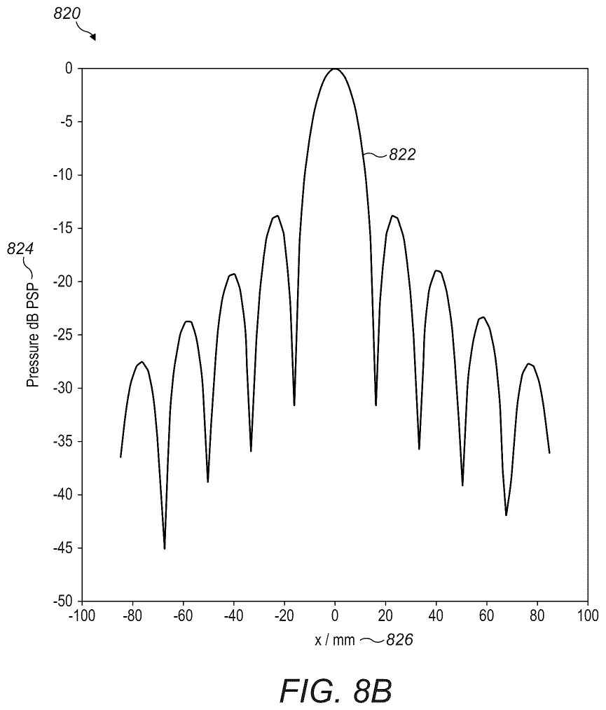

FIGS. 8A-8B show the performance of a simplified window. The array is hexagonal without critical spacing. A window has been considered where all the elements on the boundary are driven at half the amplitude of the internal elements. This produces a reduction to the Gibbs metric, but it is minimal compared to smoother tapering methods.

FIG. 8A shows a schematic 800 of the transducer amplitudes for array 802 for a simplified window. The x-axis 806 is in mm and the y-axis 804 is in mm.

FIG. 8B shows a plot 820 of directivity 822 for the simplified window. The x-axis 826 is in mm, the y-axis 824 is in normalized pressure dB PSP, with the reference level set as the focus pressure.

FIGS. 9A-9D show comparing the effectiveness of windowing for hexagonally packed arrays. The arrays are not critically spaced. A triangle window has been applied to both the rectilinear array and the hexagonal array, with the side lobes and Gibbs metric shown. Comparing these results to the simplified window in FIGS. 8A-8B, the Gibbs metric is much lower. Both packing layouts show windowing to be effective, with the rectilinear layout slightly more so.

FIG. 9A shows a schematic 900 of the transducer amplitudes for array 902 for a triangle window on a rectilinear array. The x-axis 904 is in mm and the y-axis 906 is in mm.

FIG. 9B shows a plot 920 of directivity 922 for the triangle window on a rectilinear array. The x-axis 926 is in mm, the y-axis 924 is in normalized pressure dB PSP, with the reference level set as the focus pressure.

FIG. 9C shows a schematic 940 of the transducer amplitudes for array 942 for a triangle window on a hexagonal array. The x-axis 946 is in mm and the y-axis 944 is in mm.

FIG. 9D shows a plot 960 of directivity 962 for the triangle window on a hexagonal array. The x-axis 966 is in mm, the y-axis 964 is in normalized pressure dB PSP, with the reference level set as the focus pressure.

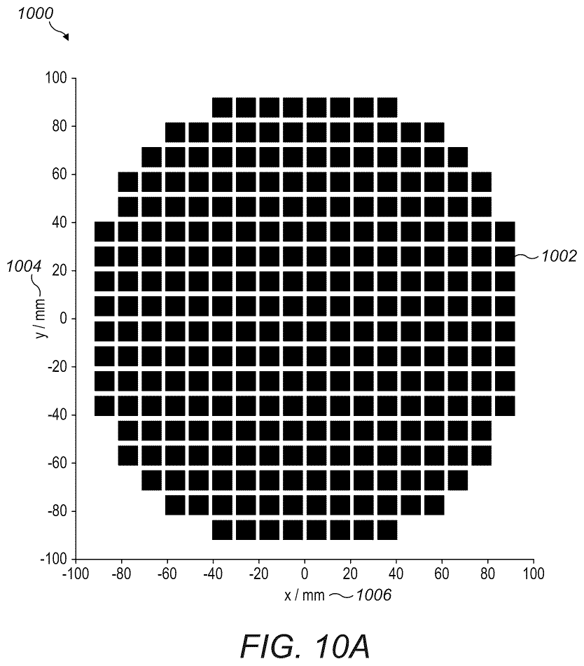

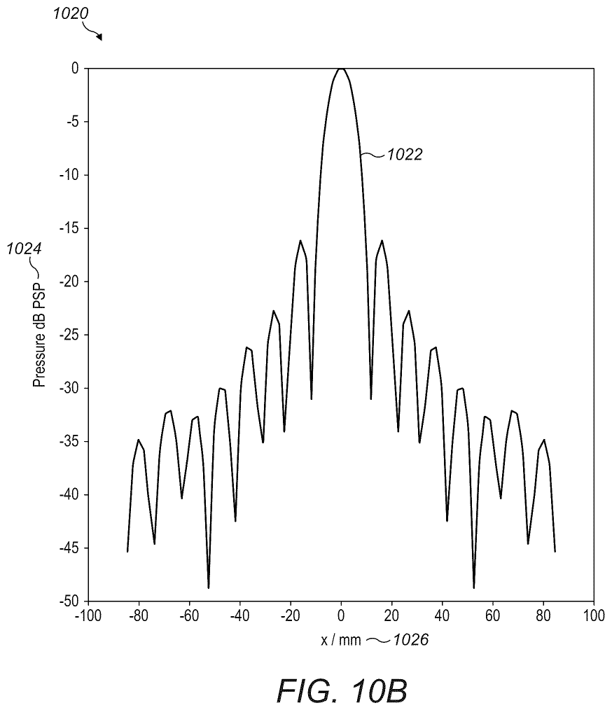

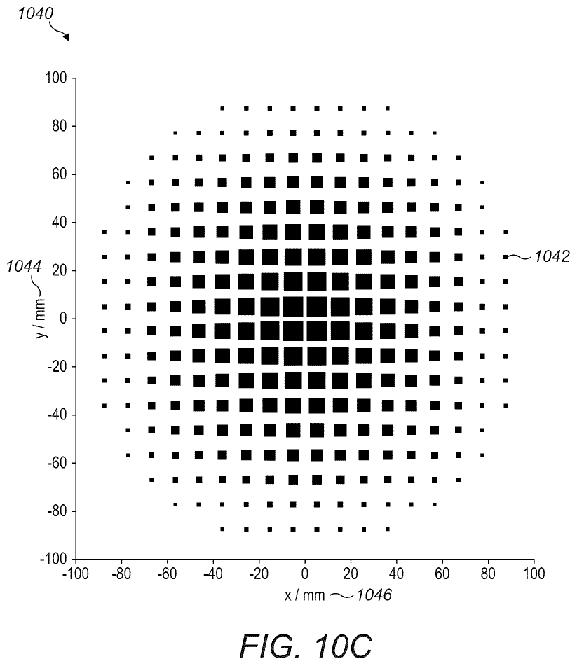

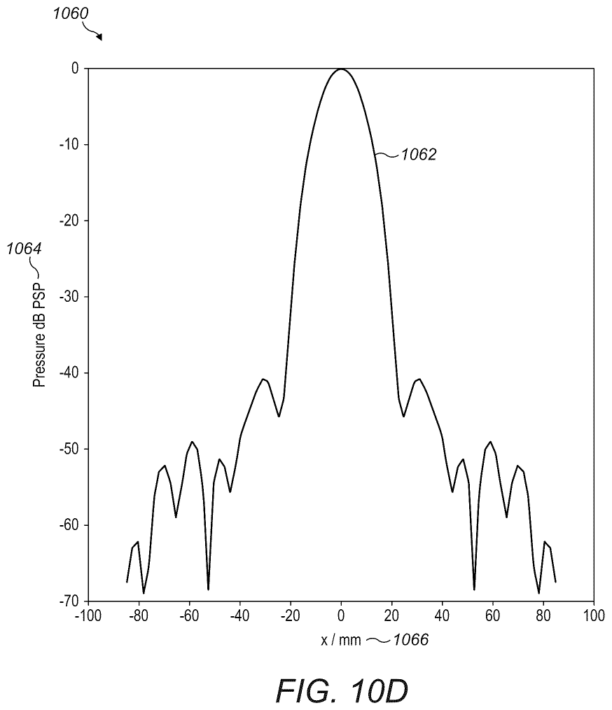

FIGS. 10A-10D show the transducer amplitudes for a circular array driven with and without amplitudes sampled from a Gaussian distribution, showing a reduction of Gibbs phenomena due to tapering. The array is arranged linearly with critical spacing. The Gibbs phenomena is shown in the sample dataset and shows the windowed array emitting lower energy side lobes compared to the uniformly driven case. The circular array also shows a dramatic reduction of Gibbs metric to the uniform setting.

FIG. 10A shows a schematic 1000 of the transducer amplitudes for a uniformly driven circular array 1002. The x-axis 1006 is in mm and the y-axis 1004 is in mm.

FIG. 10B shows a plot 1020 of directivity 1022 for uniformly driven amplitudes. The x-axis 1026 is in mm, the y-axis 1024 is in normalized pressure dB PSP, with the reference level set as the focus pressure.

FIG. 10C shows a schematic 1040 of the transducer amplitudes for a Gaussian window circular array 1042. The x-axis 1046 is in mm and the y-axis 1044 is in mm.

FIG. 10D shows a plot 1060 of directivity 1062 for Gaussian window amplitudes. The x-axis 1066 is in mm, the y-axis 1064 is in normalized pressure dB PSP, with the reference level set as the focus pressure.

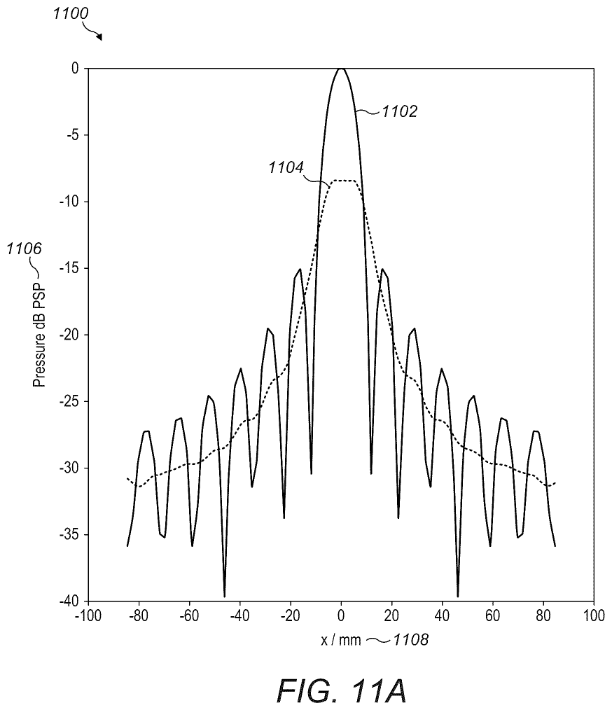

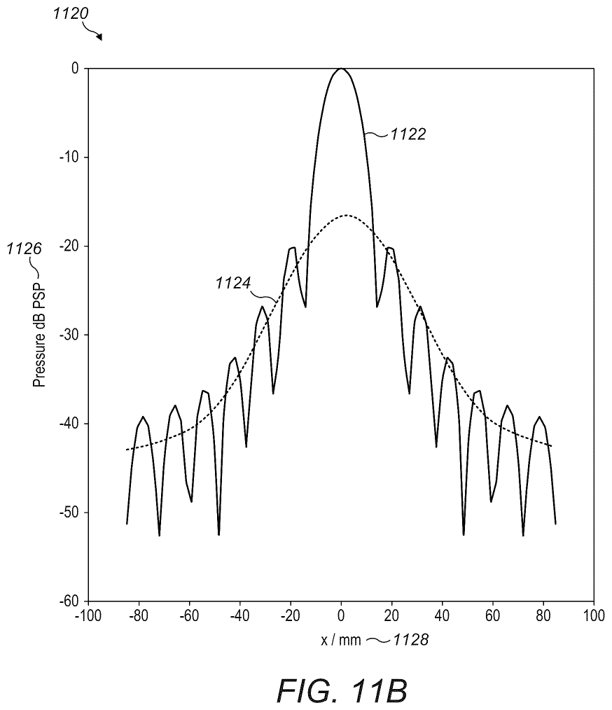

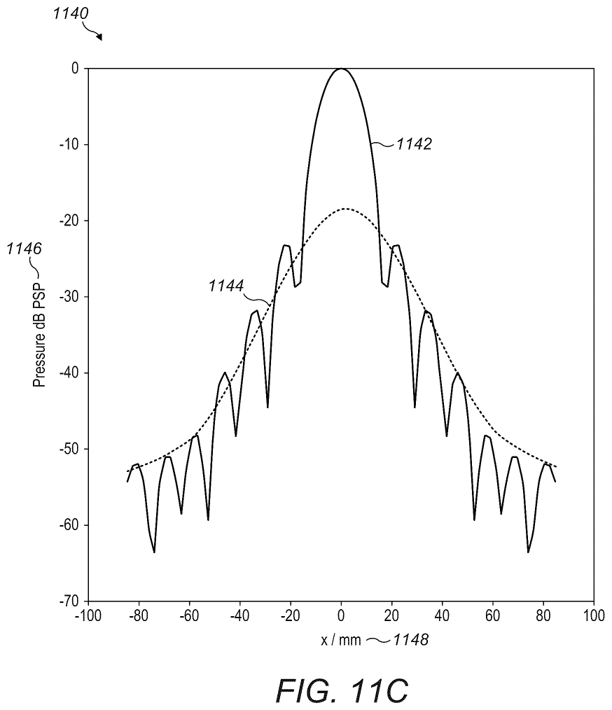

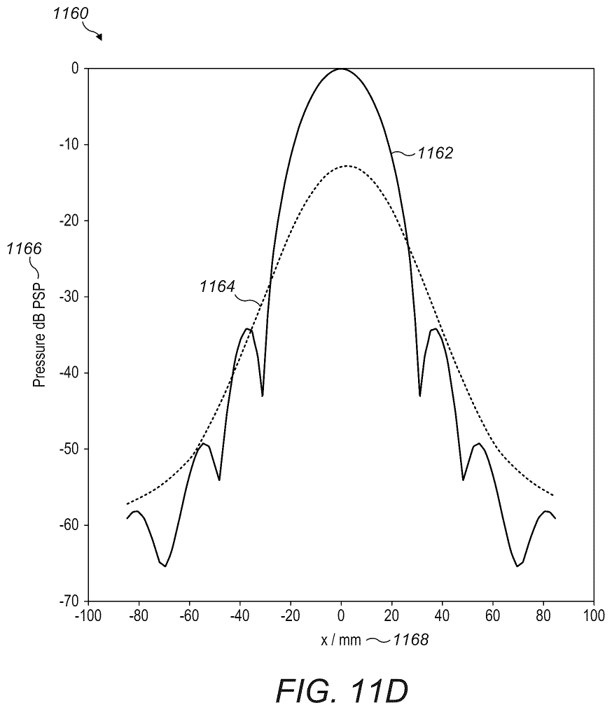

FIGS. 11A-11D show the directivity patterns for the acoustic field and a smoothed dotted trendline to show the effect of increasing the smoothness of the element amplitudes as the figures progress from FIG. 11A to FIG. 11D. The figures show the directivity pattern in the sample region for increasingly continuous element amplitude profiles, with the discontinuous (to the surroundings) minimum-energy solution (FIG. 11A) producing the smallest side lobe level improvement, supporting the theorem on decay rate.

FIG. 11A shows a plot 1100 of a directivity pattern 1102 and a smoothed directivity pattern 1104 for the set of amplitudes derived from the minimum energy solution. The x-axis 1108 is in mm, the y-axis 1106 is in normalized pressure dB PSP, with the reference level set as the focus pressure.

FIG. 11B shows a plot 1120 of a directivity pattern 1122 and a smoothed directivity pattern 1124 for the set of amplitudes derived from the solution of a second order partial differential equation (PDE). The x-axis 1128 is in mm, the y-axis 1126 is in normalized pressure dB PSP, with the reference level set as the focus pressure.

FIG. 11C shows a plot 1140 of a directivity pattern 1142 and a smoothed directivity pattern 1144 for the set of amplitudes derived from the solution of a fourth order partial differential equation (PDE). The x-axis 1148 is in mm, the y-axis 1146 is in normalized pressure dB PSP, with the reference level set as the focus pressure.

FIG. 11D shows a plot 1160 of a directivity pattern 1162 and a smoothed directivity pattern 1164 for the set of amplitudes derived from the bump function. The x-axis 1168 is in mm, the y-axis 1166 is in normalized pressure dB PSP, with the reference level set as the focus pressure.

Thus, solutions of increasing continuity are plotted in FIGS. 11B, 11C, and 11D, which show side lobe decay rate and continuity to be correlated. The best performing window for side lobe suppression is the bump function, which is infinitely differentiable, however results are restricted due to the discrete setting of the array.

FIG. 12 shows example evaluations 1200 of the bump functions for various shape factors 1202, a, for when r_{N}=1.5. The x-axis 1206 indicates the value for a. The y-axis 1204 shows the effect of modulating this function onto the fully driven amplitudes of the transducers without normalization-normalization in these cases would then take the highest amplitude derived to 1. In all cases the amplitude scaling factor A was set to 1.

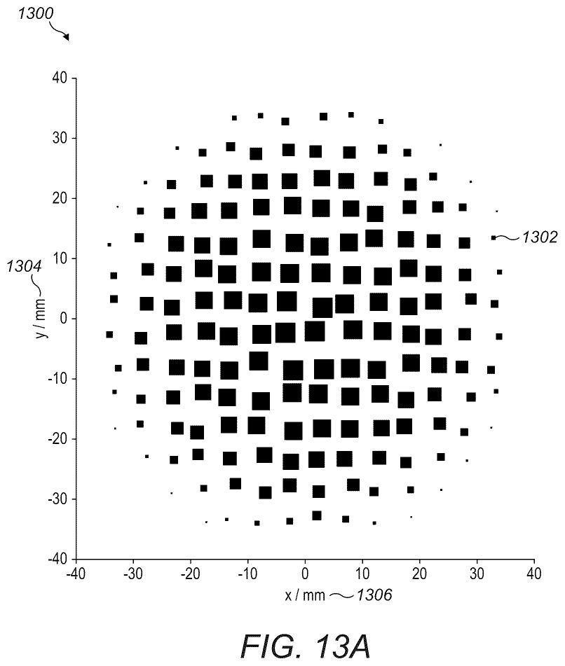

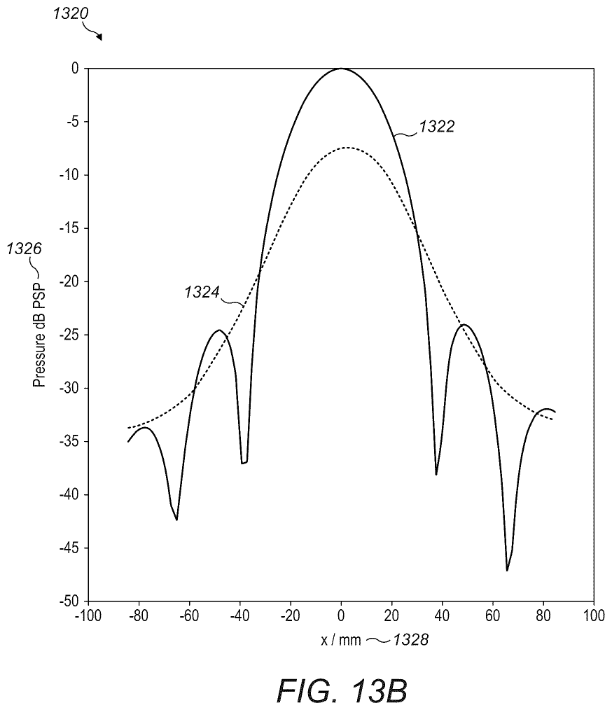

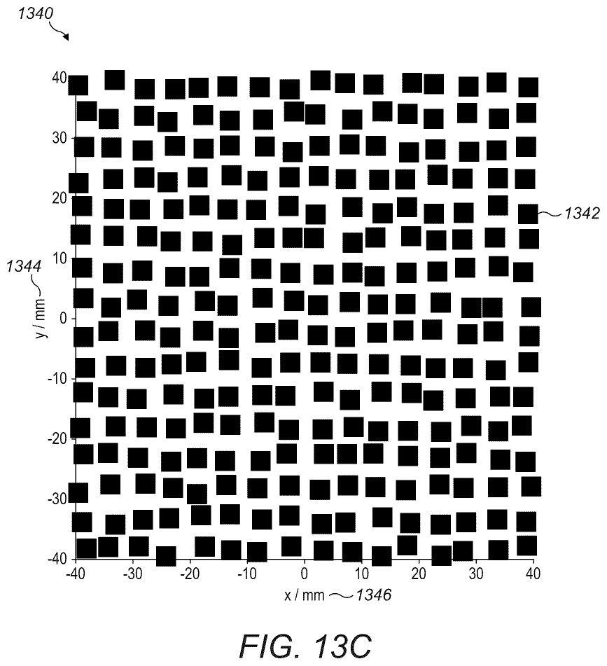

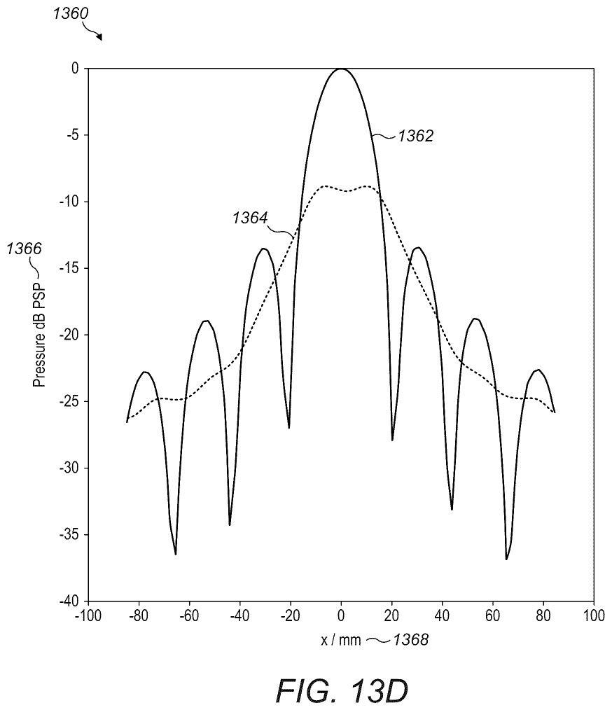

FIGS. 13A-13D show figures comparing the effectiveness of windowing for non-uniformly packed arrays. The arrays are critically spaced. A bump window has been applied to one array and uniform drives for the other, with the side lobes and Gibbs metric shown. Comparing these results between both arrays, the bump window produces a Gibbs metric much lower than the uniformly driven case. This demonstrates that windowing is effective for reducing side lobes in non-uniform arrays, with the bump window enabling a simple application of windowing to any array layout.

FIG. 13A shows a schematic 1300 of element amplitudes and location for a bump window on a non-uniform array 1302. The x-axis 1306 is in mm and the y-axis 1304 is in mm.

FIG. 13B shows a plot 1320 of directivity for the bump window on a non-uniform array. The solid line 1322 shows the side lobe levels and the dotted line 1324 shows the side lobe level trend. The x-axis 1328 is in mm, the y-axis 1326 is in normalized pressure dB PSP, with the reference level set as the focus pressure.

FIG. 13C shows a schematic 1340 of element amplitudes and location for uniformly driven amplitudes on a non-uniform array 1342. The x-axis 1346 is in mm and the y-axis 1344 is in mm.

FIG. 13D shows a plot 1360 of directivity for uniformly driven amplitudes on a non-uniform array. The solid line 1362 shows the side lobe levels and the dotted line 1364 shows the side lobe level trend. The x-axis 1368 is in mm, the y-axis 1366 is in normalized pressure dB PSP, with the reference level set as the focus pressure.

To demonstrate how imposing smooth decay at the boundary reduces the Gibbs metric, a series of figures have been included. The amplitude tends from a discontinuous square amplitude to a profile which decays smoothly within the array. The corresponding Gibbs metric is plotted alongside to demonstrate how eradicating the discontinuity reduces the size of the field susceptible to ultrasonic interference. FIG. 4A shows a series of 1D element amplitude profiles for an array of transducers, with an increasing parameter that increases the smoothness of the decay. Correspondingly, FIG. 4B shows that the Gibbs metric decreases as the smoothness increases, which reduces the ultrasonic interference microphones may be exposed to. Further illustrations on how simple window models reduce the side lobe level are given in FIGS. 8A and 8B. In FIG. 8A the transducers on the boundary are driven with half of the amplitude of the interior elements and the field in FIG. 8B shows reduced side lobe level, which is captured in a lower Gibbs metric.

To demonstrate amplitude tapering and its impact on the surrounding acoustic field FIGS. 1A-1D, 2A-2D and 3A-3D have been included. FIGS. 1A-1D show how uniformly driven amplitudes lead to a sample of the field resulting in a Gibbs metric of −22 dB resulting in the surrounding acoustic field having regions of high ultrasonic energy. FIGS. 2A-2D are the implementation of linear window which reduces the Gibbs metric to −35.37 dB for the same sample and notably reduces noise in the field significantly. FIGS. 3A-3D impose a sampled Gaussian distribution to reduce the Gibbs metric to −35.98 dB and slightly lower noise than previous examples although due to the logarithmic scale it is difficult to distinguish between FIGS. 2D and 3D. The similarity between FIGS. 2D and 3D add further benefit to the development of the Gibbs metric, as its use allows one to design precise and optimal systems. In the comparison between FIGS. 2A-2D and 3A-3D note that the transducer amplitudes have been scaled and clipped if they are above 1 (the maximum input signal that is valid for the transducer), which reduces the potential effectiveness of the windows in question. The concept central to this disclosure has been further explored with targeted Gibbs phenomena suppression, localized smoothing around missing nodes, and passive cover materials.

The imposition of windowing impacts the entire acoustic field emitted from the array, causing the shape of the main lobe to be altered as well as suppression of side lobes. The width of the main lobe may be parameterized using windowing, notably the Kaiser window parameterizes the ratio of energy from main lobe to side lobes as seen in FIG. 6. In array designs which permit grating lobes the use of windowing affects the grating lobes by shaping the main lobe, as the grating lobes are an alias of the main lobe, they follow its variation. Depending on the location of the focus and the grating lobes in space, windowing may lead to a reduction in grating lobe intensity due to being further from the high energy region of the array. One can ensure this is always the case by weighing the window amplitudes to ensure the high energy region of the array is always closer to the focus than any grating location. The use of amplitude tapering thus has profound effects on the entirety of the acoustic field.

The array and window characteristics are broadly discussed before specific examples are considered. The main factors explored here are element shape, interelement pitch, array packing, array shape, and the window smoothness. These factors are expanded upon below:

Element shape—The element shape is the shape of each individual transducer, which is assumed to be uniform. When considering the far field of the array, the directivity of a single element may be pulled out of the summation in [1]. This is seen in the literature on array factors, which is quite widely understood and most useful when considering the far field of the array, i.e., the directivity function of the transducer array as a whole in its far field mirrors the directivity of the far field when considering a single transducer element. As the element shape becomes independent of the array shape in the far field its impact on the effect of windowing is largely through weighting the acoustic field.

Interelement pitch—Pitch is the distance between the centroid of each transducer's aperture. Changing pitch has the biggest impact on the effect of windowing due to introducing aliasing. The side lobes are still effectively suppressed even in the presence of grating lobes, but grating lobes have sufficient energy for causing microphone interference.

Array packing—The packing is the distribution of transducers on the surface. Windowing is most effective on uniform array layouts, so only those are considered here. The two layouts of interest are hexagonal and rectilinear packing. Windowing is effective for both, however in combination with the rectilinear packing approach it is slightly more effective. An example is shown in FIGS. 9A-9D where triangle tapering of amplitudes is effective for reducing the side lobe level for both hexagonal and rectilinear. Non-uniform array layouts are also receptive to windowing, with FIGS. 13A-13D showing a dramatic reduction in the Gibbs Metric between a uniformly driven non-uniform array and a bump windowed one. The windowing methods developed here (PDE and bump) apply effortlessly to non-uniform settings as they are defined on element location (centroid of the transducer aperture).

Array shape—The shape of the array is found by only considering the transducers on the boundary of the array. The size of the array has an important impact on the effectiveness of measuring windowing through the Gibbs Metric. Notably, the size of the array determines the size of the main lobe so one may need to scale the sample of the field appropriately to capture the side lobe regions. The array shape has little impact, as FIGS. 10A-10D show a significant reduction for side lobes when windowing on a circular array as well as a square array. Note rectangular arrays behave similarly to square arrays.

Window smoothness—The window smoothness depends upon how effectively the transducer amplitudes sample the continuous window function. Introducing just one transducer that breaks the smoothness of the window profile leads to a rise of side lobe level, this is seen in FIGS. 7A-7B with the increase of the Gibbs Metric. Methods to mitigate the impact of a deterministic discontinuity due to element error have been developed in the U.S. patent application Ser. No. 18/092,431, filed on Jan. 2, 2023, which is incorporated by reference herein in its entirety.

While there are many possible window functions, the output of the phased array displays the particular characteristics which can be identified when using window functions which taper into a discontinuity. The relationship is defined in the side lobe drop off rate theorem: If the spatial function of a window, w(xₙ, fₙ), is continious and bounded for the first n derivatives, then its side lobes will decay at the rate of r⁻⁽ⁿ⁺¹⁾ as r→∞:

$$p ( r ) = 0 ( {r}^{- ( n + 1 )} ) , r \to ∞ .$$

This theorem is stated and proved in theorem 3.14 of (Prabhu, 2013) and page 92 of (Papoulis, 1977), and both hold for any arbitrary window function. The theorem is explicitly derived for continuous Fourier transforms but holds for the discrete case as demonstrated in Chapter 4: Theorem 3 of (Trefethen, 2000). The discretization introduces an aliasing error due to the resolution of sampling of the window, this aliasing error is always present in any discretized system but may be suppressed by uniform sampling at Nyquist or higher resolutions if possible. Hence by the side lobe drop off rate one may derive the continuity and differentiability of the function used to taper the element amplitudes. FIGS. 11A-11D validate the theorem for acoustic arrays, as plots of the directivity pattern for increasingly continuous amplitudes indeed show the side lobe decay rate increasing. The minimum-energy solution is typically not required to be continuous and differentiable at the boundary of the array, giving the slowest side lobe decay of all those considered in FIGS. 11A-11D.

To demonstrate how the continuity conditions at the boundary of window function determines the asymptotic behavior of the side lobes the Helmholtz equation is examined. The side lobe behavior may be approximated by taking the Fourier transform:

$$\begin{matrix}\tilde{w} ( k ) & = {\int }_{- ∞}^{∞} w ( x ) {e}^{ikx} dx = {\int }_{- L}^{L} w ( x ) {e}^{ikx} dx \\ & = {[ w ( x ) \frac{{e}^{ikx}}{ik} ]}_{- L}^{L} - {\int }_{- L}^{L} \frac{dw ( x )}{dx} \frac{{e}^{ikx}}{ik} dx ,\end{matrix}$$

where integration by parts (IBPs) has been applied. Applying the boundary condition, setting w(±L)=0 and applying IBPs again:

$$\tilde{w} ( k ) = - {[ \frac{dw ( x )}{dx} \frac{{e}^{ikx}}{{( ik )}^{2}} ]}_{- L}^{L} + {\int }_{- L}^{L} \frac{{d}^{2} w ( x )}{{dx}^{2}} \frac{{e}^{ikx}}{{( ik )}^{2}} dx .$$

Giving the asymptotic behavior:

$$\vert \tilde{w} ( k ) \vert ∼ \frac{C}{{k}^{2}} , \vert k \vert \to ∞ .$$

For any general window function the expansion may be derived:

$$\tilde{w} ( k ) = {\sum }_{n = 0}^{∞} {\frac{{( - 1 )}^{n}}{{( ik )}^{n + 1}} [ \frac{{d}^{n} w ( x )}{{dx}^{n}} {e}^{ikx} ]}_{- L}^{L} ,$$

then if one considers a window function which is continuous up to the mth derivative, then the expansion becomes:

$$\tilde{w} ( k ) = {\sum }_{n = m}^{∞} {\frac{{( - 1 )}^{n}}{{( ik )}^{n + 1}} [ \frac{{d}^{n} w ( x )}{{dx}^{n}} {e}^{ikx} ]}_{- L}^{L} .$$

The asymptotic behavior would become:

$$\vert \tilde{w} ( k ) \vert \sim \frac{C}{{k}^{m + 1}} , \vert k \vert \to ∞ ,$$

confirming the theorem for the side lobe decay rate.

Windowing functions have a long history in signal processing. Applying them to a time-domain signal allows for detailed spectral analysis by reducing sidelobes in Fourier analysis. In this way, mixed frequency signals can be separated or analyzed in ways not possible without first windowing the input data. Beyond this, they are useful in filter design, statistics, and analyzing transient events. This invention details a novel application of windowing: instead of applying the window function to data in the time-domain, the window is applied to modulate the output of an acoustic transducer array. The window is now applied to a spatial dimension, not to time-domain data signal. The sidelobes which are reduced are spatial, not frequency. The resulting effect reduces a measurable, fringing field, reducing any potential effects generated by ultrasound interacting with devices not designed for such input.

### II. Targeted Apodization Schemes for the Reduction of Ultrasonic Interference

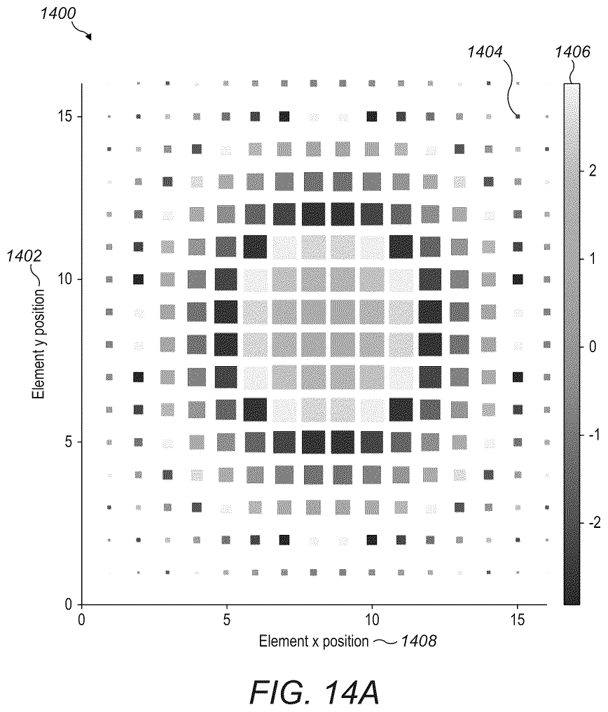

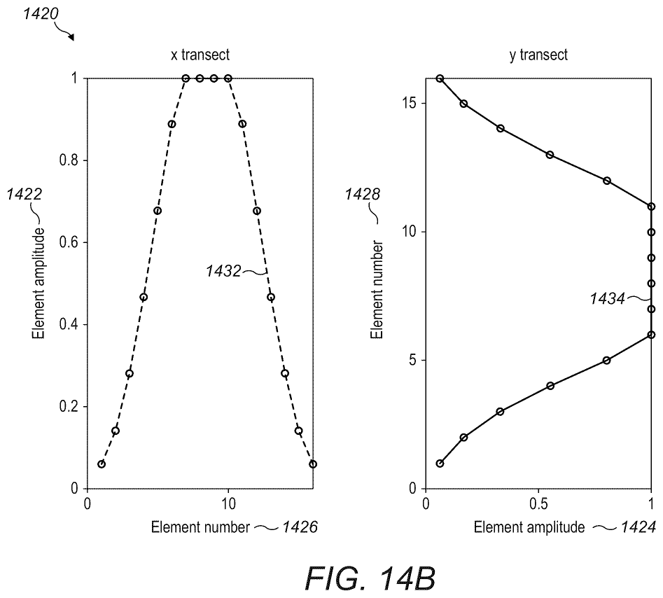

FIGS. 14A and 14B show an example of a two-dimensional apodization applied to an array. FIG. 14A shows a plot 1400 with the transducer distribution 1404 where the phase of each transducer element is described by shading and the normalized input driving signal amplitude of each transducer element is described by square size 1406. The x-axis 1408 shows the ordinal position of the element along the x-axis of a rectilinear layout transducer array. The y-axis 1402 shows the ordinal position of the element along the y-axis of a rectilinear layout transducer array. FIG. 14B shows plots 1420 of a transect in the x-direction with respect to the transducer array 1432 and a transect in the y-direction with respect to the transducer array 1434. The axes 1426 1428 are element numbers in an ordinal counting of transducer elements of a rectilinear transducer array layout along their respective row and column. The axes 1422 1444 are element amplitude, normalized between a zero-input signal and the maximum permissible input signal amplitude and thus output pressure represented by a 0 and 1 in amplitude respectively.

The apodization in this case is an amplitude tapering in line with a Chebyshev window function profile to determine the level of background interference.

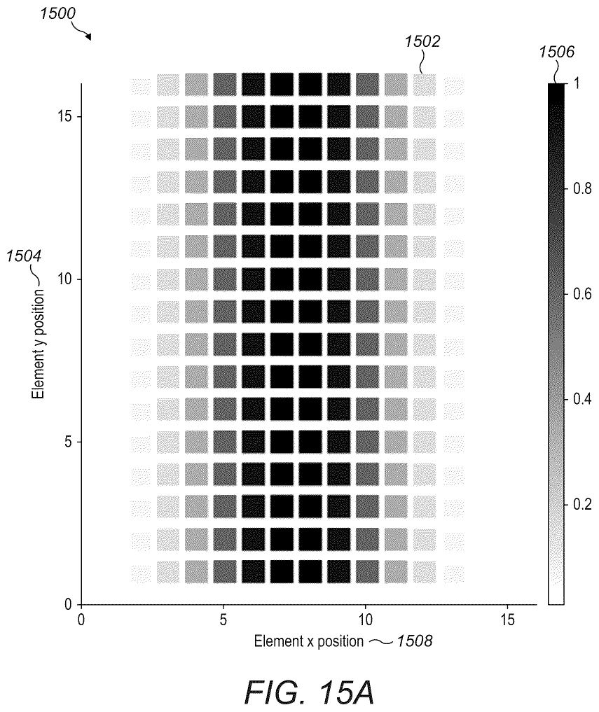

FIGS. 15A and 15B show an example of dimensional reduction applied to the apodization applied. FIG. 15A shows a plot 1500 with the transducer distribution 1502 where the normalized input driving signal amplitude of each transducer element is described by shading 1506. The x-axis 1508 shows the ordinal position of the element along the x-axis of a rectilinear layout transducer array. The y-axis 1504 shows the ordinal position of the element along the y-axis of a rectilinear layout transducer array. FIG. 15B shows plots 1520 of a transect in the x-direction with respect to the transducer array 1526 and a transect in the y-direction with respect to the transducer array 1528. The axes 1530 1532 are element numbers in an ordinal counting of transducer elements of a rectilinear transducer array layout along their respective row and column. The axes 1522 1524 are element amplitude, normalized between a zero-input signal and the maximum permissible input signal amplitude and thus output pressure represented by a 0 and 1 in amplitude respectively. In this case the apodization is only applied in the x-direction, with the y-direction remaining unapodized. Hence, the x-direction and y-direction transects have quite different amplitude profiles.

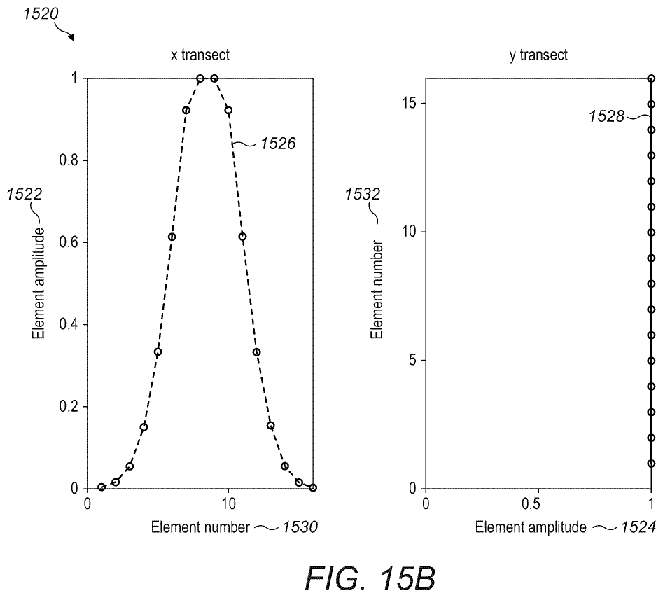

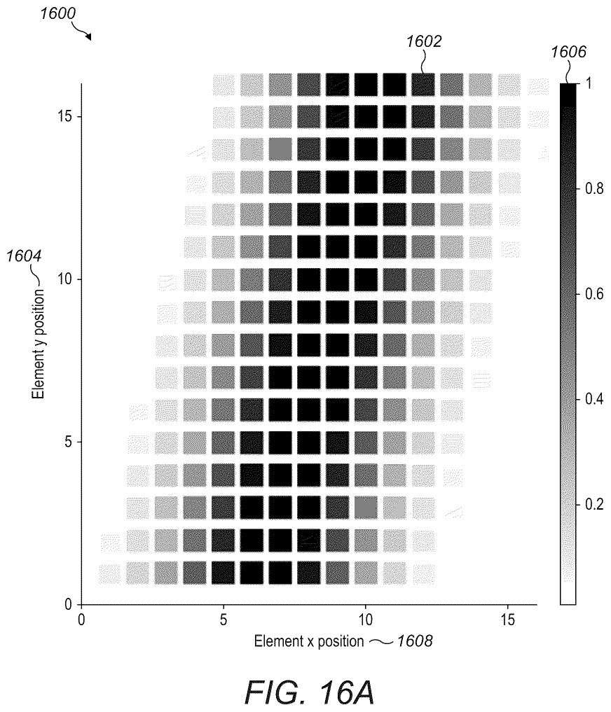

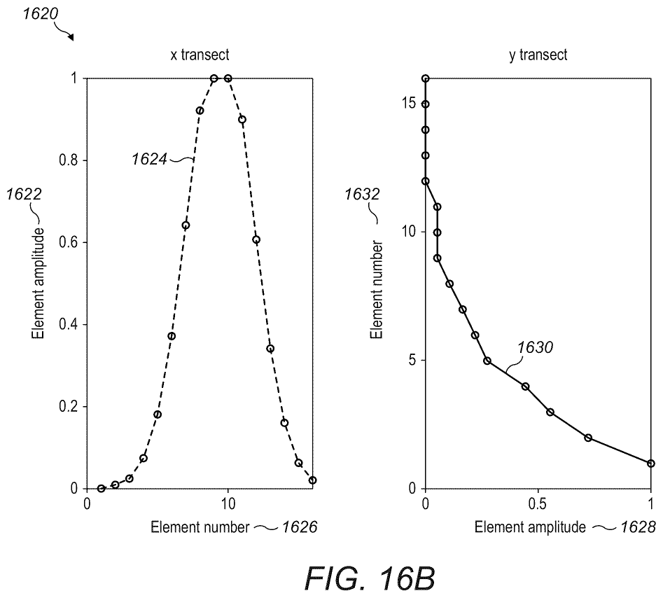

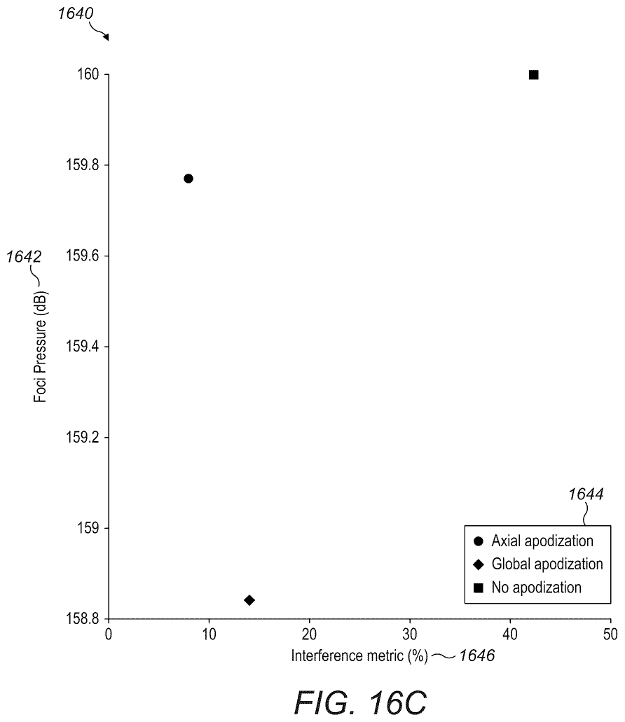

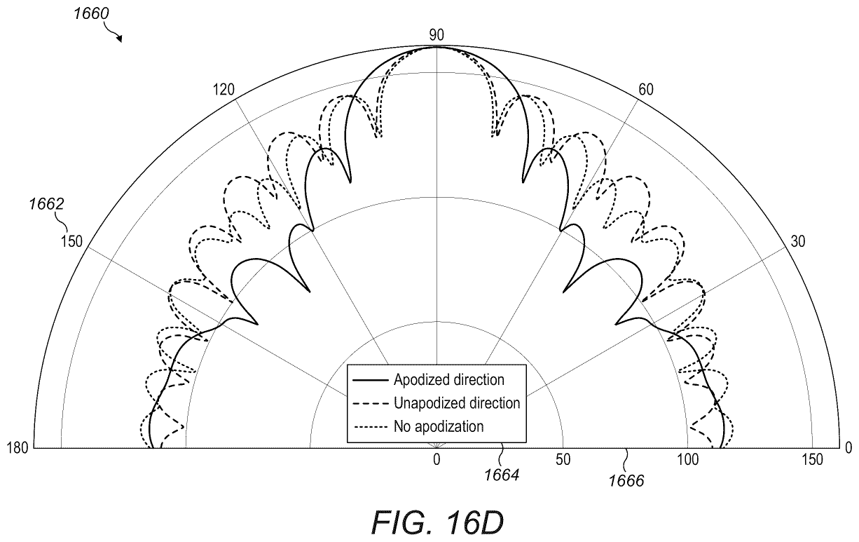

FIGS. 16A-16D show element amplitudes for an apodization targeted at a volume off axis (aligned directly with neither the transducer array x-axis nor the transducer array y-axis). FIG. 16A shows a plot 1600 with the transducer distribution 1602 where the normalized input driving signal amplitude of each transducer element is described by shading 1606. The x-axis 1608 shows the ordinal position of the element along the x-axis of a rectilinear layout transducer array. The y-axis 1604 shows the ordinal position of the element along the y-axis of a rectilinear layout transducer array. FIG. 16B shows plots 1620 of a transect in the x-direction with respect to the transducer array 1624 and a transect in the y-direction with respect to the transducer array 1630. The axes 1626 1632 are element numbers in an ordinal counting of transducer elements of a rectilinear transducer array layout along their respective row and column. The axes 1622 1628 are element amplitude, normalized between a zero-input signal and the maximum permissible input signal amplitude and thus output pressure represented by a 0 and 1 in amplitude, respectively.

The element amplitudes for an apodization targeted at a volume off axis. FIG. 16A shows an apodization in one direction, with the apodization direction angled off axis. FIG. 16B shows the x-direction and y-direction transects, demonstrating the angular property of the apodization which particularly causes the y-direction transect to have an unorthodox apodization shape. The null region is centered 15 degrees below the x-axis, leading to a rotated apodization.

FIG. 16C is a plot 1640 of a comparison of apodization 1644 with the x-axis 1646 is % of interference metric and the y-axis 1642 is in foci pressure in dB SPL. FIG. 16D is a polar plot 1660 of a comparison of apodization for an angular arc through the simulated emitted field on the apodization axis, an angular arc through the simulated emitted field perpendicular to the apodization axis and an angular arc through a simulated scenario with no apodization applied 1664 with the r-axis 1666 is in dB SPL and the angle θ 1662 is in degrees. Thus, FIG. 16C compares one-dimensional axial apodization with untargeted two-dimensional apodization and no apodization on reducing acoustic interference in a desired quiet volume and directivity. In FIG. 16D the apodized direction has lower sidelobes than both the unapodized direction and no apodization array. The interference metric shown in the figure is the percentage of the desired quiet region that remains above a target threshold level.

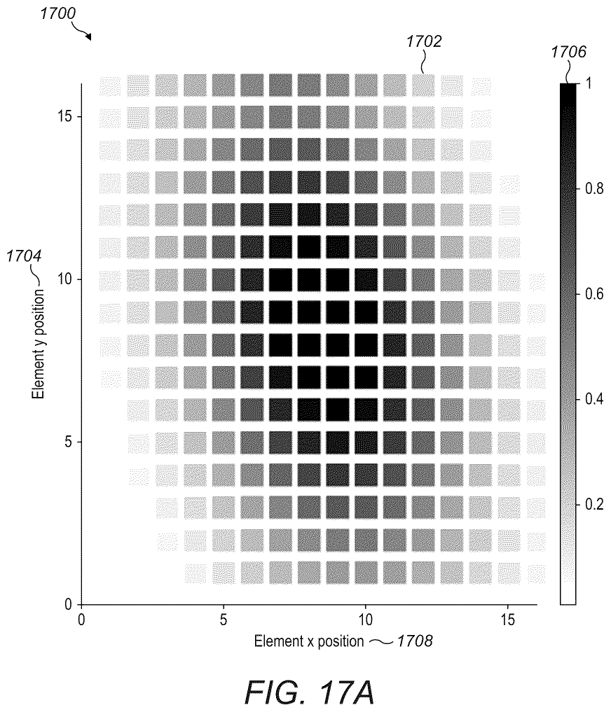

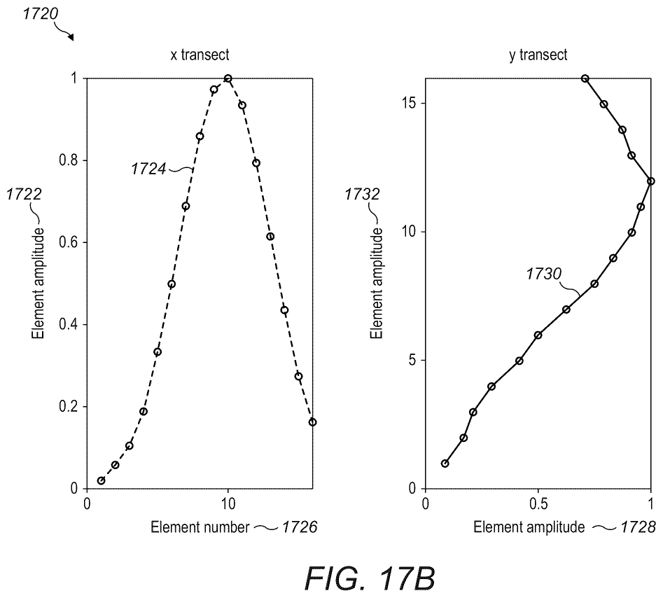

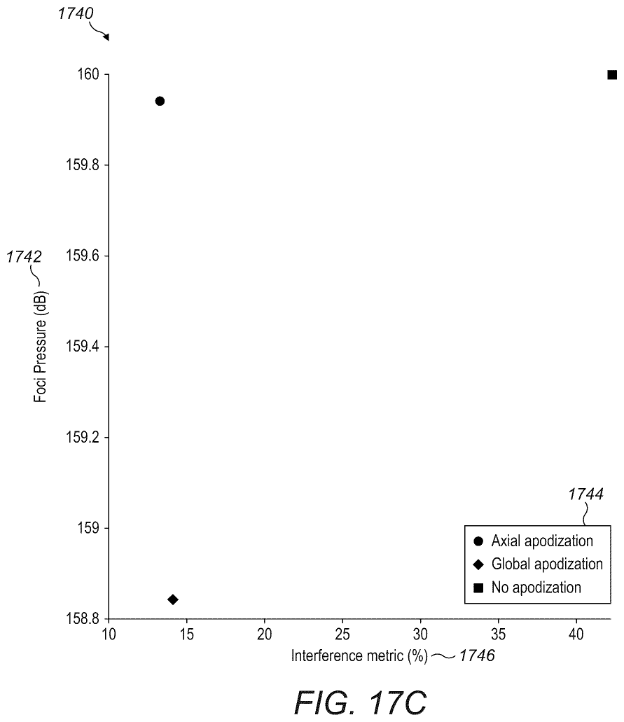

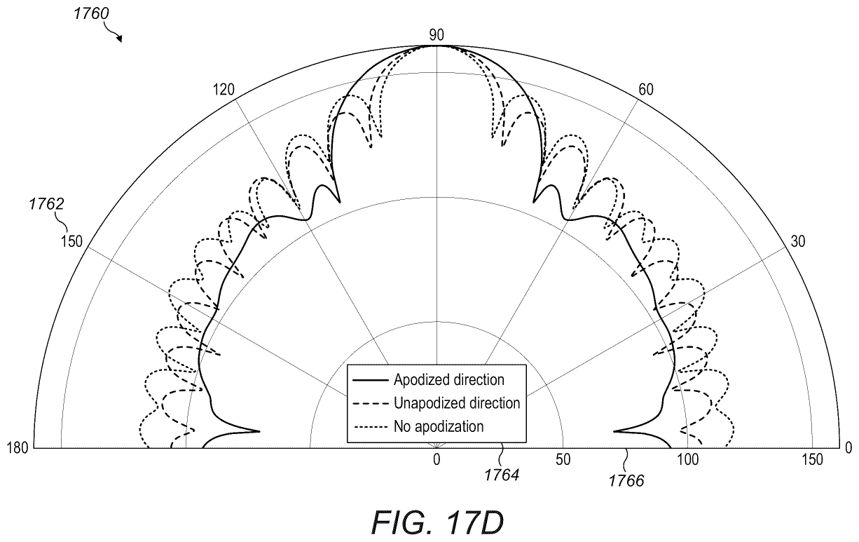

FIGS. 17A-17D show element amplitudes for a superposition of axial apodizations in order to generate two non-orthogonal null regions. FIG. 17A shows a plot 1700 with the transducer distribution 1702 where the normalized input driving signal amplitude of each transducer element is described by shading 1706. The x-axis 1708 shows the ordinal position of the element along the x-axis of a rectilinear layout transducer array. The y-axis 1704 shows the ordinal position of the element along the y-axis of a rectilinear layout transducer array. FIG. 17B shows plots 1720 of a transect in the x-direction with respect to the transducer array 1724 and a transect in the y-direction with respect to the transducer array 1728. The axes 1726 1732 are element numbers in an ordinal counting of transducer elements of a rectilinear transducer array layout along their respective row and column. The axes 1722 1728 are element amplitude, normalized between a zero-input signal and the maximum permissible input signal amplitude and thus output pressure represented by a 0 and 1 in amplitude, respectively. The element amplitudes for a superposition of axial apodizations in order to generate two non-orthogonal null regions. The null region is centered 15 degrees below the x axis with respect to the transducer array, with a second region at an angle of 60 degrees. This results in a gradient of element amplitudes in FIG. 17A and the contrasting peaks in FIG. 17B.

FIG. 17C is a plot 1740 of a comparison of apodization 1744 with the x-axis 1746 is % of interference metric and the y-axis 1742 is in foci pressure in dB SPL. FIG. 17D is a polar plot 1760 of a comparison of apodization for an angular arc through the simulated emitted field on one of the apodization axes, an angular arc through the simulated emitted field away from the apodization axes and an angular arc through a simulated scenario with no apodization applied 1764 with the r-axis 1766 is in dB SPL and the angle θ 1762 is in degrees. This FIG. 17C shows a comparison of the superposition of two one-dimensional axial apodizations with untargeted two-dimensional apodization and no apodization on reducing interference for two null regions. A reduction in side lobe levels in the apodized direction is evident in FIG. 17D, leading to a minute reduction in energy generated despite a significant reduction in unwanted ultrasonic interference. The interference metric shown in the figure is the percentage of the desired quiet region that remains above a target threshold level.

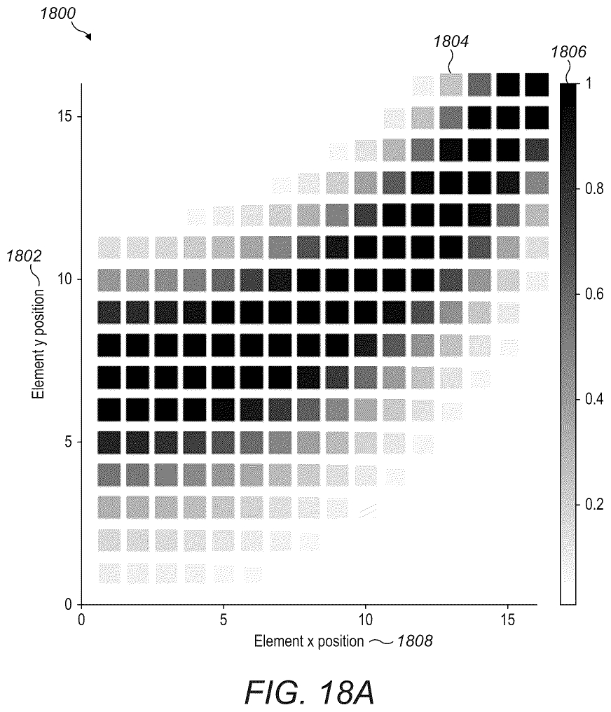

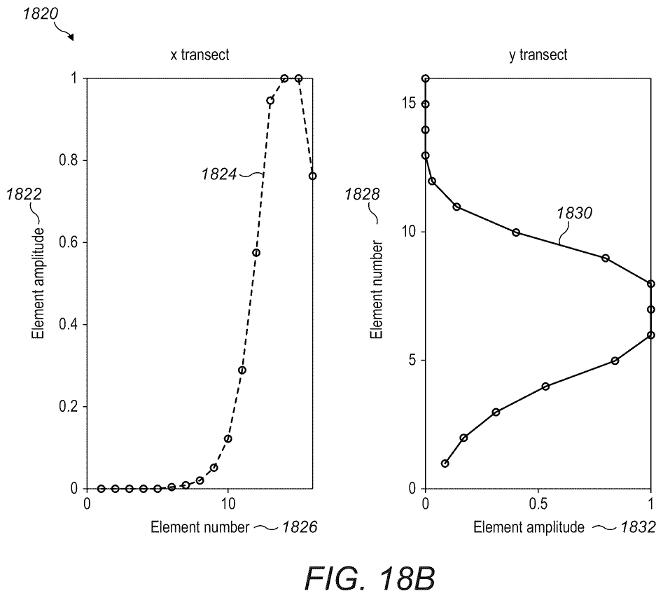

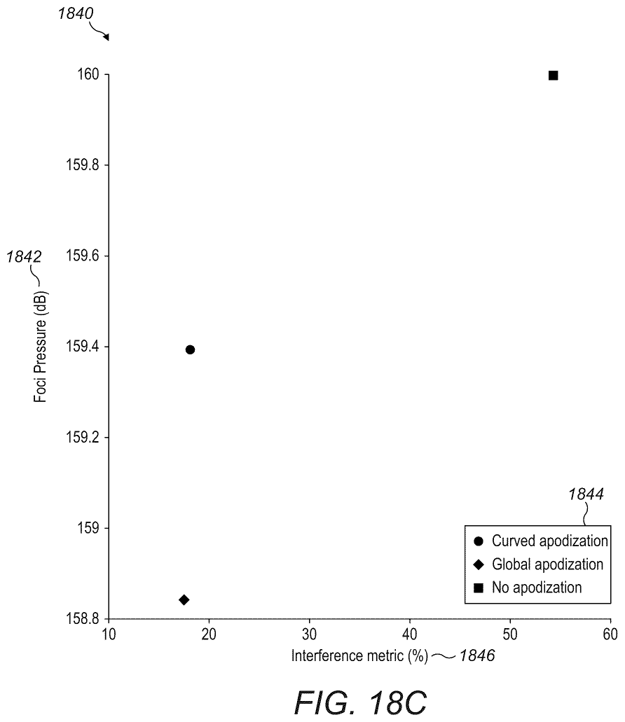

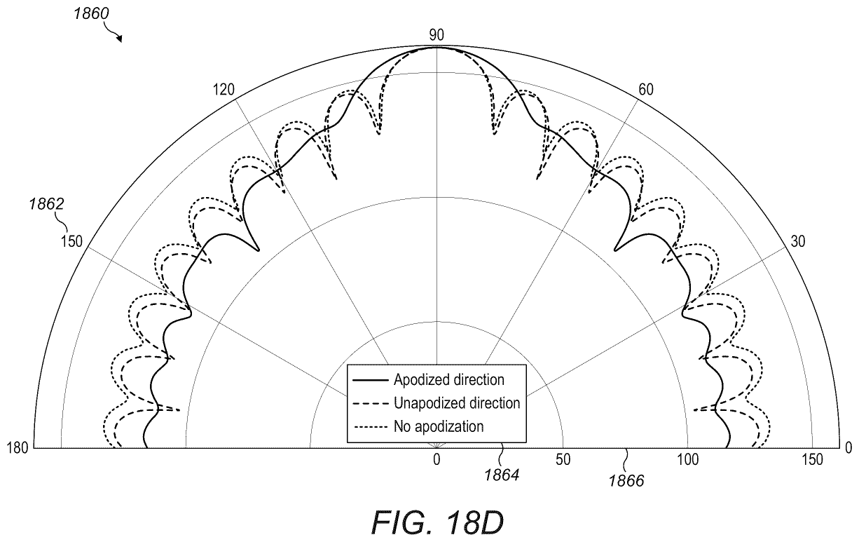

FIGS. 18A-18D show element amplitudes for a one-dimensional apodization in which the apodization axis is curved. FIG. 18A shows a plot 1800 with the transducer distribution 1804 where the normalized input driving signal amplitude of each transducer element is described by shading 1806. The x-axis 1808 shows the ordinal position of the element along the x-axis of a rectilinear layout transducer array. The y-axis shows 1802 the ordinal position of the element along the y-axis of a rectilinear layout transducer array FIG. 18B shows plots 1820 of a transect in the x-direction with respect to the transducer array 1824 and a transect in the y-direction with respect to the transducer array 1830. The axes 1826 1828 are element numbers in an ordinal counting of transducer elements of a rectilinear transducer array layout along their respective row and column. The axes 1822 1832 are element amplitude, normalized between a zero-input signal and the maximum permissible input signal amplitude and thus output pressure represented by a 0 and 1 in amplitude respectively. The orthogonal apodization is projected onto a curve which results in the curved element amplitude shading in FIG. 18A. This results in vastly different transects for the x-direction and y-direction with respect to the transducer array as shown in FIG. 18B.

FIG. 18C is a plot 1840 of a comparison of apodization 1844 with the x-axis 1846 is % of interference metric and the y-axis 1842 is in foci pressure in dB SPL. FIG. 18D is a polar plot 1860 of a comparison of apodization 1864 with the r-axis 1866 is in dB SPL and the angle θ 1862 is in degrees. This FIG. 18C is a comparison of one-dimensional apodization with untargeted two-dimensional apodization and no apodization on reducing interference for a curved apodization. The null apodization reduces sidelobe levels in FIG. 18D which results in the reduced interference without hindering the energy emission as severely, where an angular arc through the simulated emitted field substantially close to the curved apodization axis, an angular arc through the simulated emitted field substantially away from the apodization axis and an angular arc through a simulated scenario with no apodization applied are compared.

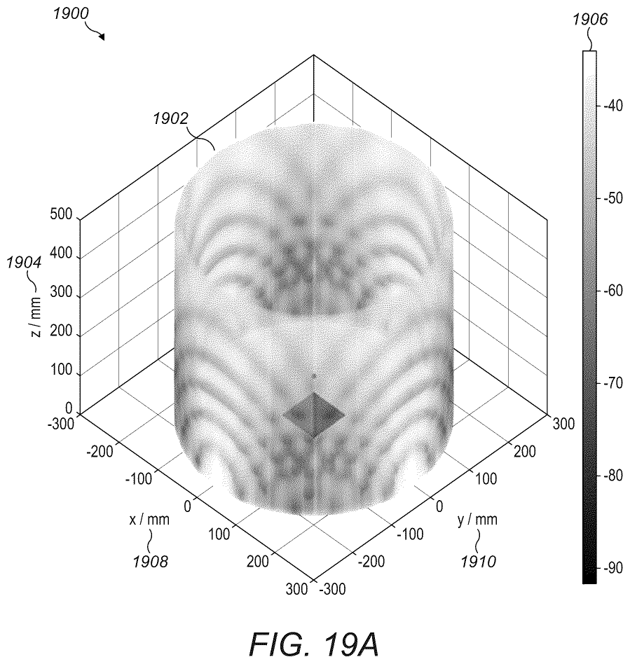

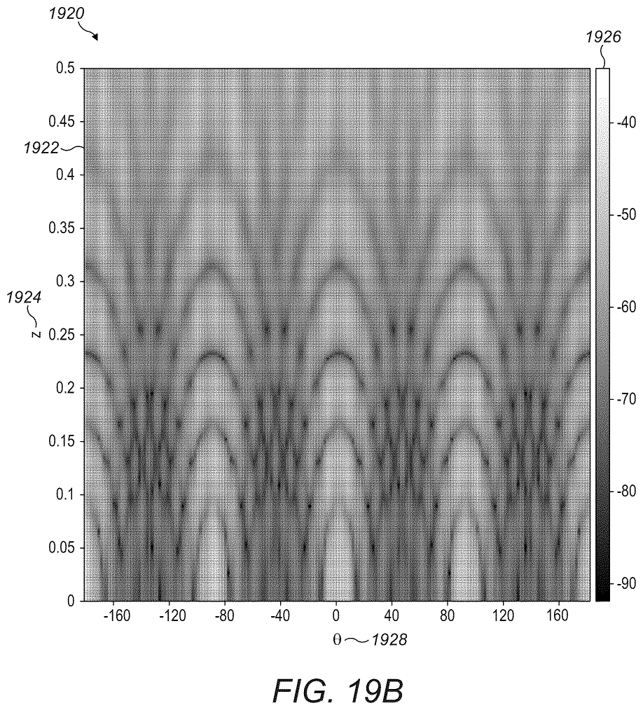

FIGS. 19A and 19B show the acoustic field distribution surrounding an ultrasonic array with no apodization. FIG. 19A shows a plot 1900 of a 3D acoustic field distribution 1902 measured in normalized pressure dB PSP, with the reference level set as the focus pressure 1906. The x-axis 1908, the y-axis 1910, and the z-axis 1904 are in mm. FIG. 19B shows a plot 1920 of a pressure-based acoustic field distribution 1922 measured in normalized pressure dB PSP, with the reference level set as the focus pressure 1926. The x-axis 1928 is angle θ in degrees. The y-axis 1924 is the z distance in the array coordinate system from the array centric x-y plane in meters. The array emits ‘rings’ of acoustics pressures along each edge, as seen in FIG. 19A. The unwrapped pressures in FIG. 19B show these rings having much greater energy than the remaining field.

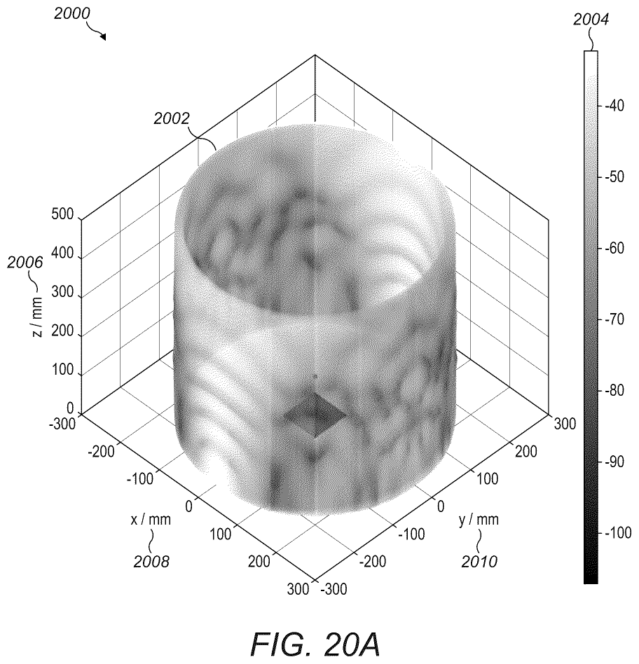

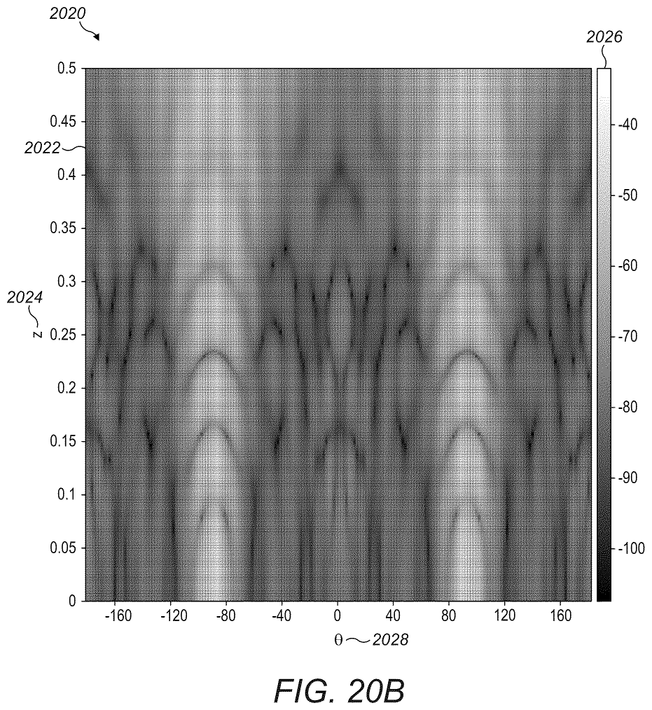

FIGS. 20A and 20B show the acoustic field distribution surrounding an ultrasonic array with one-dimensional axial apodization. FIG. 20A shows a plot 2000 of a 3D acoustic field distribution 2002 measured in normalized pressure dB PSP, with the reference level set as the focus pressure 2004. The x-axis 2008, the y-axis 2010, and the z-axis 2006 are in mm. FIG. 20B shows a plot 2020 of a pressure-based acoustic field distribution 2022 measured in normalized pressure dB PSP, with the reference level set as the focus pressure 2026. The x-axis 2028 is angle θ in degrees. The y-axis 2024 is the z distance in the array coordinate system from the array centric x-y plane in meters. Applying an apodization along one direction eliminates the high energy ‘rings’ and reduces ultrasonic interference significantly.

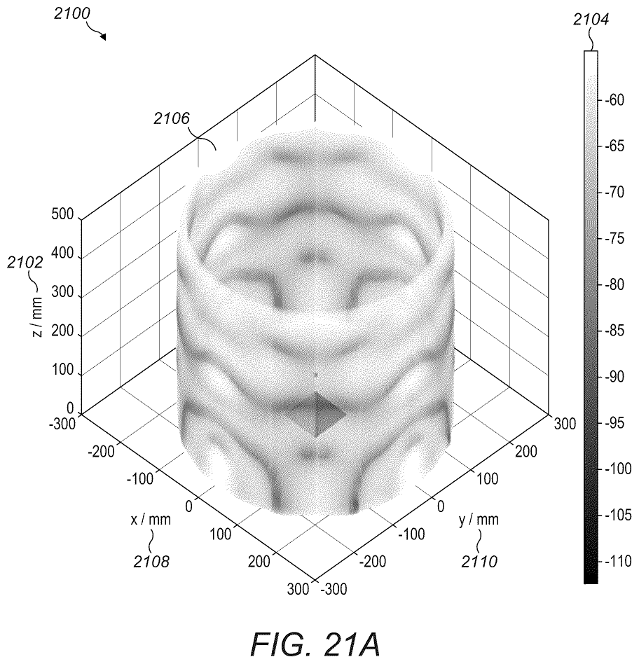

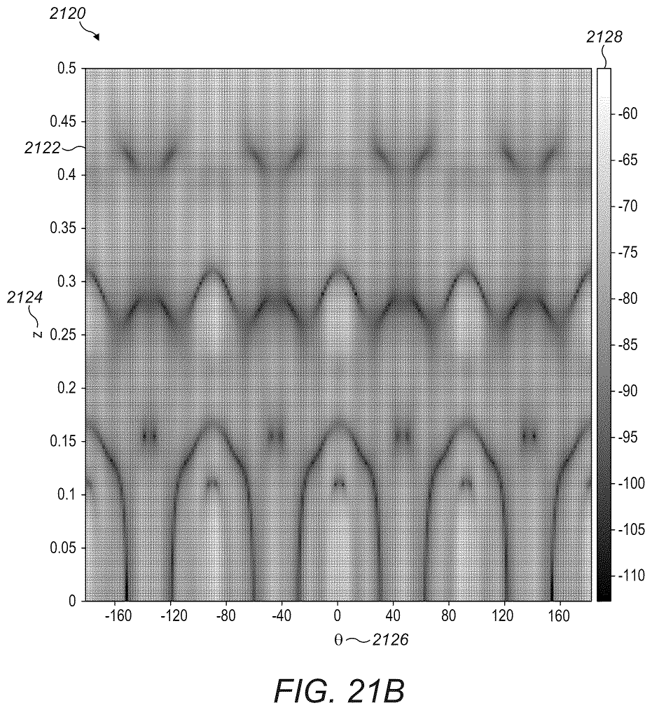

FIGS. 21A and 21B show the acoustic field distribution surrounding an ultrasonic array with untargeted two-dimensional apodization. FIG. 21A shows a plot 2100 of a 3D acoustic field distribution 2106 measured in normalized pressure dB PSP, with the reference level set as the focus pressure 2104. The x-axis 2108, the y-axis 2110, and the z-axis 2102 are in mm. FIG. 21B shows a plot 2120 of a pressure-based acoustic field distribution 2122 measured in normalized pressure dB PSP, with the reference level set as the focus pressure 2128. The x-axis 2126 is angle θ in degrees. The y-axis 2124 is the z distance in the array coordinate system from the array centric x-y plane in meters. The global apodization is shown to remove all the high energy ‘rings’ from the acoustic field.

An apodization is the tapering of each element's amplitude to achieve an overall scheme across a domain. In general, this technique is applied globally to the surface of a domain, to ensure an aim such as the suppression of side lobes, minimization of main lobe width, shaping of the field, or otherwise. The act of apodization fundamentally lowers the energy inputted into the domain and hence reduces the effective energy the domain may achieve at the foci. To mitigate energy reductions, a method has been developed in which apodization is only applied to a subset of the array domain, to maximize the energy in at the foci while suppressing it elsewhere. The commercial benefit is the suppression of noise leads to reductions of microphone interference over and above a global windowing approach when considering the required energy levels at the foci.

The novelty of the targeted apodization approach is that the apodization is only applied to a subdomain of the array as opposed to the domain globally, see FIGS. 14A and 14B for an illustration of global, untargeted apodization and FIGS. 15A and 15B for an example of targeted apodization. Different approaches to targeted apodization are shown in FIGS. 16A, 16B, 17A, 17B and 18A, 18B and show how well these approaches perform in FIGS. 16C, 16D, 17C, 17D, 18C and 18D.

FIGS. 14A and 14B show the element amplitudes and phases for a rescaled and clipped array with apodization applied to an array, a demonstration of global apodization with sufficient energy at the foci. FIGS. 15A and 15B show an example of targeted apodization.

An apodization or window function may be described using a spatial parameterization or an element-wise parameterization, where the respective methods allow the function to take parameters of either spatial location or lattice location respectively. These allow the prescribed function to be discretized such that an element amplitude may be associated with the transducer at each location.

An untargeted global apodization or window function is generally applied for a flat and planar two-dimensional array by taking the x and y spatial positions in a notional array coordinate system where the transducer array occupies the x-y plane close to the origin or without loss of generality lattice locations and labelling these with the transducer specific parameters tₓ and t_{y}. In some embodiments, three dimensional parameterisations may be required in the case of curved, concave or convex arrays.

The window function w(here parameterized in two-dimensions) in the untargeted case in this arrangement may then be evaluated for each transducer as:

A_{x,y}=w(tₓ,t_{y}),

where the function may be a two-dimensional separably, radially or otherwise non-separably extended Dolph-Chebyshev, Gauss, Taylor, Kaiser or other apodization or window function. A_{x,y} then determines the modulation used to prescribe the output amplitude to each individual transducer.

To achieve an axial apodization or window function, the dot product with a unit normal vector \hat{n} pointing in the direction of the desired quiet region may be computed and this then used to parameterize a one-dimensional apodization or window function w in this case as:

$${A}_{x , y} = w ( ( {t}_{x} - {o}_{x} ) {\hat{n}}_{x} + ( {t}_{y} - {o}_{y} ) {\hat{n}}_{y} ) ,$$

where oₓ and o_{y} denote the origin point through which the zero of the one-dimensional window must run. A sensible choice for the origin may be taken to be the center of the array. Without loss of generality, this may be extended to three dimensions in the case that the transducer array is non-planar. This may also be computed piecewise in the case that the array is not contiguous in space or in the lattice arrangement.

This generates an apodization in one direction from the array but not in the orthogonal direction, see FIGS. 16A-16D and 20A-20B. In FIGS. 20A-20B the effect on the acoustic field due to the apodization is shown, with a clear suppression of high energy in the y direction, although this extended method can suppress interference located in any direction an orthogonal apodization function is generated for the array surface. In this particular case, with the y-direction apodized and the x-direction not apodized as a result of the normal vector being set to \hat{n}=(0, 1).

The method applies to any location that one wishes to suppress, as shown in FIG. 16A-16D. The examples outline the applications to rectilinear array window functions, but the scheme readily extends to other array layouts such as hexagonal, sunflower, jittered, or radial. The theory also extends to other array shapes, such as rectangular, circular, or otherwise.

Additionally, the method may be extended to multiple interference regions of varying angles by performing an element-wise multiplication of two or more rotated element amplitudes, thus superposing the field effects, as:

$${A}_{x , y} = {w}_{1} ( {t}_{x} {\hat{n}}_{1 , x} + {t}_{y} {\hat{n}}_{1 , y} ) {w}_{2} ( {t}_{x} {\hat{n}}_{2 , x} + {t}_{y} {\hat{n}}_{2 , y} ) .$$

An example is shown in FIGS. 17A-17D, which shows the apodization pattern for two interference regions at 15 and 60 degrees, leading to a reduction in interference while maintaining sufficient energy at the foci.

Furthermore, additional properties such as curvature may be added by considering conformal mappings. For example, consider the following mapping to generate an element amplitude surface with curvature:

$$z = {t}_{x} + {t}_{y} i ,$$

then conformally map this to a new domain such as for example:

z′=exp(z).

where the x and y positions are the parameterized locations of the transducers as previously. The element amplitudes are assigned by first extracting the new remapped locations as:

t′ₓ= [symbol] (z′),

t′_{y}= [symbol] (z′),

before substituting these new t′ₓ and t′_{y} values into the previous parameterizations of window functions. An example is given in FIG. 6 showing the produced element amplitude profile and accompanying reduction of side lobes.

The background acoustic field is given in FIGS. 19A-19B, 20A-20B and 21A-21B, which show the pressure distribution on a cylinder surrounding the array. These figures show the field for an ultrasonic array with no apodization, directed apodization, and undirected apodization. In FIGS. 19A-19B, the background acoustic field exhibits high energy “rings” which causes microphone interference. The introduction of the apodization in both of FIGS. 20A-20B and 21A-21B suppresses these rings. In particular, the use of targeted apodization therefore enables target regions of interference to be suppressed.

The invention claimed may include:
A method comprising:
Apodizing ultrasonic arrays in specific directions to reduce side lobes.
The use of apodization functions Gauss, Chebyshev and Taylor.

### III. Dynamic Apodization to Minimize Effect of Malfunctioning Transducers in a Phased Array

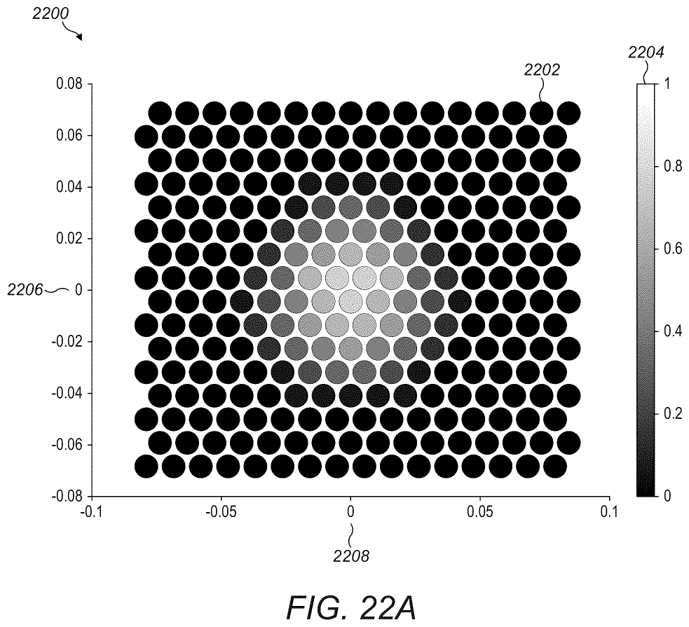

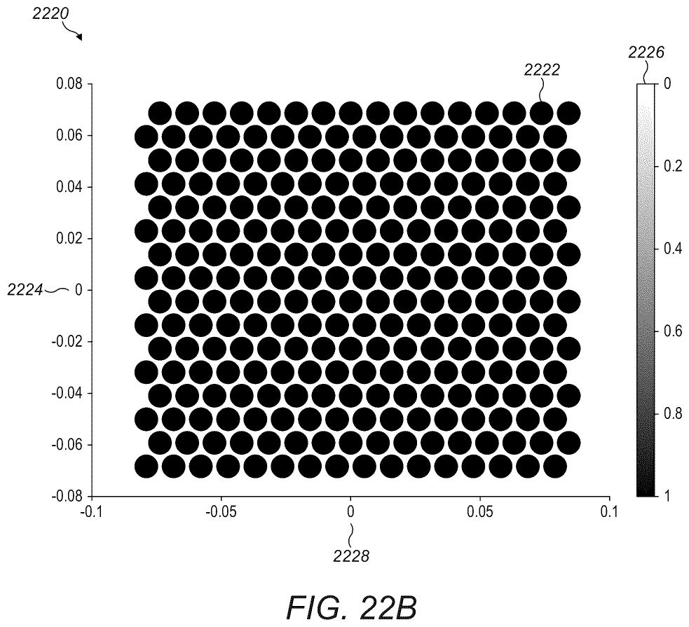

FIGS. 22A and 22B show a schematic of apodization and uniform amplitude drives.

FIG. 22A shows a plot 2200 of a schematic of a cosine amplitude apodization for transducers 2202 with a measurement 2204 in element amplitude, normalized between a zero-input signal and the maximum permissible input signal amplitude and thus output pressure represented by a 0 and 1 respectively. The x-axis 2208 is the x-coordinate of the local transducer array coordinate system measured in meters. The y-axis 2206 is the y-coordinate of the local transducer array coordinate system measured in meters. FIG. 22B shows a plot 2220 of a schematic of uniform amplitude drives for transducers with no apodization 2222 with a measurement in element amplitude 2226, normalized between a zero-input signal and the maximum permissible input signal amplitude and thus output pressure represented by a 1 and 0 respectively. The x-axis 2228 is the x-coordinate of the local transducer array coordinate system measured in meters. The y-axis 2224 is the y-coordinate of the local transducer array coordinate system measured in meters. Note that the element amplitude 2226 is reversed from others in this disclosure; in this FIG. 22B “0” is light and “1” is dark.

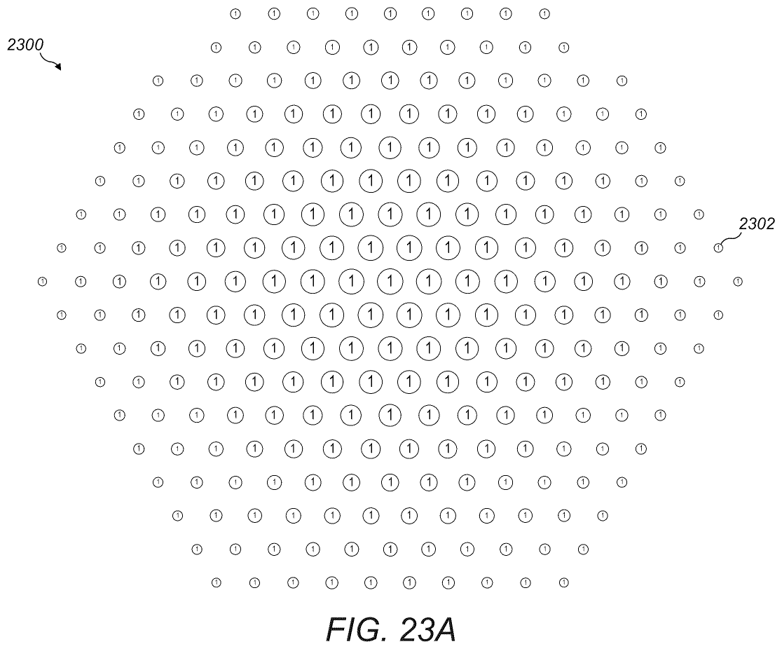

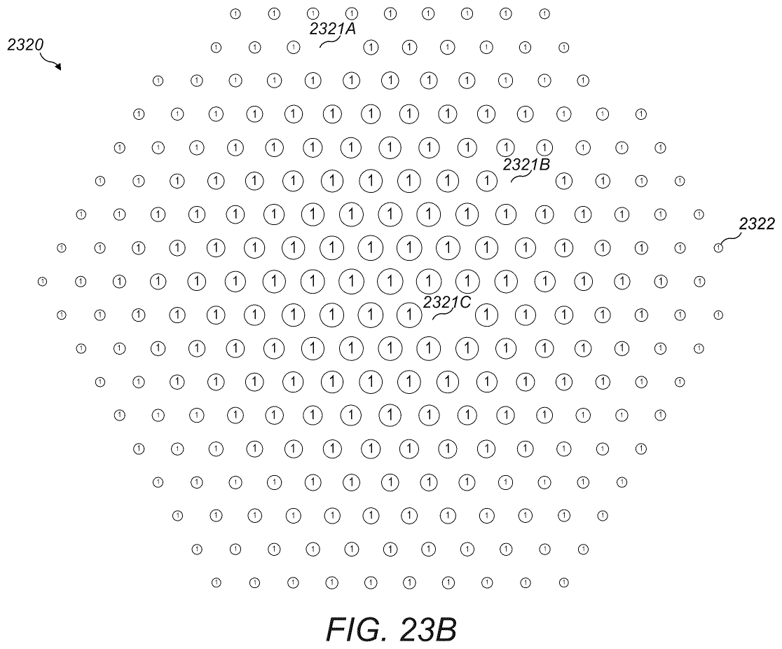

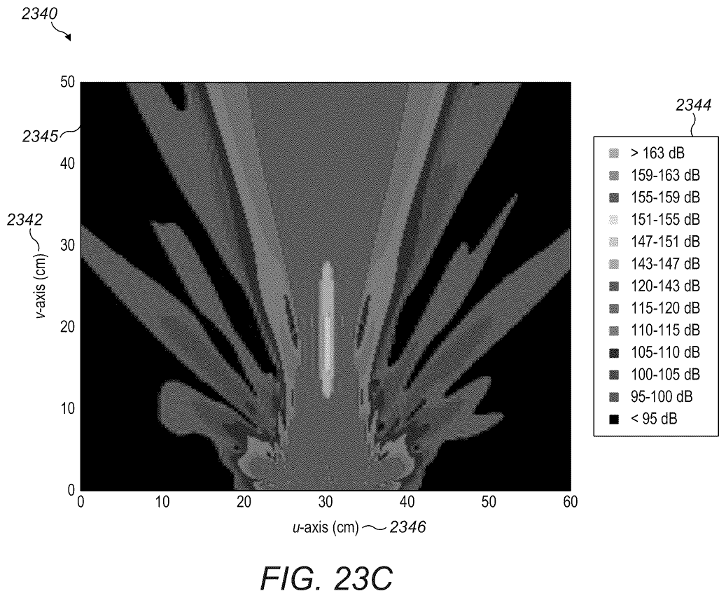

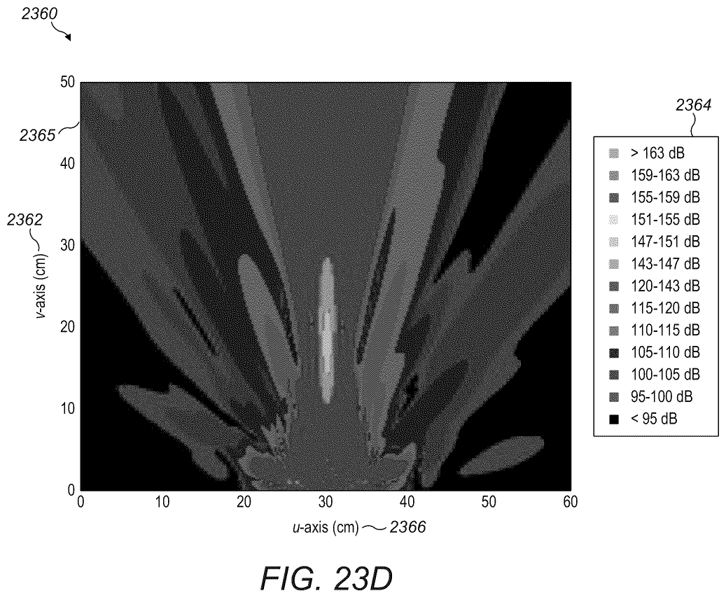

FIGS. 23A-23D show effects of element failure on an ambient field. FIG. 23A shows an illustrative plot 2300 of no failed elements 2302 where the size of the circle corresponds to the drive amplitude. FIG. 23B shows an illustrative plot 2320 of three failed elements 2321A 2321B 2321C within an array 2322 where the size of the circle corresponds to the drive amplitude. FIG. 23C shows a plot 2340 of an acoustic field 2345 measured in dB SPL 2344. The x-axis 2346 is the u-axis in cm. The y-axis 2342 is v-axis in cm. FIG. 23D shows a plot 2360 of an acoustic field 2365 with higher ambient field (reduced coverage of the darkest classification of decibel levels) and grating lobes measured in dB SPL 2364. The x-axis 2366 is the u-axis in cm. The y-axis 2362 is v-axis in cm.

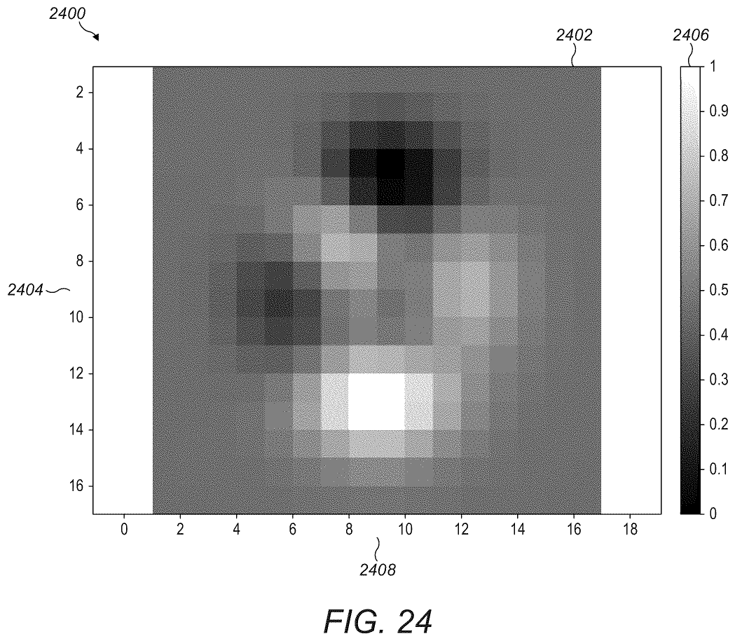

FIG. 24 shows a plot 2400 of a 2D apodization function 2402 compensating for 2 failed transducers (black areas at x=5, y=9 and x=10, y=4. This is a 16×16 array with the x-axis 2408 and the y-axis 2404 showing the ordinal coordinates of transducer placements in the rectilinear transducer layout. The key 2406 shows shading of the normalized input driving signal amplitude of each transducer element.

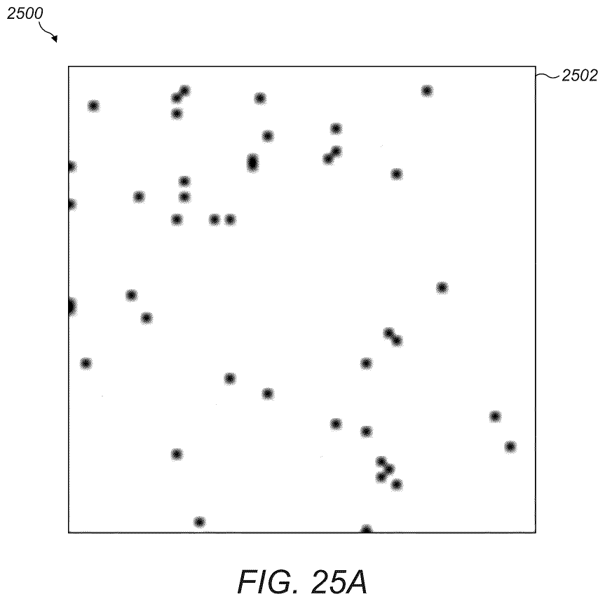

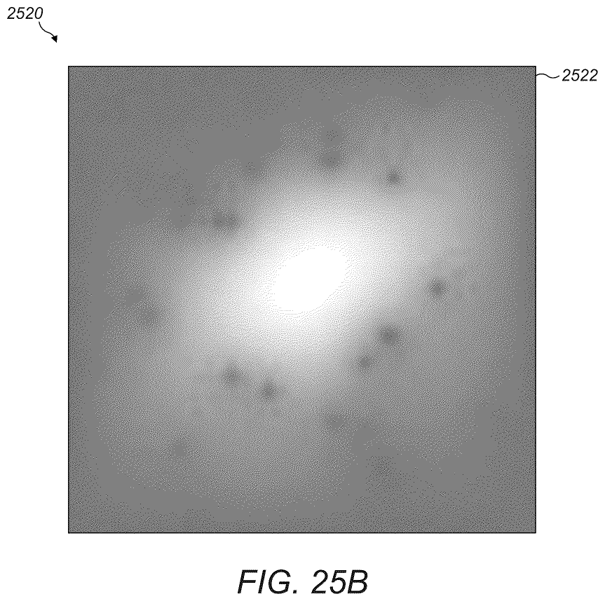

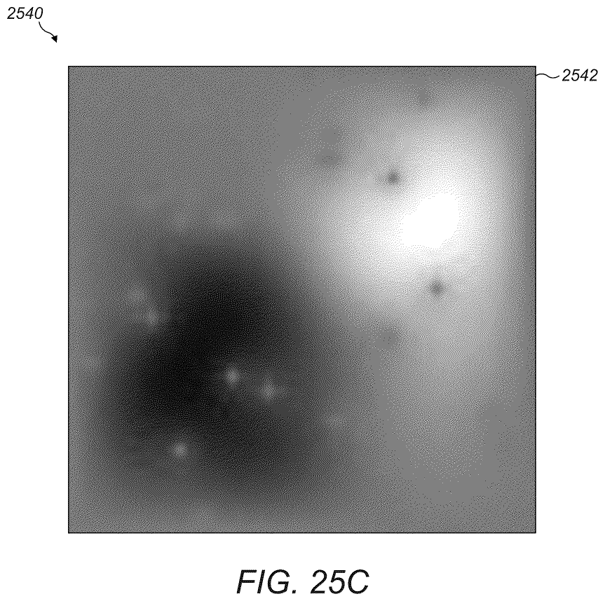

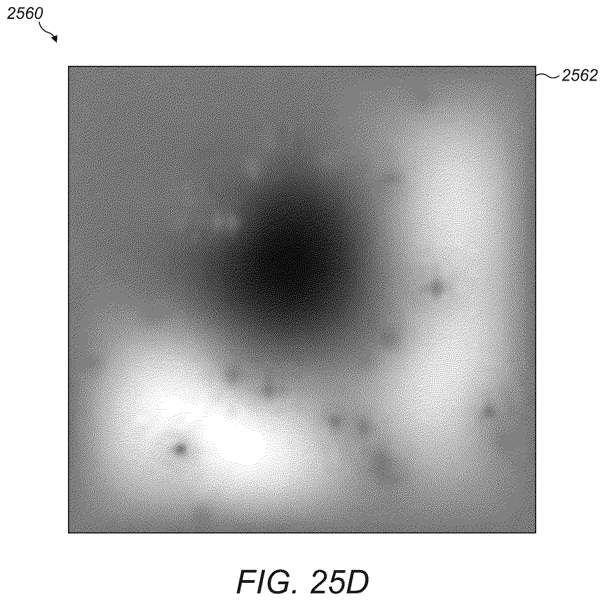

FIGS. 25A-25D show Helmholtz modes of the boundary value problem corresponding to a square lattice of 62×62 transducers with a 1% failure rate. FIG. 25A shows a plot of positions 2502 of failed and virtual edge transducer, where black is zero amplitude (failed transducers) and white is maximum (fully functional transducers). For FIGS. 25B, 25C, and 25D, black is negative, mid grey is zero and white is positive.

FIG. 25B shows a plot 2520 of a fundamental mode 2522, while taking into account the failed transducers as boundary conditions of the Helmholtz solution mode.

FIG. 25C shows a plot 2540 of a first harmonic mode 2542, while taking into account the failed transducers as boundary conditions of the Helmholtz solution mode.

FIG. 25D shows a plot 2560 of a second harmonic mode 2562, while taking into account the failed transducers as boundary conditions of the Helmholtz solution mode.

The harmonic modes and linear combinations thereof may have their absolute value taken and used as apodization or window functions also. Alternatively, these higher modes may be used for tracking, location and imaging physical objects in the field.

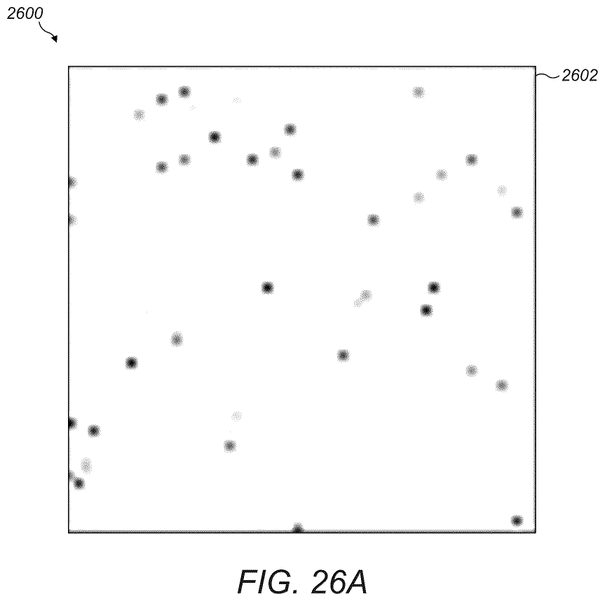

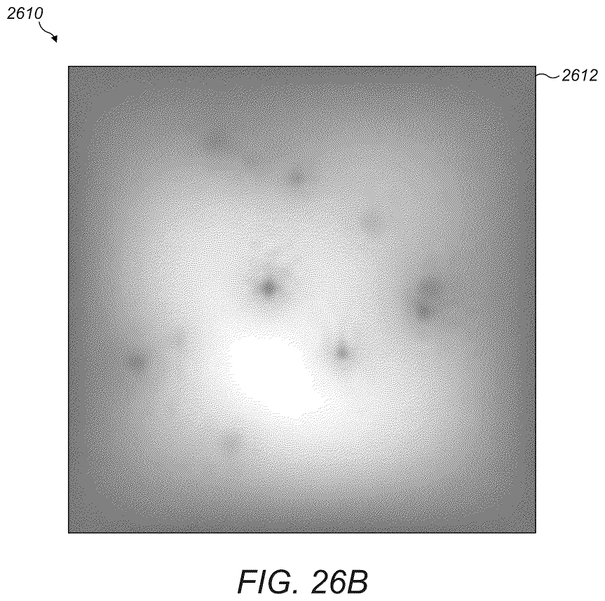

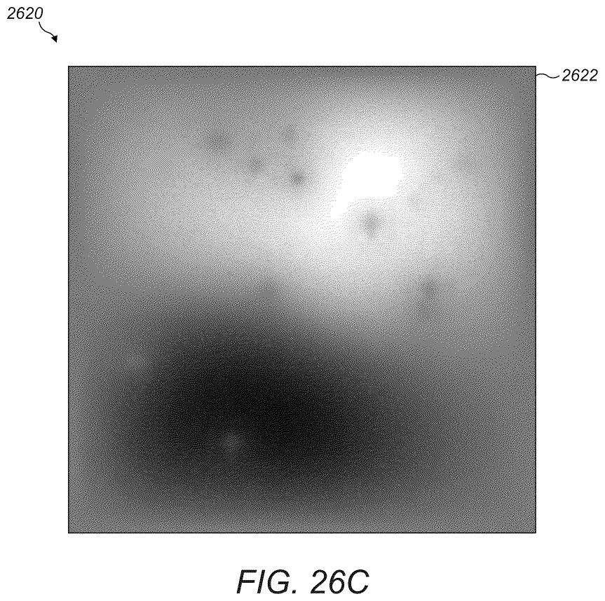

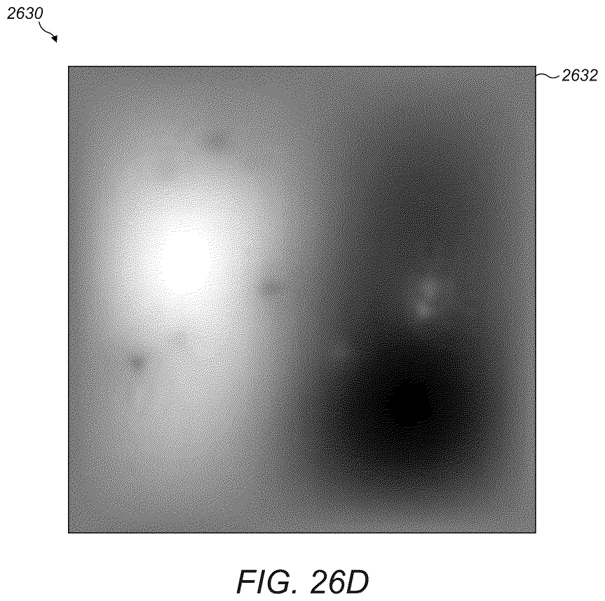

FIGS. 26A-26D show Helmholtz modes of the boundary value problem corresponding to a square lattice of 62×62 transducers where 1% of the transducers are reduced in their amplitude capability by a random amount. FIG. 26A shows a plot 2600 of showing positions of outlier and virtual edge transducers 2602, where black is zero amplitude (failed transducers) and white is maximum (fully functional transducers). For FIGS. 26B, 26C, and 26D, black is negative, mid grey is zero and white is positive.

FIG. 26B shows a plot 2610 of a fundamental mode 2612, while taking into account the failed transducers as conditional boundary conditions of the Helmholtz solution mode.

FIG. 26C shows a plot 2620 of a first harmonic mode 2622, while taking into account the failed transducers as conditional boundary conditions of the Helmholtz solution mode.

FIG. 26D shows a plot 2630 of a second harmonic mode 2632, while taking into account the failed transducers as conditional boundary conditions of the Helmholtz solution mode.

The harmonic modes and linear combinations thereof may have their absolute value taken and used as apodization or window functions also. Alternatively, these higher modes may be used for tracking, location and imaging physical objects in the field. Note that the modes are closer to the canonical square plate modes due to the lessened impact of faulty with reduced amplitude elements versus failed elements.

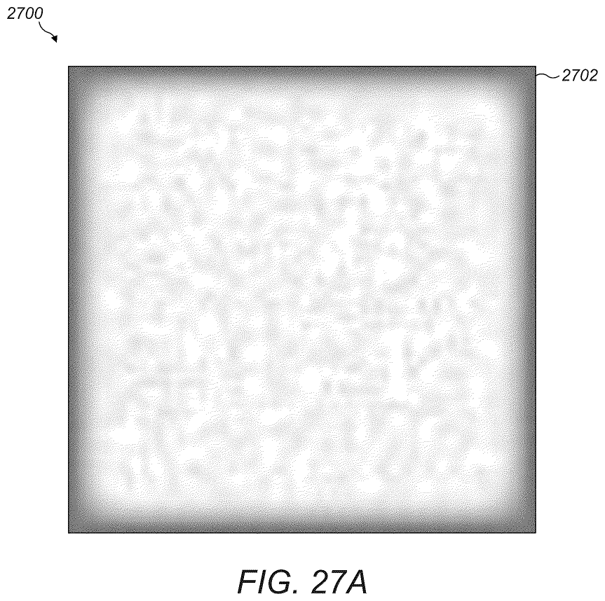

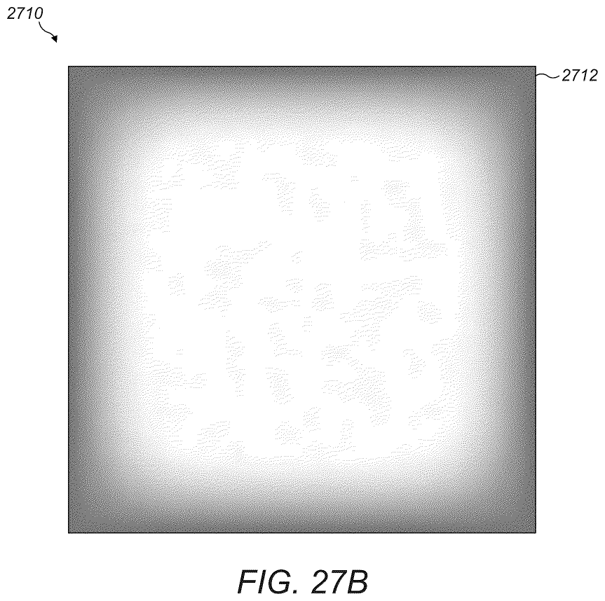

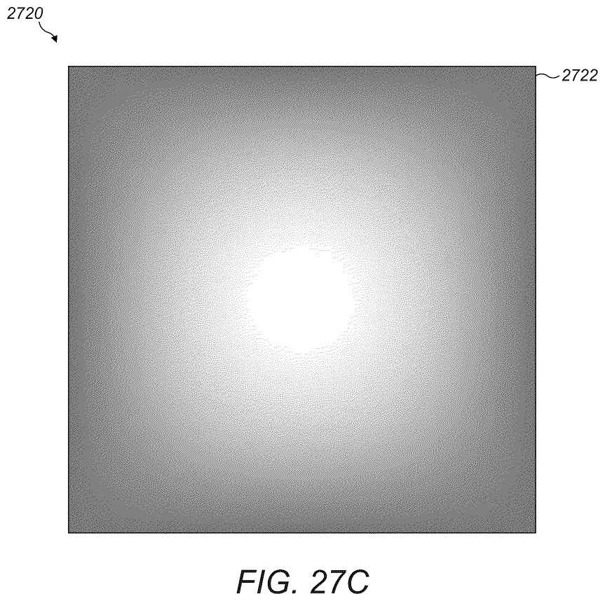

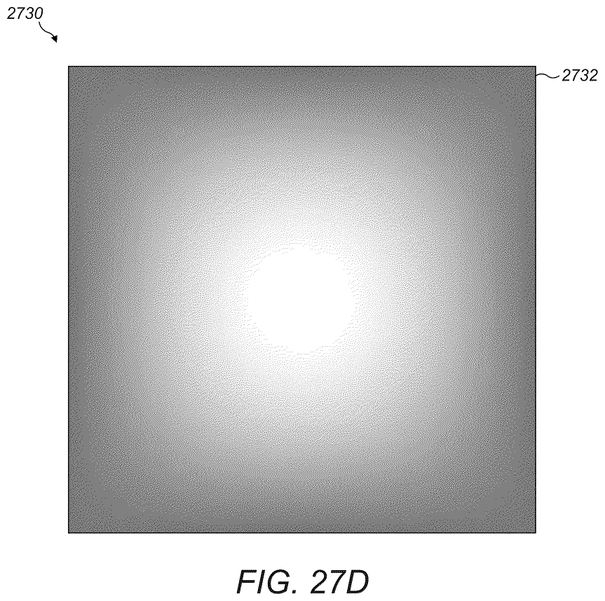

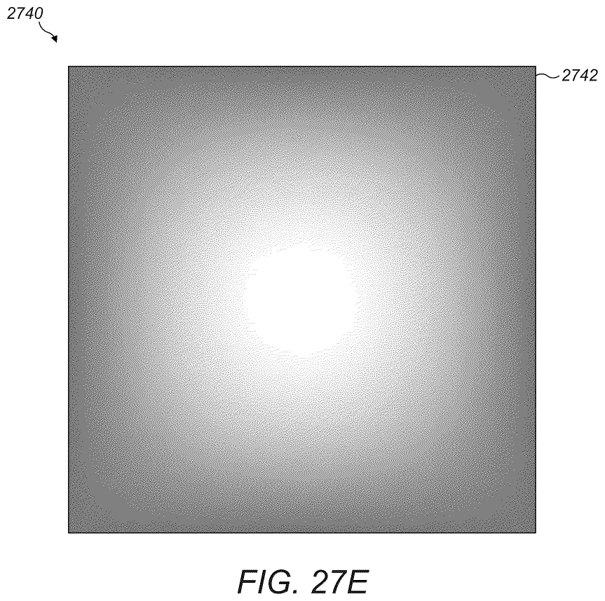

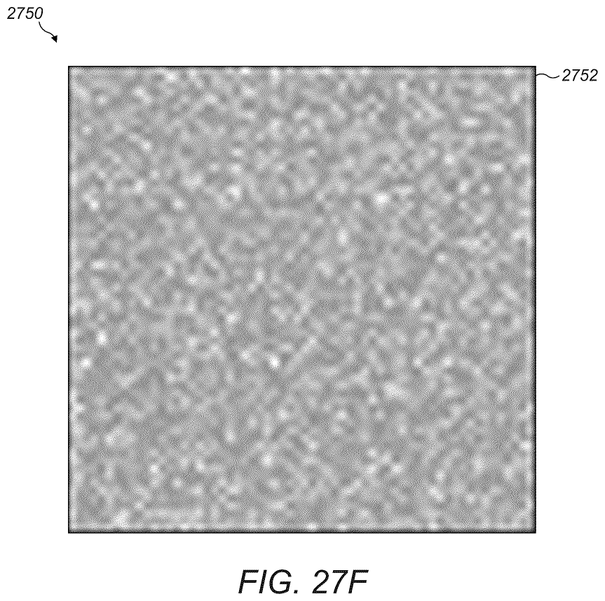

FIGS. 27A-27F show a scenario distributing the maximum amplitude capability over all transducers with different Gaussian distributions, meant to model manufacturing variability, where due to the formulation of the outlier transducer problem the aim is to always try to obtain a window which drives at least one element at maximum (1.0, as the amplitudes remain treated as normalized to an ‘average’) amplitude. The maximum amplitudes of the transducers may therefore be scaled to trade-off window effectiveness with output. In each case the standard deviation of the maximum amplitudes is σ=0.2

FIG. 27A shows a plot 2700 of amplitudes 2702 where the average maximum amplitude limit of each transducer is μ=0.8.

FIG. 27B shows a plot 2710 of amplitudes 2712 where the average maximum amplitude limit of each transducer is μ=0.9.

FIG. 27C shows a plot 2720 of amplitudes 2722 where the average maximum amplitude limit of each transducer is μ=1.0.

FIG. 27D shows a plot 2730 of amplitudes 2732 where the average maximum amplitude limit of each transducer is μ=1.1.

FIG. 27E shows a plot 2740 of amplitudes 2742 where the average maximum amplitude limit of each transducer is μ=1.2.

FIG. 27F shows a plot 2750 where the relative weights drawn from the Gaussian distribution are normalized to the maximum value (maximum value is white) and displayed 2752.

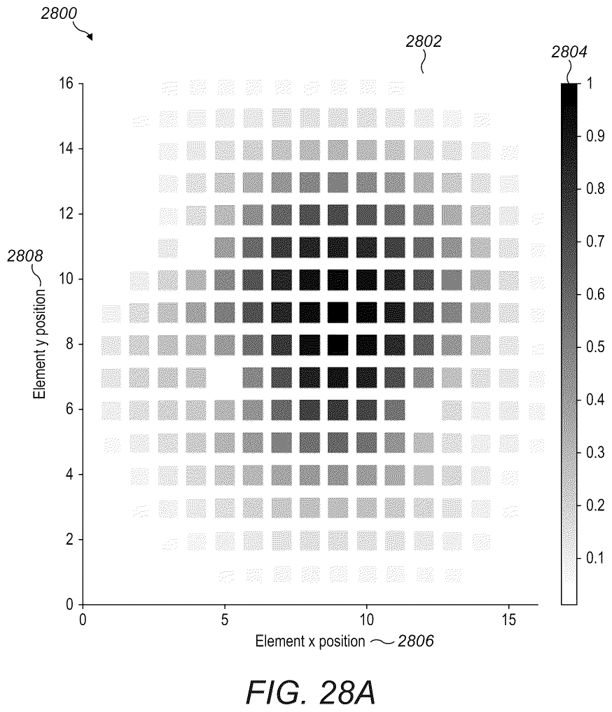

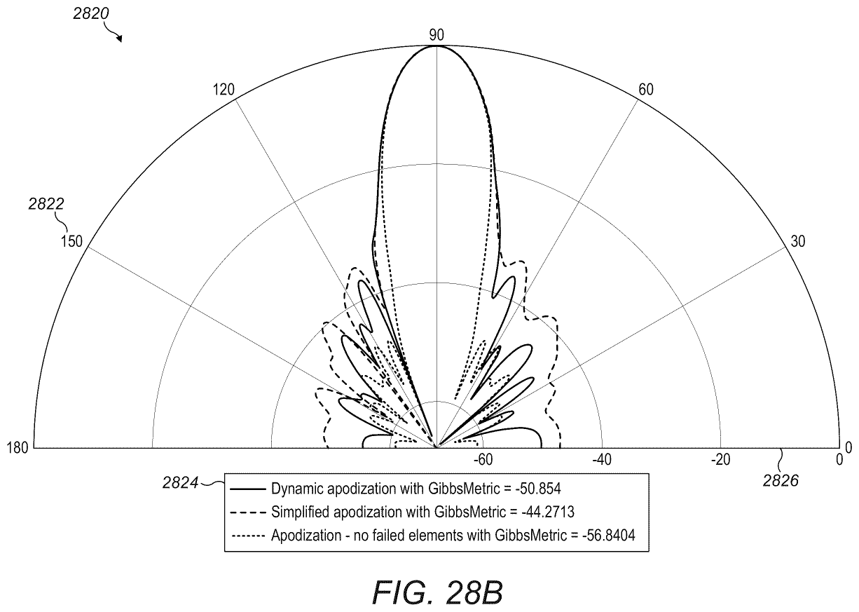

FIGS. 28A and 28B show the effect of dynamic windowing to correct element failure on an ambient field. FIG. 28A shows a plot 2800 of a 16×16 array 2802 of transducers where the normalized input driving signal amplitude of each transducer element is described by shading 2804. The x-axis 2806 shows the ordinal position of the element along the x-axis of a rectilinear layout transducer array. The y-axis 2808 shows the ordinal position of the element along the y-axis of a rectilinear layout transducer array. This shows an example of a 2D apodization function compensating for three failed transducers. FIG. 28B shows a polar plot 2820 of the acoustic field 2824 generated by the dynamic apodization, a simplified apodization and no failed elements. The r-axis 2826 is normalized dB, with the reference level set as the focus pressure and the angle θ 2822 is in degrees.

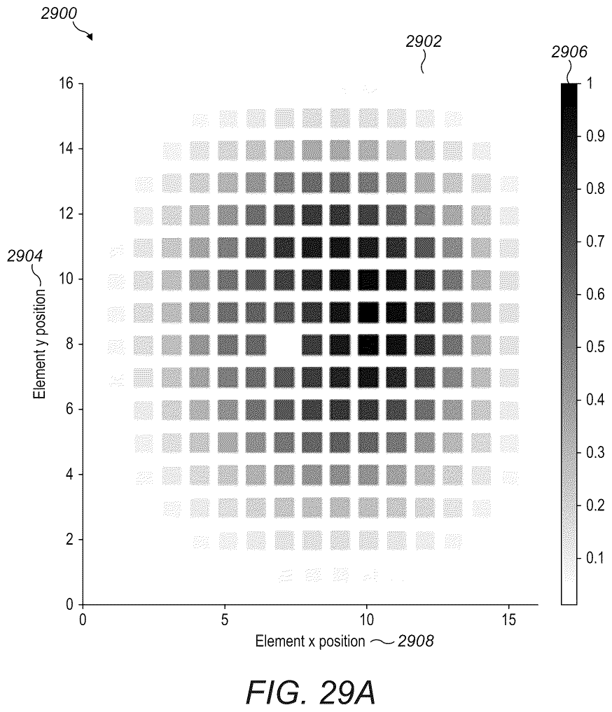

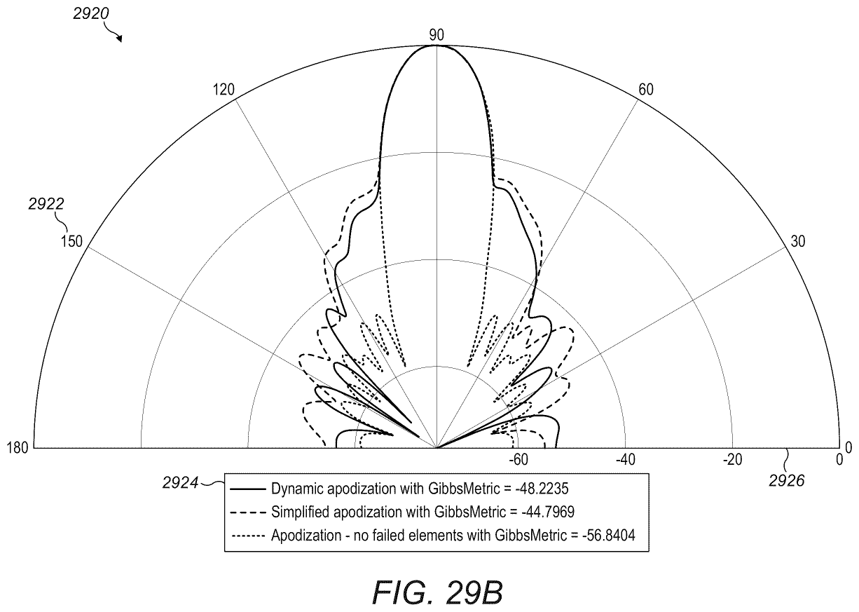

FIGS. 29A and 29B show the effect of dynamic windowing to correct element failure on an ambient field. FIG. 29A shows a plot 2900 of a 16×16 array 2902 of transducers where the normalized input driving signal amplitude of each transducer element is described by shading 2906. The x-axis 2908 shows the ordinal position of the element along the x-axis of a rectilinear layout transducer array. The y-axis 2904 shows the ordinal position of the element along the y-axis of a rectilinear layout transducer array. This shows an example of a 2D apodization function compensating for one failed transducer. FIG. 29B shows a polar plot 2920 of the acoustic field 2924 generated by the dynamic apodization, a simplified apodization and no failed elements. The r-axis 2926 is normalized dB, with the reference level set as the focus pressure and the angle θ 2922 is in degrees.

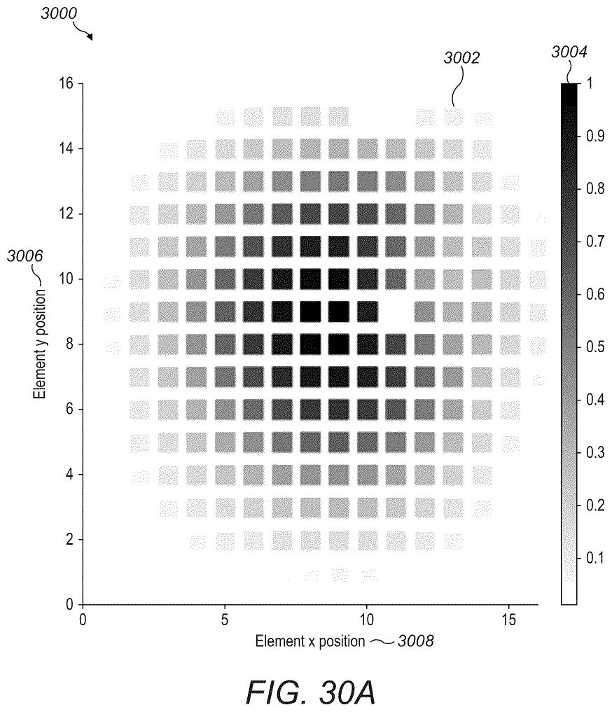

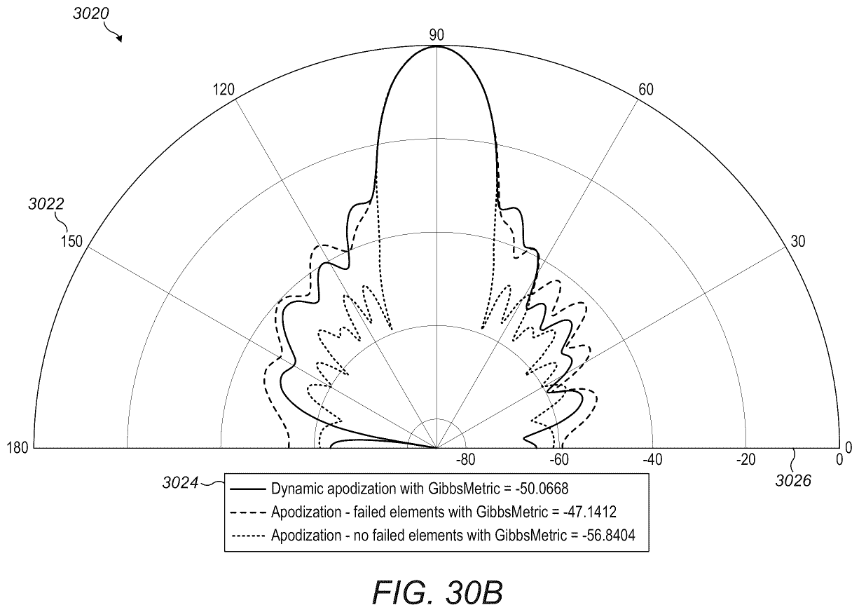

FIGS. 30A and 30B show the effect of dynamic windowing to correct element failure on an ambient field. FIG. 30A shows a plot 3000 of a 16×16 array 3002 of transducers where the normalized input driving signal amplitude of each transducer element is described by shading 3004. The x-axis 3008 shows the ordinal position of the element along the x-axis of a rectilinear layout transducer array. The y-axis 3006 shows the ordinal position of the element along the y-axis of a rectilinear layout transducer array. This shows an example of a 2D apodization function compensating for five failed transducers. FIG. 30B shows a polar plot 3020 of the acoustic field 3024 generated by the dynamic apodization, a simplified apodization and no failed elements. The r-axis 3026 is normalized dB, with the reference level set as the focus pressure and the angle θ 3022 is in degrees.

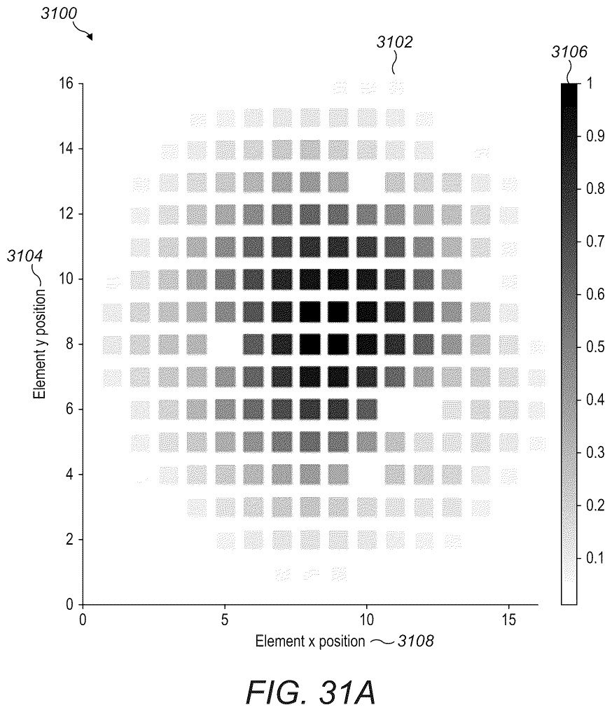

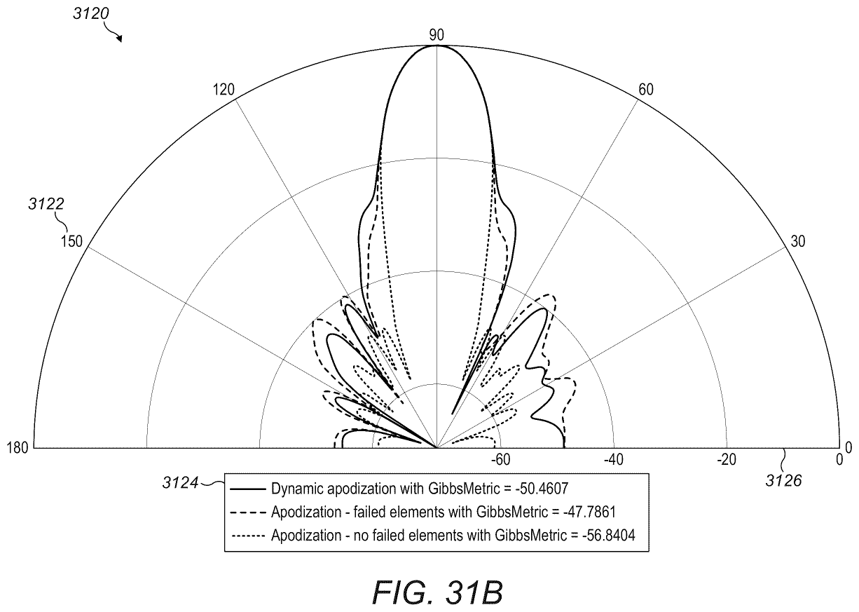

FIGS. 31A and 31B show the effect of dynamic windowing to correct element failure on an ambient field. FIG. 31A shows a plot 3100 of a 16×16 array 3102 of transducers where the normalized input driving signal amplitude of each transducer element is described by shading 3106. The x-axis 3108 shows the ordinal position of the element along the x-axis of a rectilinear layout transducer array. The y-axis 3104 shows the ordinal position of the element along the y-axis of a rectilinear layout transducer array. This shows an example of a 2D apodization function compensating for ten failed transducers. FIG. 31B shows a polar plot 3120 of the acoustic field 3124 generated by the dynamic apodization, a simplified apodization and no failed elements. The r-axis 3126 is normalized dB, with the reference level set as the focus pressure and the angle θ 3122 is in degrees.

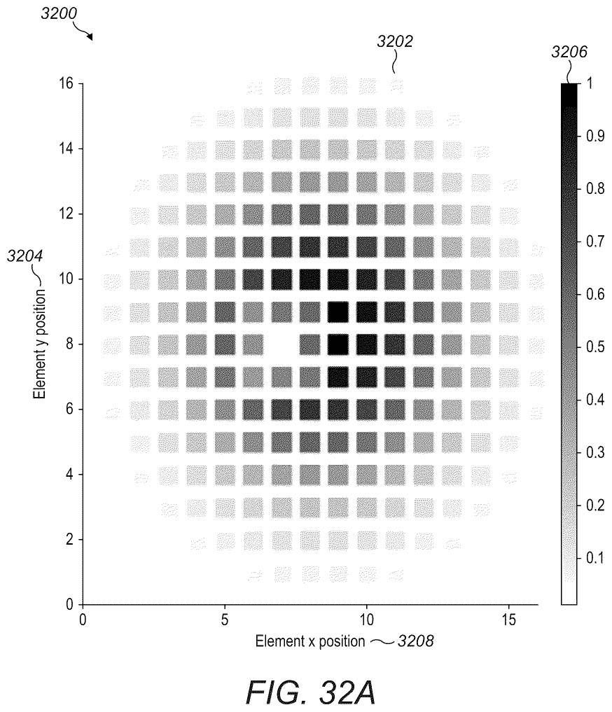

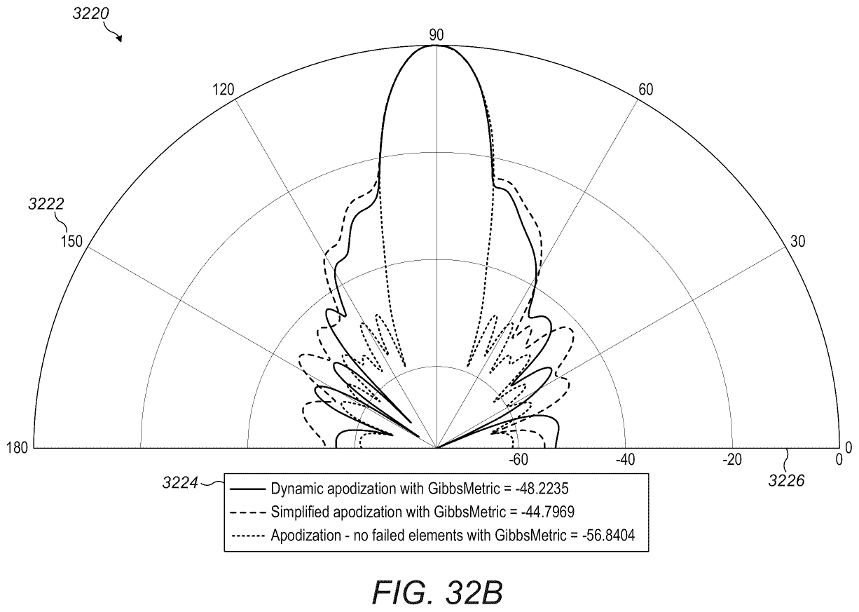

FIGS. 32A and 32B show the effect of simplified windowing to correct element failure on ambient field. FIG. 32A shows a plot 3200 of a 16×16 array 3202 of transducers where the normalized input driving signal amplitude of each transducer element is described by shading 3206. The x-axis 3208 shows the ordinal position of the element along the x-axis of a rectilinear layout transducer array. The y-axis 3204 shows the ordinal position of the element along the y-axis of a rectilinear layout transducer array. This is an example of a simplified apodization function compensating for a failed transducer. The elements surrounding the transducer have their amplitudes halved. FIG. 32B shows a polar plot 3220 of the acoustic field 3224 generated by the dynamic apodization, a simplified apodization and no failed elements. The r-axis 3226 is normalized dB, with the reference level set as the focus pressure and the angle θ 3222 is in degrees.

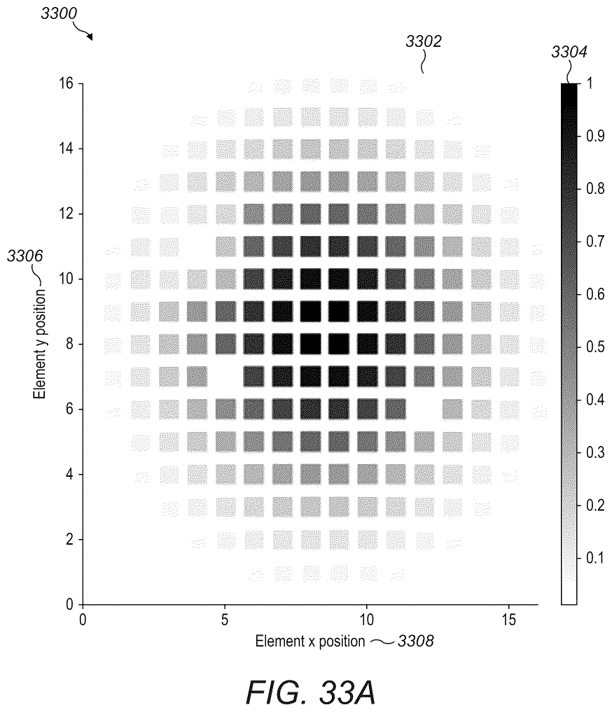

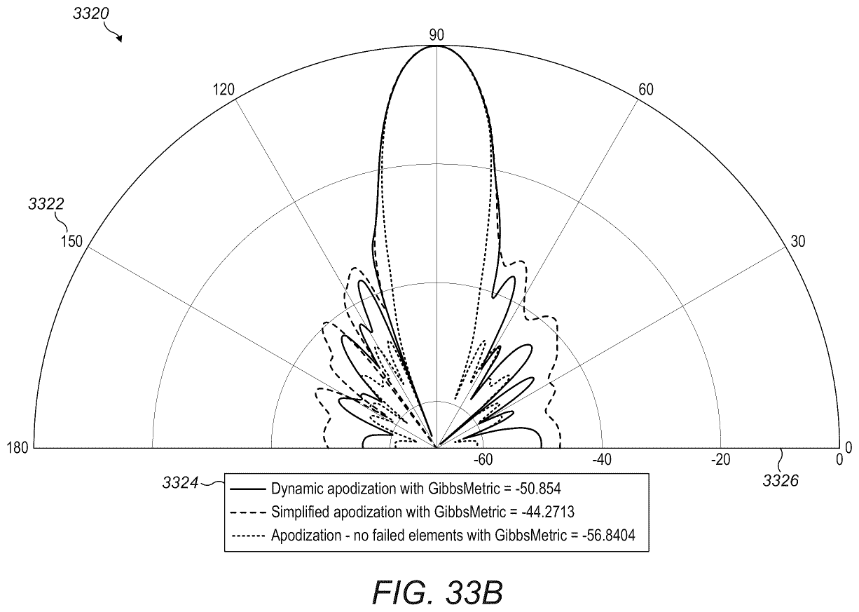

FIGS. 33A and 33B show the effect of simplified windowing to correct element failure on ambient field. FIG. 33A shows a plot 3300 of a 16×16 array 3302 of transducers where the normalized input driving signal amplitude of each transducer element is described by shading 3304. The x-axis 3308 shows the ordinal position of the element along the x-axis of a rectilinear layout transducer array. The y-axis 3306 shows the ordinal position of the element along the y-axis of a rectilinear layout transducer array. This is an example of a simplified apodization function compensating for several failed transducers. The elements surrounding the transducer have their amplitudes halved. FIG. 33B shows a polar plot 3320 of the acoustic field 3324 generated by the dynamic apodization, a simplified apodization and no failed elements. The r-axis 3326 is normalized dB, with the reference level set as the focus pressure and the angle θ 3322 is in degrees.

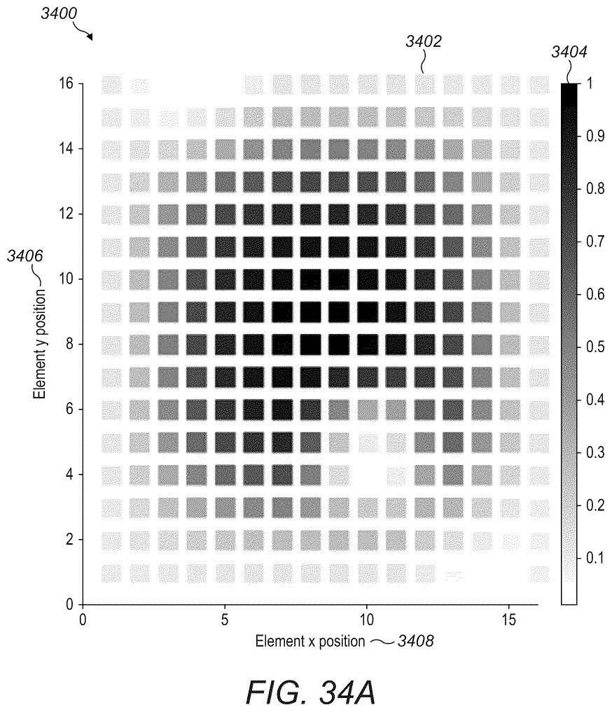

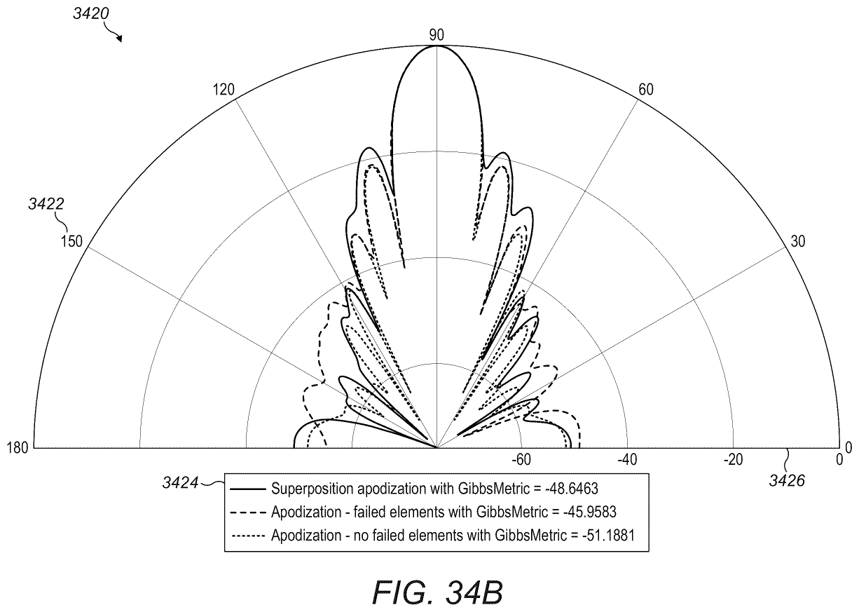

FIGS. 34A and 34B show the effect of simplified windowing to correct element failure on ambient field. FIG. 34A shows a plot 3400 of a 16×16 array 3402 of transducers where the normalized input driving signal amplitude of each transducer element is described by shading 3404. The x-axis 3408 shows the ordinal position of the element along the x-axis of a rectilinear layout transducer array. The y-axis 3406 shows the ordinal position of the element along the y-axis of a rectilinear layout transducer array. This is an example of a simplified apodization function compensating for several failed transducers. A local window subtracts from the original apodization, such that the supposition of them leaves the failed elements' amplitudes at 0. FIG. 34B shows a polar plot 3420 of the acoustic field 3424 generated by the dynamic apodization, a simplified apodization and no failed elements. The r-axis 3426 is normalized dB, with the reference level set as the focus pressure and the angle θ 3422 is in degrees.

Apodization is a method used to reduce side lobes/foci when beam steering/focusing a phased array. In order to reduce these unwanted effects, the amplitudes of elements are modulated such that element amplitudes near the array edges approach zero. The modulation technique used is determined by the window function used, with common FFT windowing functions being often used (e.g. Hanning, etc.). This is because side lobe effects generated in the acoustic field may be viewed as Gibbs ringing in a frequency or Fourier space.

A non-apodized and an apodized array are shown in FIGS. 22A-22B.

The benefits of apodization can be readily lost in the presence of a non-functioning transducer. This can be thought of as the loss of smooth amplitude change across the array with a rapid amplitude reduction in comparison to neighboring elements at the failed element.

An example of the effect of element failure on the ambient acoustic field is shown in FIGS. 23A-23D.

A method to counter these effects is to dynamically apply a 2D windowing function to the elements where the failed elements are given a driving amplitude of zero. Thus, their failure is compensated for from an apodization point of view. Similarly, if the element has not failed but has experienced a reduction in ultrasonic output capability, then the window function may be modified by scaling to compensate for such an outlier transducer element. This is achieved by scaling the existing windowing function until the functional capability of the outlier transducer may be accommodated within the envelope of the window.

This could be achieved in some embodiments by dynamically measuring the current draw or other indicators of the health, and thus function, of an element. Where a failed element is identified its coordinates may be determined and a new apodization regime employed. Through a variety of techniques, a 2D window function may be generated which places zero driving amplitude onto the failed elements. Thus, a smooth window function still drives the array and has no spatial artifacts which would result in higher grating lobes/foci. An example of a technique to generate a smooth apodization is outlined below. A potential weighting function is shown in FIG. 24.

A useful apodization of the phased array output that yields substantial reductions in side lobes and thus suppresses noise by applying a spatial function whose Fourier dual is band limited in spatial frequency as a modulation by design. Such a function must be chosen to be band limited in space, so as to be representable with minimal error when applied to a physically finite array of ultrasonic transducers. As a result, to maintain this dual band limited structure in the presence of failed transducer elements, while the majority of the window function continues to provide sufficient element power to achieve the focusing or beam-steering goals of the ultrasonic system.

A simplified apodization approach to mitigate the impact of a single underperforming transducer is to scale the neighboring transducers appropriately. Considering the case where the underperforming transducer has failed entirely (amplitude of zero) then the surrounding transducers have their amplitudes halved. FIGS. 32A-32B and 33A-33B show this simplified apodization approach and comparisons to the dynamic apodization discussed later. The simplified approach mitigates the discontinuity introduced by the underperforming transducer and so the side lobe level is reduced, however it underperforms the more sophisticated dynamic apodization method applied later. Note to compare the impact of effectiveness of each approach the “Gibbs Metric” has been included, which is the average side lobe level for the data shown. The Gibbs Metric is defined earlier in this disclosure.

One way to derive an apodization in the presence of failed elements can be thought of as a general window function with an effective convolution over the locations of the failed elements, so:

A_{t,initial}=w(xₜ),

where w is the unmodified window function used for a transducer array with uniform properties, Aₜ the window amplitude of the transducer under consideration, xₜ denotes the parameterisation vector corresponding to the location of the considered transducer in either space or lattice position (where applicable), w_{t̅}_{_{i,failed}} is the anti-window function centered around the transducer that deviates from uniformity (fails a uniformity check) which subtracts the transducer amplitude difference alongside a halo around it to preserve the dual band limited property required for the apodization to be functionally useful, s is the number of deviating transducers and t_{i,failed} an index of the deviating transducers.

While the window function w must be inscribed or lie within the set of uniformly functional transducers, the summed anti-window functions w⁻ must circumscribe or lie outside of the set of functionally deviating transducers to maintain the dual band limited property required of an apodization that functionally reduces side lobe effects.

Another approach to generate an apodization to compensate for failed elements is to apply a convolution or a moving average to an existing window function with defects to smooth the discontinuities for the element amplitudes. In general, an apodization is applied to the entire array, this may be formed by considering again the vector of initial transducer amplitude scalings A_{t,initial}, where this takes a window vector as:

A_{t,initial}=w(xₜ),

Once the failed elements are located, their value is set to zero in the vector A_{t,initial}. As discussed previously and shown in FIGS. 23A-23D, the failed elements cannot produce the amplitude required of them to instantiate the desired window function across the constellation of transducers, leading to a higher ambient field.

To compensate for the discontinuity which the failed elements have introduced, a local modification to the apodization is imposed around the failed elements. To illustrate one such implementation of this method, a discrete convolution is iteratively applied to the elements, with the maximum amplitude of the failed element enforced, as well as ‘virtual’ elements set to zero, where these consist of an extrapolated continuation of the lattice or other arrangement so as to ensure the window decays to zero at any edges encountered to ensure correct boundary conditions are observed. A matrix s may then be viewed as a discrete convolution where the set of uniform transducers with correct amplitude is denoted T, the set of lattice edge transducers which are assigned zero and denoted § and the set of outlier transducers K, where the union of the sets is operated on and convolved with the elements amplitudes as:

$$\begin{matrix}∀ {A}_{t , τ} ∈ {A}_{τ} , & {A}_{t , τ} = 1 , \\ ∀ {A}_{t , ξ} ∈ {A}_{ξ} , & {A}_{t , ξ} = 0 , \\ ∀ {A}_{t , κ} ∈ {A}_{κ} , & 0 \leq {A}_{t , κ} < 1\end{matrix} ,$$

where each of the classes of stand in discrete points for the transducer is allocated as shown, then the discrete convolution may be applied as:

$${A}_{Ω , 0} := {A}_{τ} ⋃ {A}_{ξ} ⋃ {A}_{κ} , \\ {A}_{Ω , i + 1 , initial} ( j , k ) := {\sum }_{p = - N}^{N} {\sum }_{q = - N}^{N} {A}_{Ω , i} ( j - p , k - q ) s ( p , q ) , \\ {A}_{Ω , i + 1} := {A}_{τ , i + 1 , initial} ⋃ {A}_{ξ} ⋃ {A}_{κ} ,$$

where for simplicity of exposition and without loss of generality the matrix s is of size 2N+1 and centered around zero, j and k denote coordinates of the transducer in the arrangement, t denotes actively controllable transducers, Ω all transducers including boundary padding elements and outlier transducers and i is a fictitious discrete time or iteration number. To make the matrix and the number of required boundary zero-padding elements small, it may be helpful to use many iterations. Alternatively, only one iteration may be necessary in cases where the matrix size and number of elements required for use as padding to enforce a zero-boundary condition is of less importance. This may also be applied in cases wherein the matrix s is itself a discretization of a continuous function, and so the matrix may be considered to be applicable in the limit of matrix size even in disjointed and unstructured transducer arrangements. The amplitudes assigned to the elements are then normalized, where an example of the result of such a procedure is shown in FIG. 26A.

A further approach to generating apodizations for removing failed elements is to use such elements as boundary conditions in a discretized Helmholtz equation. The fundamental mode shape that is determined as the dominant mode of the discretized Helmholtz equation may also be considered to be a fitting of the largest possible sinusoids within the region. Fitting such sinusoidal functions with zero boundary conditions that is the vibrational mode of the imaginary surface that is constructed from the transducers should therefore significantly reduce side lobe energy in the field while being constrained by the boundary conditions imposed by the edges and outlier elements. As such, the array edges and outlier elements may be interpreted as Dirichlet boundary conditions, as shown in FIG. 25A.

The solution must be normalized (the function scaled such that each input value fits within the largest possible amplitude for each element) at each stage to ensure that physical amplitude limitations are respected.

The Helmholtz equation is:

$${∇}^{2} f = - {k}^{2} f ,$$

where f is generally known as the eigenfunction or wavefunction and k the wavenumber. Discretising and rearranging this into a matrix can be achieved simply without building the matrix itself, known as a matrix-free approach, by at each stage inferring a finite difference stencil and using this construct the large matrix-vector product only. This small matrix representing the finite difference stencil required for example on a two-dimensional square lattice takes the simple form of a negated discrete Laplacian:

$$s = [ \begin{matrix}0 & - 1 & 0 \\ - 1 & 4 & - 1 \\ 0 & - 1 & 0\end{matrix} ] ,$$

then forming the large matrix-vector product in a way that is matrix-free may be used to rearrange the differential equation into an eigenproblem as, for example in the case of a 3×3 square lattice, the implied matrix M takes the form:

$$M = [ \begin{matrix}4 & - 1 & 0 & - 1 & 0 & 0 & 0 & 0 & 0 \\ - 1 & 4 & - 1 & 0 & - 1 & 0 & 0 & 0 & 0 \\ 0 & - 1 & 4 & 0 & 0 & - 1 & 0 & 0 & 0 \\ - 1 & 0 & 0 & 4 & - 1 & 0 & - 1 & 0 & 0 \\ 0 & - 1 & 0 & - 1 & 4 & - 1 & 0 & - 1 & 0 \\ 0 & 0 & - 1 & 0 & - 1 & 4 & 0 & 0 & - 1 \\ 0 & 0 & 0 & - 1 & 0 & 0 & 4 & - 1 & 0 \\ 0 & 0 & 0 & 0 & - 1 & 0 & - 1 & 4 & - 1 \\ 0 & 0 & 0 & 0 & 0 & - 1 & 0 & - 1 & 4\end{matrix} ] ,$$

where discrete elements are only present as the components of f for the groups A_{τ}∪A_{κ} and the elements in A_{ξ} (the edge elements) are implied.

However, as the k² in the differential equation relates and is proportional to both the wavenumber and the eigenvalue, the dominant eigenvector (highest frequency vibration mode) is not the same as the dominant mode (lowest frequency vibration mode), so an eigenvalue shift must be applied before extracting the lowest and then dominant mode, forming as is usual in this scenario:

$$( M - σ I ) f = ( λ - σ ) f ,$$

where σ is the eigenvalue of the dominant eigenvector (not the dominant, lowest frequency fundamental mode), shifting the eigenvalue for the desired dominant mode which was closest to zero to be the furthest from zero, due to the shift by σ. This then allows the eigenfunction f to be extracted via an eigenvector determination procedure, as the dominant, fundamental mode of M is the dominant eigenvector of this new (M−σI).

One such procedure to obtain the dominant eigenvector is the power iteration that finds the dominant eigenvalue and eigenvector in each case where the eigenvalue takes its maximum absolute value. The power iteration must be normalized (the function scaled such that each input value fits within the largest possible amplitude for each element) at each stage to ensure that physical amplitude limitations are respected. To generate the solution for the fundamental mode of the Helmholtz system, when using a power iteration a two stage dominant eigenvector approach is necessary, the first stage wherein the dominant eigenvalue of the system Mf=λf, the largest eigenvalue σ is determined, followed by a power iteration of (M−σI)f=(λ−σ)f, to determine the eigenvector corresponding to the fundamental mode of the vibration.

Due to the unconditional convergence (given appropriate initial conditions with a component in the dominant direction which may be achieved by random initialization) of the power iteration method boundary conditions may be applied prior or subsequent to each iteration as:

$${A}_{Ω} = {A}_{τ} ⋃ {A}_{ξ} ⋃ {A}_{κ} , \\ {f}_{t , constrained} = \{ \begin{matrix}{f}_{t} , & {f}_{t} \leq {A}_{t} \cdot {max}_{∀ i ∈ Ω} {f}_{i} , \\ \frac{{A}_{t} \cdot {max}_{∀ i ∈ Ω} {f}_{i} \cdot {f}_{t}}{‖ {f}_{t} ‖} , & {f}_{t} > {A}_{t} \cdot {max}_{∀ i ∈ Ω} {f}_{i}\end{matrix} ,$$

where each component of the discretized function vector fₜ is constrained in this manner to preserve sign and ensure that any outlier transducers or array edges are respected during the iteration. Rescaling the system so as to reposition the maximum solution amplitude for any element

$$( {max}_{∀ i ∈ Ω} {f}_{i} )$$

to a lower value, solving and then scaling back allows the maximum solution amplitude to be chosen, in the situation that the trade-off between apodization function effectiveness/smoothness and overall output efficiency may be chosen, since for best effect the majority of elements must be capable of enough amplitude to generate a full scale window. The effect and trade-off of modifying this scaling factor is shown in FIGS. 27A-27F.

Finally, as discussed, this fundamental mode of vibration, given using the maximum amplitude available from the outlier transducers and zero amplitude array edges as a boundary value problem, may then be used as a window function that enables reduced side lobe output and as a result reduces the ultrasonic interference. Illustrative examples of a window function produced in such a way are shown in FIGS. 25A-25D.

Once the fundamental mode of vibration is computed, which in the case of the power iteration is where a difference defined between the current iteration and one or more previous iterations falls below a threshold and is said to have converged, this fₜ may be assigned as the amplitudes for a set of transducers or to a transducer basis set or focusing function. This is achieved as:

$${α}_{t , new} = \frac{{f}_{t}}{‖ {α}_{t} ‖} ,$$

where αₜ is the previous complex value associated with this transducer and α_{t,new} is the new replacement value. This is then either directly in the case of computed drives or indirectly in the case of basis sets or focusing functions used to drive the transducers.

Other methods for computing eigenvectors may also be used, including Krylov subspace methods for generating an incomplete eigen-decomposition of the modified matrix (M−σI) such as the Arnoldi or Lanczos methods, especially in the case that higher order modes are desired, although these have other applications outside apodization as described previously.

This differential equation method should not be considered to be only usable with the Helmholtz equation. The bi-harmonic operator in the bi-Helmholtz equation may also be applicable to generating apodization functions as it has the form γ⁴∇⁴f−η²∇²f+f=0. Other differential equations that include higher order or fractional order derivatives may also be applicable to generating effective apodization functions in the context of a boundary value problem.

The outlier elements in all cases must only be enforced as a boundary condition if at any point in the convergence of either of the preceding methods the amplitude limitations (relative to all other elements in the intermediately available solution) of such an element is not respected, so as to allow the final window to best fit the scenario presented by the limitations in the transducer elements. Further, the edge transducers may be present in any configuration, such as may be useful for generating apodization functions for any array geometry or layout.

Further, the discrete convolution, moving average and discretized differential equation method for generating apodizations do not require a square lattice to function. They may be used on any lattice or point set whereupon a convolution, average or differential operator may be defined. This may be hexagonal lattice or an unstructured point set, so long as these aforementioned operators may be defined.

The outcome of the dynamic apodization is generally that the discontinuity of the failed element introduced is smoothly removed. A smooth array profile leads to a reduction in side lobe level compared to no smoothing, as shown for a smaller array in FIG. 28B. To further illustrate the benefit of dynamic apodization for reducing side lobe levels, examples are included for the same array N failed elements in the case N=1, 5, 10. These are shown in FIGS. 29A-29B, 30A-30B and 31A-31B, respectively.

Another possibility is to use a linear combination of windows to create a window for the array and effectivity negated windows to attenuate input amplitudes around individual transducers that may have failed or have reduced output that together generate an apodization that reduces background levels. This is especially useful for simple systems where few transducer deviances or failures are expected. The simplified apodization method illustrated in FIGS. 32A-32B and 33A-33B may also be viewed as the supposition of several windowed arrays, which is permitted due to the linearity in the system. Expanding on this, the apodization scheme takes a local window and convolves it with a linear summation of delta functions centered in the positions of the underperforming transducer. The original window function then has the convolved window subtracted from it, leaving a smoothly varying apodization scheme with specified continuity everywhere. The supposition of windows may be done as follows. Define the original apodization scheme, without underperforming transducers as a 2D matrix, W, where the amplitude of the nth transducer is given by W(xₙ, yₙ). The local window to be applied in the region of an underperforming transducer is given by w₀. The location of each underperforming transducer is known at xᵢ=(xᵢ, yᵢ), with a delta function returning its position in the 2D matrix, so for a set of failed transducers the window function may be obtained as:

$$W ( {x}_{n} , {y}_{n} ) = w - {\sum }_{i = 0}^{N} {w}_{0} ⊗ δ ( {x}_{i} ) ,$$

where N is the number of failed transducers.

This method is applicable to any phased array-based system which uses apodization. This approach therefore has wide applicability to radar, sonar, medical imaging and NDT systems.

The negative impact of this system approach is that it can reduce the overall acoustic field amplitude generatable by the array. This may be an issue for mid-air haptics if there is not enough output headroom, but most other array systems do not drive the array at its highest operating amplitude instead often operating at the lowest possible for imaging where signal to noise is more important than amplitude. In such applications therefore this approach may realize greater utility.

Novelty and inventive steps include:
Constructing an apodization function using a boundary value problem on a discretized differential equation.
Constructing an apodization function using a discrete convolution with boundary effects and enforced amplitude on selected points.
Constructing an apodization function using a moving average with boundary effects and enforced amplitude on selected points.

### IV. Passive Acoustic Structures for the More Efficient Distribution of Acoustic Pressure From Acoustic Phased Arrays

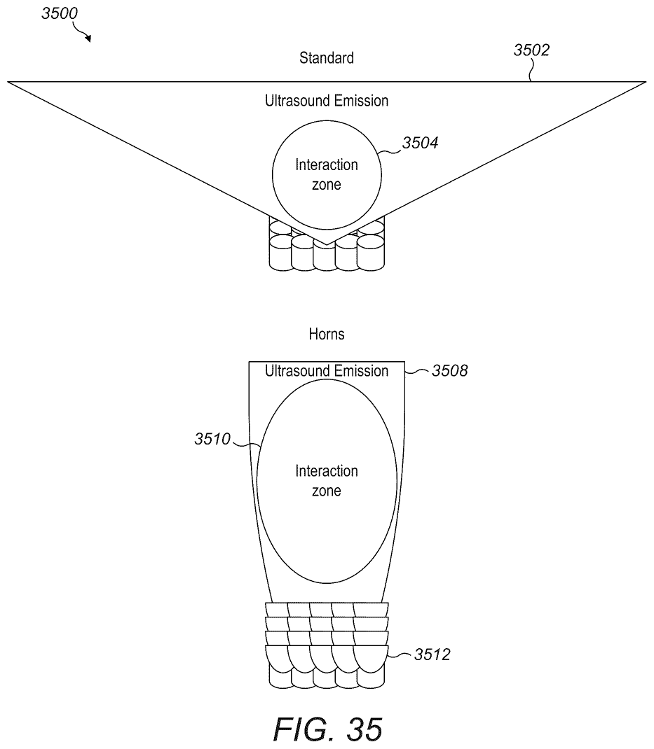

FIG. 35 shows a plot 3500 for a concept for redistribution of acoustic pressure to increase the haptic interaction zone from transducers. Shown is a standard ultrasound emission 3502 from an interaction zone 3504 from transducers 3503. Also shown is a horn ultrasound emission 3508 from an interaction zone 3510 from horns 3512.

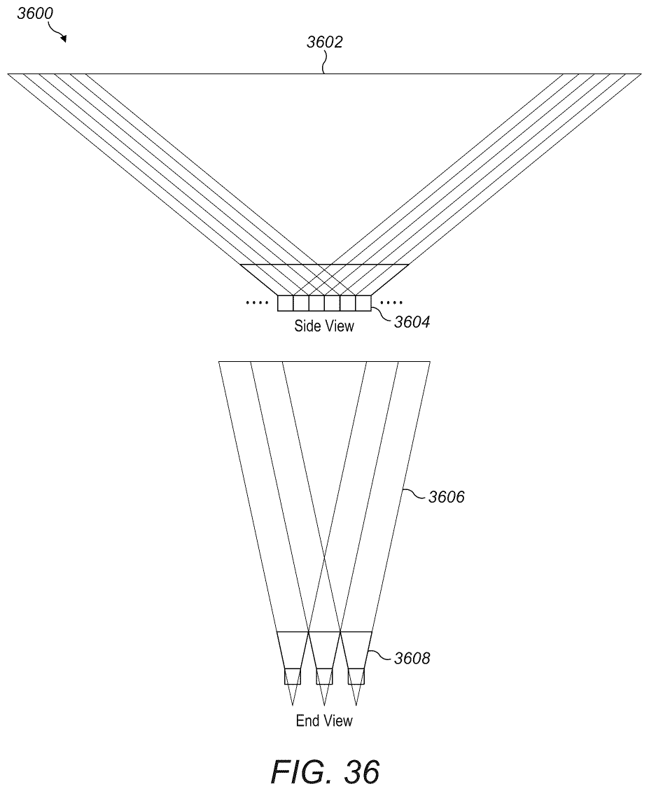

FIG. 36 shows a plot 3600 of the distribution of pressure in the two dimensions using horns showing a broad emission 3602 in a side view dimension 3604 and narrow emission 3606 in the other dimension 3608.

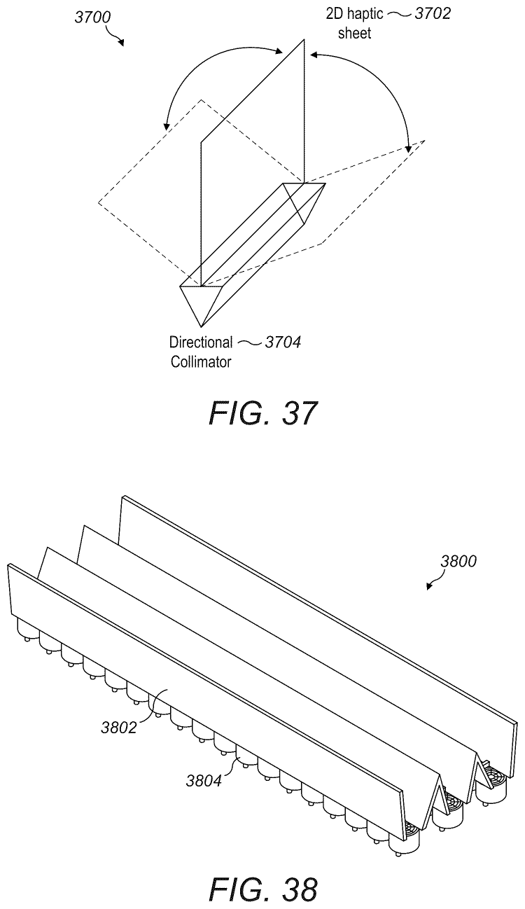

FIG. 37 shows a plot 3700 of a 3D interaction zone created by rotating a 2D sheet of ultrasound 3702 using a directional collimator 3704.

FIG. 38 shows a plot 3800 of a shared horn structure 3804 with transducers 3D view 3802.

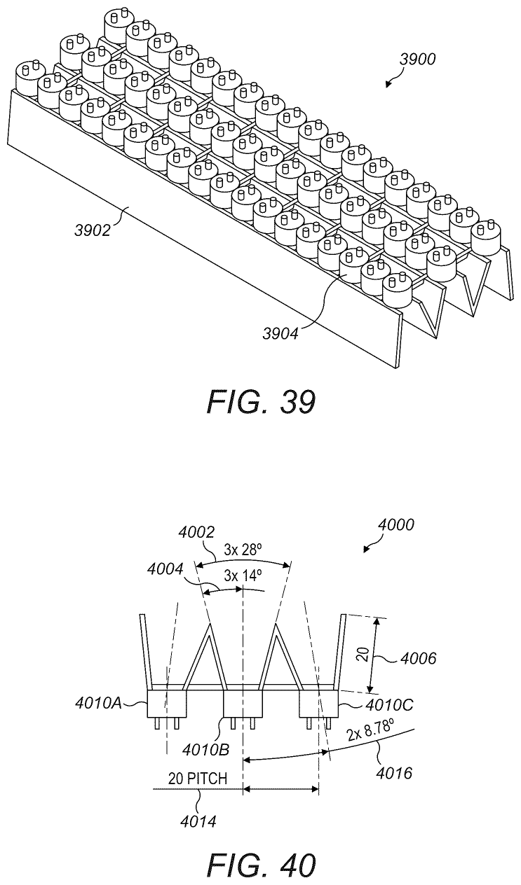

FIG. 39 shows a plot 3900 of a shared horn structure 3904 with transducers 3D view underside 3902.

FIG. 40 shows a plot 4000 of an end view of shared horn structure on top of transducers on top of transducers 4010A 4010B 4010C with specific horn geometry. A 20 mm pitch 4014 is between the centers of transducers 4010B 4010C. The horns atop the two rows of transducers to the left 4010A and to the right 4010C are both tilted 8.78 degrees inward 4016 towards the central transducer row 4010B, whose central horn is not tilted. As shown on the central transducer 4010B, each horn has locally a 14-degree tilt 4004 between the left edge of the horn and the centerline of the transducer, shown as 4010B. Further, as shown on the central transducer, each horn has a 28-degree tilt 4002 between the left edge and the right edge of the horn atop each transducer, shown on center transducer 4010B. Each horn extends a maximum of 20 mm from the transducer surface, as shown on the right edge 4006 of the right transducer 4010C.

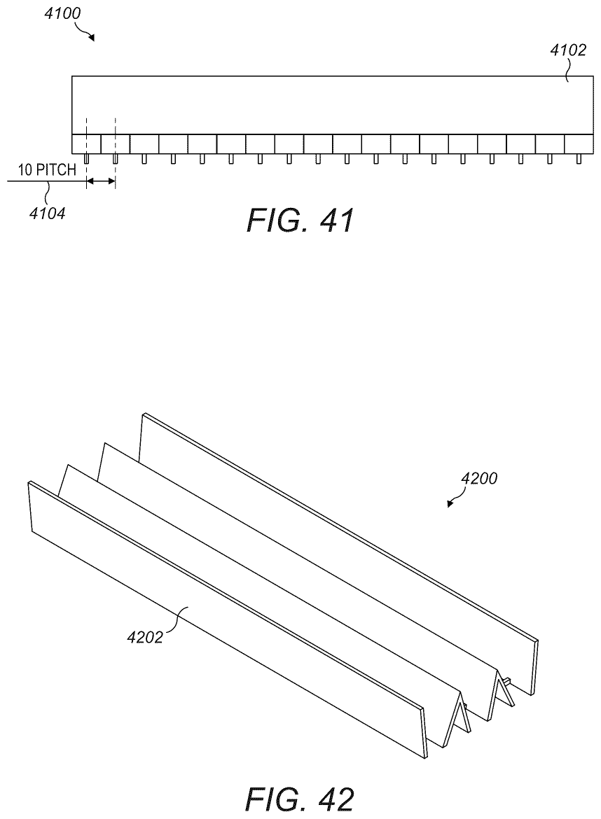

FIG. 41 shows a side view 4100 of shared horn structure 4102 on top of transducers where a 10 mm pitch 4104 separates the center of each transducer element on this axis. FIG. 42 shows a view 4200 of shared horns 4202.

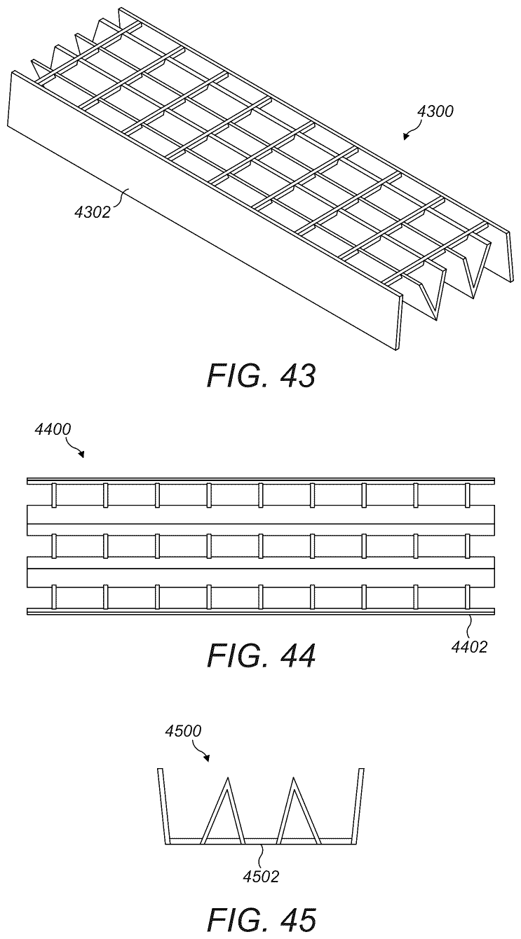

FIG. 43 shows a view 4300 of shared horns underside 4302.

FIG. 44 shows a view 4400 of a shared horn top down 4402.

FIG. 45 shows a view 4500 shared horn end view 4502.

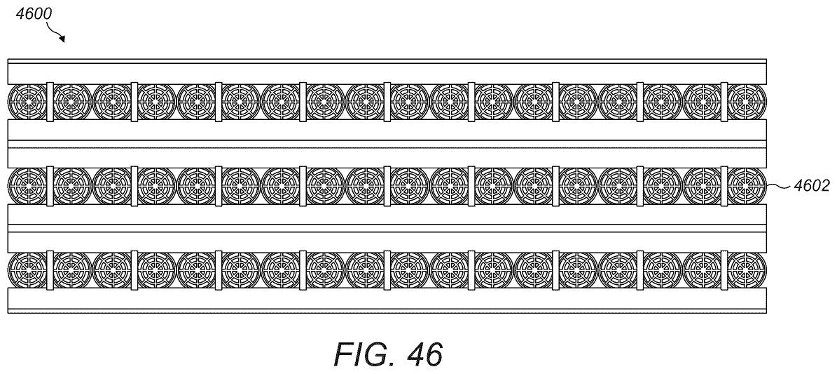

FIG. 46 shows a view 4600 of a shared horn top down with transducers 4602.

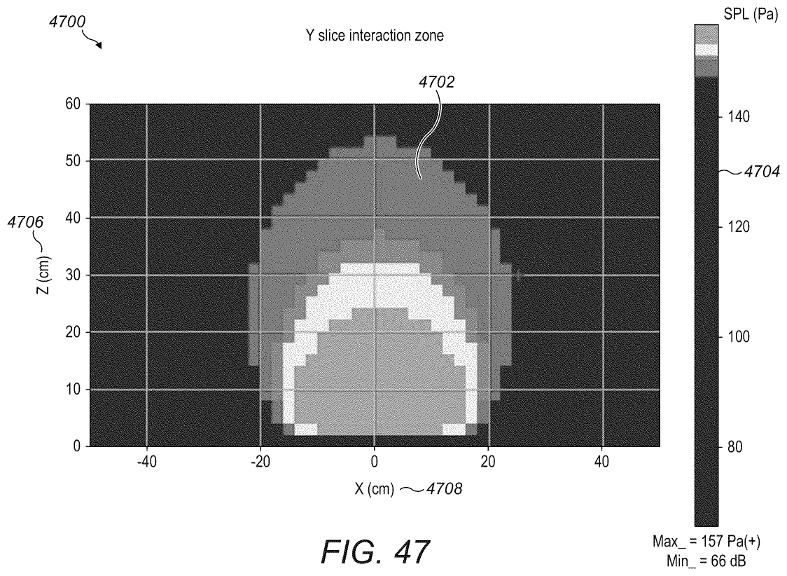

FIG. 47 shows a plot 4700 of a simulated pressure output 4702 in a Y slice interaction zone in dB SPL 4704 from the horn array design in the non-confined axis. The x-axis 4708 is the x direction in cm in the local array coordinate system. The y-axis 4706 is the z direction in cm in the local array coordinate system.

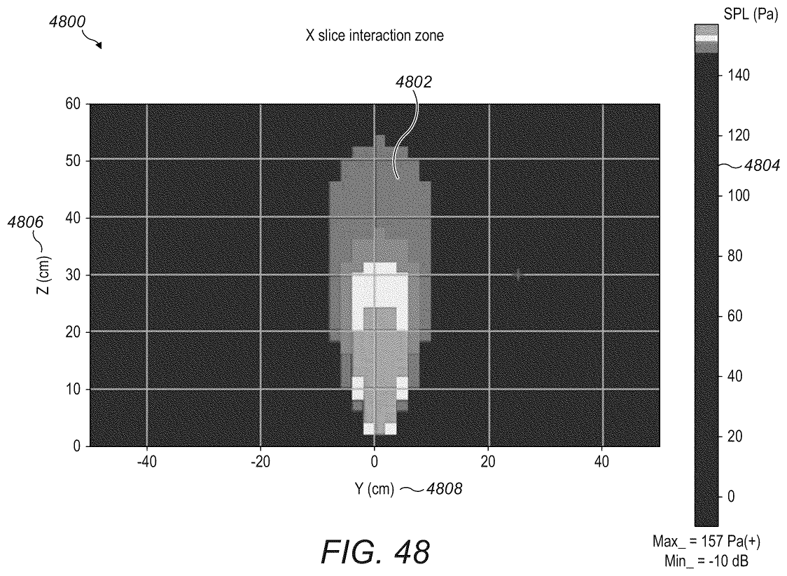

FIG. 48 shows a plot 4800 of a simulated interaction zone output 4802 in a X slice interaction zone in dB SPL 4804 from the shared horn array in the confined axis. The x-axis 4808 is the y direction in cm in the local array coordinate system. The y-axis 4806 is the z direction in cm in the local array coordinate system.

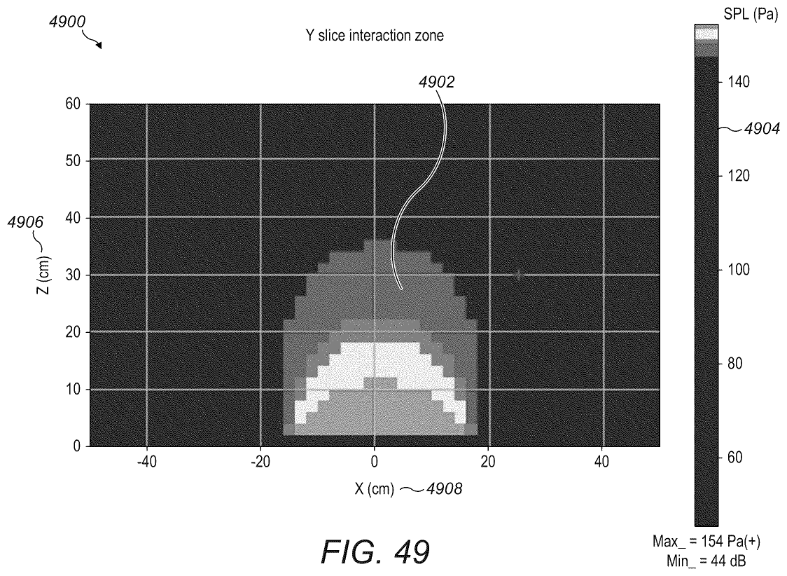

FIG. 49 shows a plot 4900 of a simulated pressure output 4902 in a Y slice interaction zone in dB SPL 4904 from a simulated interaction zone for a 18×3 array without any horns for comparison. The x-axis 4908 is the x direction in cm in the local array coordinate system. The y-axis 4906 is the z direction in cm in the local array coordinate system.

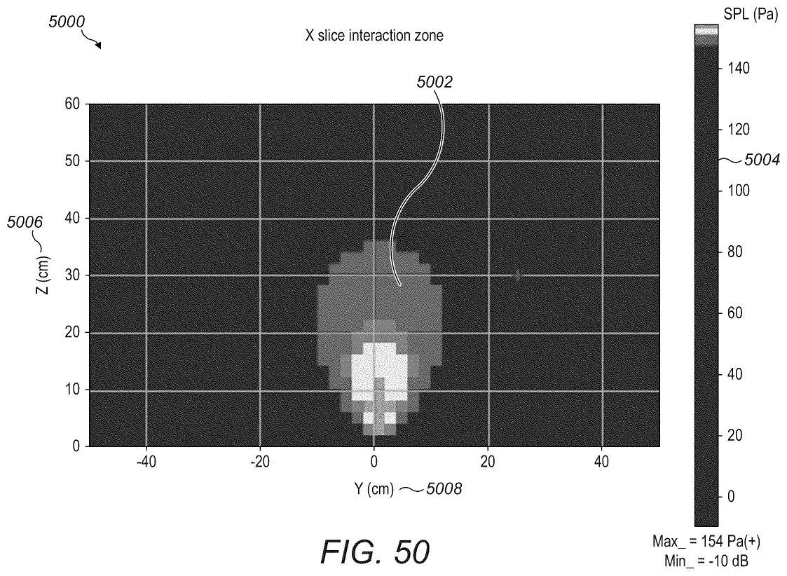

FIG. 50 shows a plot 5000 of a simulated interaction zone output 5002 in a X slice interaction zone in dB SPL 5004 from a simulated interaction zone of 3×18 array without horns for comparison low width array dimension. The x-axis 5008 is the y direction in cm in the local array coordinate system. The y-axis 5006 is the z direction in cm in the local array coordinate system.

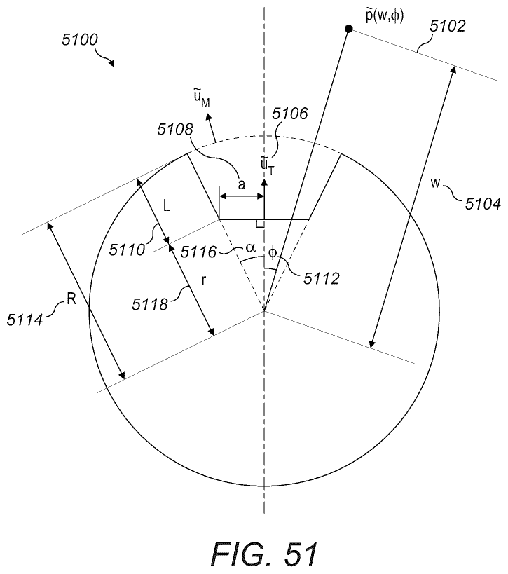

FIG. 51 shows a diagram 5100 of the geometry of the parabolic horn used for the analytical model. Shown is a section of the infinite rigid cylinder into which the horn is modelled as being recessed into, where R 5114 is the distance between the lip of the horn output and the conceptual centerline of the modelled infinite rigid cylinder, r 5518 is the distance between the conceptual centerline and the input of the horn, L 5110 is the distance between the horn input edge and the lip of the horn output, a 5018 is the radius of the horn input aperture, α 5116 is the angle the horn makes with the conceptual cylinder centerline, ϕ 5112 is the angular part of the pressure parameterization, w 5104 is the radial part of the pressure parameterization, \tilde{p}(w, ϕ) 5102 is the pressure evaluated at the parameters 5112 5014, ũ_{M} 5105 is the output aperture, the ‘mouth’ of the horn, ũ_{T} 5106 is the input aperture, the ‘throat’ of the horn.

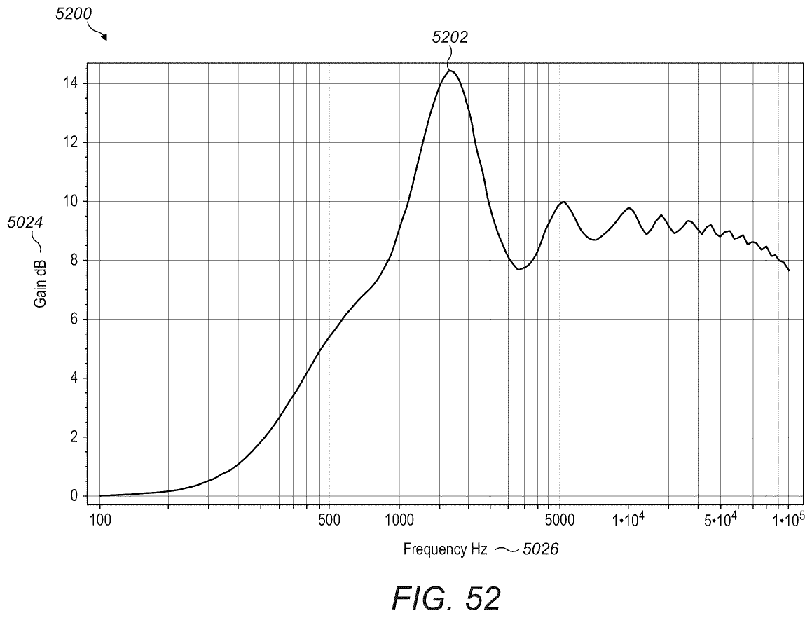

FIG. 52 shows a plot 5200 of a modeled frequency response 5202 of a horn with: α=14 degrees, L=20 mm, a=4.2 mm, ρ₀=1.18 kg/m³, c=345 m/s. The x-axis 5026 is frequency in Hz. The y-axis 5024 is gain in dB of pressure with an arbitrary reference point.

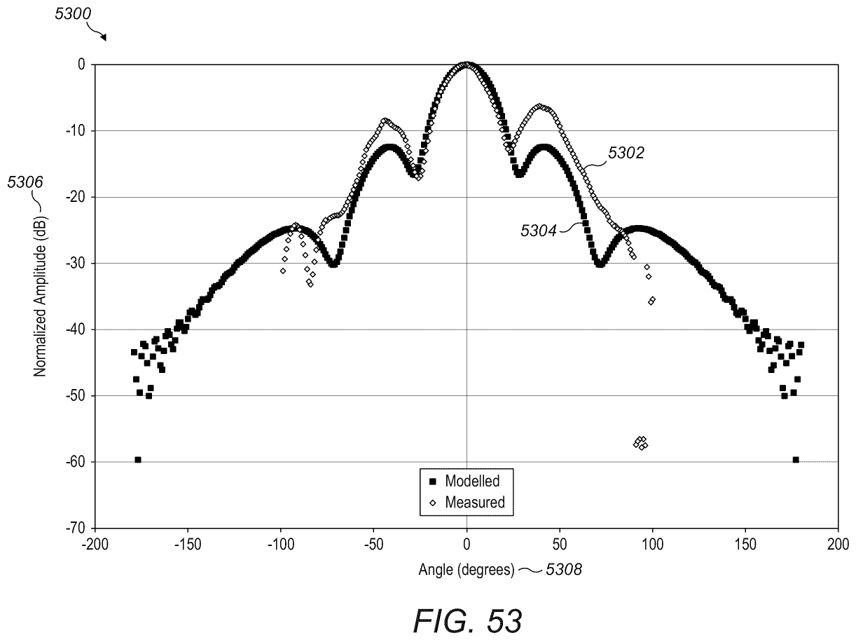

FIG. 53 shows a plot 5300 of measured 5302 and modeled 5304 directivity behavior of a horn with: α=14 degrees, L=20 mm, a=4.2 mm, ρ₀=1.18 kg/m³, c=345 m/s. The x-axis 5308 is angle in degrees. The y-axis 5306 is normalized amplitude in dB, where the reference is defined as the peak of the main lobe.

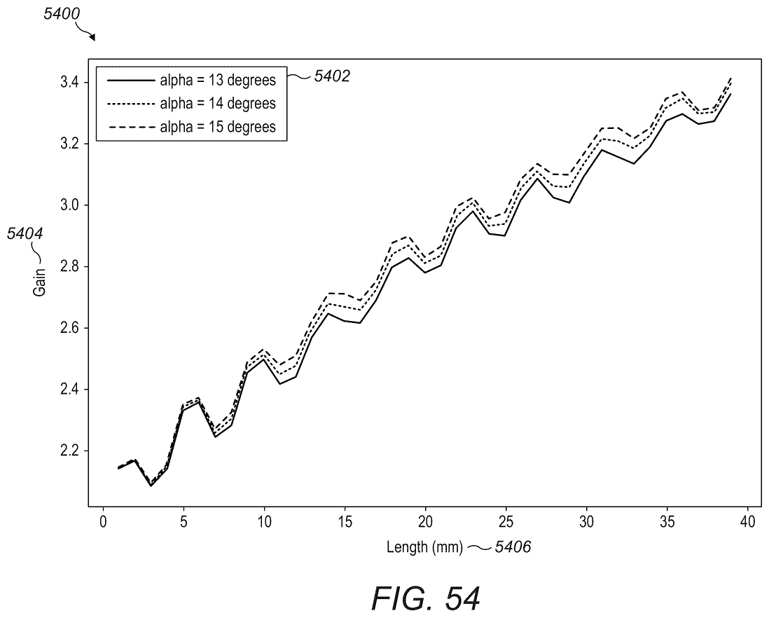

FIG. 54 shows a plot 5400 parameter sweep using the analytical model for a variety of horn angles 5402 and horn lengths affecting on axis gain. The x-axis 5406 is length in mm. The y-axis 5404 is gain as additional output in dB of pressure, as the proportion of the output far field pressure with the horn present compared to the input in a scenario without the horn.

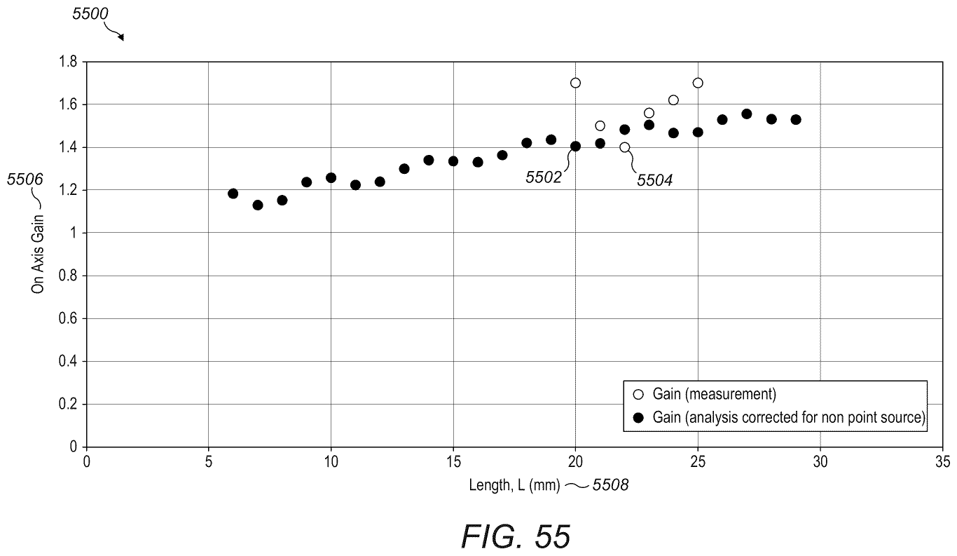

FIG. 55 shows a plot 5500 of differences in analytical model gain 5502 and measured gain 5504 for horns of various lengths. The x-axis 5508 is length (L) in mm. The y-axis 5506 is on axis gain as a proportion of the initial input pressure.

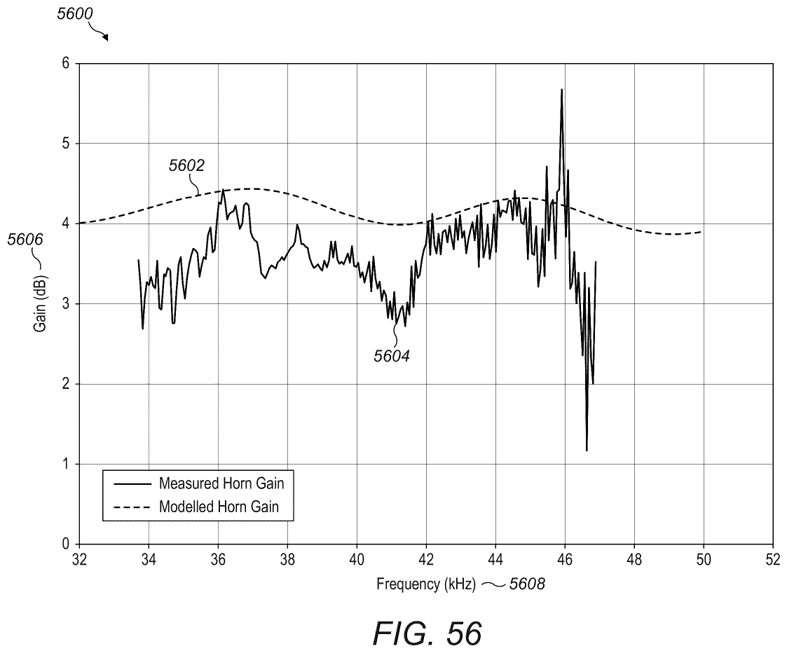

FIG. 56 shows a plot 5600 of measured 5604 versus modeled 5602 horn on axis gain. The x-axis 5608 is frequency in Hz. The y-axis 5606 is gain in dB. The horn is as in the above Figures, with correction factor for non-point source used for the modeled horn.

Initial Concept. The initial concept of increasing directivity of the constituent transducers of a phased array to increase the interaction zone is shown in FIG. 35. The top diagram shows the acoustic pressure distribution from a transducer array without adjustment in directivity. It shows that acoustic pressure is emitted in a wide distribution, however the amount of pressure required for haptics is only available in a much smaller zone. This results in regions where the emitted ultrasound pressure is wasted as it is not sufficiently high enough pressure to be useful for the application but is still present in these regions. The diagram at the bottom of Error! Reference source not found.35 shows an array made with more directive transducers.

Acoustic pressure is emitted in a more vertical direction, the interaction zone 3510 area is larger directly above the phased array, and there is less pressure in regions where no interaction zone exists. The interaction zones 3504 3510 represent acoustic pressure which meets the desired threshold, while the remainder of the ultrasound emission zones 3502 3508 represent acoustic pressure which is not high enough for the application.

This method is varying the directivity of the individual transducers to concentrate the emission into a smaller cone above each transducer. However, as discussed herein, it is difficult to ascertain the effect this will have on the interaction zone, as in order to increase the directivity, the size of individual transducers increases. Also, the ideal directivity depends on the number of transducers and the aspect ratio of the phased array as well as the size and shape of the required interaction zone. It is technically difficult and costly to produce a bespoke transducer design for every desired directivity function to hit a specific array cost, size and interaction zone requirement for a given application.

An apodization is the tapering of each element's amplitude to achieve an overall scheme across a domain. In general, this technique is applied globally to the surface of a domain, to ensure an aim such as the suppression of side lobes, minimization of main lobe width, shaping of the field, or otherwise. The act of apodization fundamentally lowers the energy inputted into the domain and hence reduces the effective energy the domain may achieve at the foci. To mitigate energy reductions, a method has been developed in which apodization is only applied to a subset of the array domain, to maximize the energy in at the foci while suppressing it elsewhere. The benefits for the company are the suppression of noise leads to reductions of microphone interference than global windowing at the required energy levels at the foci.

Passive Acoustic Structures. It is possible to modify the directivity of a given transducer using various passive acoustic structures. Horns, lenses, or metamaterials are some examples. These structures may increase the on-axis pressure from a transducer by concentrating the sound pressure into a smaller area than previously. The invention detailed here is the most effective horn design determined.

Horns require a throat aperture to be smaller than the mouth aperture in order to function. Given that the throat aperture is determined by the size of the transducer, the mouth aperture will be larger than a transducer alone, meaning they occupy more space, increasing the distance between two adjacent transducers, increasing the grating lobes (as the array becomes less critically spaced) as well as decreasing the overlap of pressure between. These conflicting outcomes make it difficult to conceptually determine the most effective horn design for a given application and make the optimum horn design determined in this work unexpected.

Horn Design. Specific details of the embodiment of this invention are given in FIG. 38Error! Reference source not found. through FIG. 46. The horn is made up of two flat sides, angled to in this example create a throat aperture connected to Murata MA40S4S transducer. The sides are extended so that multiple transducers share the same horn structure, and each has the directivity profile and on axis power affected in the same way. This side view is shown in FIG. 41Error! Reference source not found., with multiple transducers (18) being affected by the same simple horn structure placed above. In this axis, the directivity of the transducers will remain unaffected by the horn structure, as the sides of the horn are parallel to this angle of emission.

FIG. 40 shows the critical dimensions of the shared horn structure. In this axis, the horn sides confine acoustic pressure so that the emission profile is narrower and stronger in the center. In this way, the acoustic field emitted from the Murata transducer is no longer axisymmetric, with one axis being broad, and the other axis being narrower. This provides the benefit of both outcomes, where the emission profile in one axis is broad, allowing the emission from two adjacent transducers to overlap, and a narrow emission in the other axis which increasing the pressure output from the transducer. The directivity plot for the horn embodiment design is given in FIG. 53. This directivity plot can be used to calculate the acoustic pressure at any point around the array. A parameterized version of this directivity function could be used, to reduce memory requirements as well as increase computational speed.

For the specific design as shown, the interaction zone produced has been simulated using computer model to show the increase in interaction zone volume. The resulting interaction zone is shown to be appreciably different across each axis of symmetry and almost 2D in nature with a wide interaction zone in the non-confined axis shown in FIG. 47 and a narrow interaction zone shown in FIG. 48. Areas denote the area of highest pressure (155 dB SPL), less pressure (150 dB SPL) and the lowest usable pressure (146 dB SPL). For comparison, a simulation of interaction zone was conducted for a phased array of Murata MA40S4S transducers with the same array layout and total number of transducers (32×3) was conducted. The results are displayed in FIG. 49 and FIG. 50. The results show a large increase in interaction zone volume for the array with shared horns. To achieve the same interaction zone without horns would require 32×5 transducer array or 160 transducers, an increase of 64 transducers or 66.6%.

Analytical Model of shared horn structure. The shared horn is modelled as a parabolic horn mounted in an infinite cylinder of a given radius. The sides are assumed to be completely rigid and perfect reflectors. A sketch of the cross section of the horn is shown in FIG. 51 in cylindrical coordinates, where the pressure observed at point ρ is the radial ordinate and is the angular ordinate. The parabolic horn flares over a half angle α and is mounted in an infinite cylinder of radius R in free space, so the axial ordinate z may be ignored. However, for the purpose of this derivation it is assumed the cylinder has a finite axial length 1. An infinite flat strip of half-width a is located at the throat of the horn which is a distance r from the center of the cylinder and vibrates uniformly with a velocity u_{T}. The mouth of the horn is modelled as an infinite curved strip of radius R vibrating with velocity uₘ. The length L of the horn is given by L=R−r.

Modelling the horn in this way gives the following equations:

$$Gain : \\ \frac{{\tilde{U}}_{M}}{{\tilde{U}}_{T}} = \frac{{S}_{M} {\tilde{u}}_{M}}{{S}_{T} {\tilde{u}}_{T}} = \frac{R {\tilde{u}}_{M}}{r {\tilde{u}}_{T}} = \frac{1}{{a}_{21} {Z}_{AR} + {a}_{22}} \\ Where : \\ {Z}_{AR} = \frac{{ρ}_{0} C}{{S}_{M}} {Z}_{s} \\ And : \\ Zs = j \frac{α}{π} ( \frac{{H}_{0}^{( 2 )} ( kR )}{{H}_{1}^{( 2 )} ( kR )} + 4 {\sum }_{n = 1}^{∞} \frac{{sin}^{2} ( n α ) {H}_{n}^{( 2 )} ( kR )}{{n}^{2} {α}^{2} ( {H}_{n + 1}^{( 2 )} ( kR ) - {H}_{n - 1}^{( 2 )} ( kR ) )} ) \\ Directivity : \\ D ( ∅ ) = \frac{2 j}{π kR} ( \frac{1}{{H}_{1}^{( 2 )} ( kR )} + 4 {\sum }_{n = 1}^{∞} \frac{{j}^{n} sin ( n α ) cos ( n ∅ )}{n α ( {H}_{n + 1}^{2} ( kR ) - {H}_{n - 1}^{( 2 )} ( kR ) )} )$$

Where H denotes the Hankel function.

Using the equation for gain, the on-axis gain achieved for various geometries of horns can be investigated without costly manufacturing and measurement iterations. An example of such a parameter sweep is shown in FIG. 54, threes angles of horn flare were investigated, and the gain achieved is plotted against length of horn wall. It is shown that for a specific horn mouth diameter the best gain achieved is with α=14°.

A measured spectrum response of the horn with the same geometries as FIG. 52 is shown in FIG. 56. The spectrum is only relevant in the frequency ranges from 35 kHz-47 kHz as shown, due to the limitations of the measurement equipment used. It was not possible to achieve sufficient signal to noise ratio in other areas of the spectrum.

The analytical model used has some limitations when used to compare data for real world devices. The analytical model assumes an ideal point source positioned in the center of a cylinder at distance R from the mouth of the horn. The measurements were made using a Murata MA40S4S transducer placed at distance L away from the horn mouth (L denoting the side length of the horn). The Murata transducer is not an ideal point source, and already has a directivity function which is much more directive than an omnidirectional point source. The power gain already experienced through the directionality of the Murata transducer can be calculated by integrating the under the spherical directivity function, normalized to an on-axis pressure of 1, of the Murata transducer. Comparing this area to the area of a unit sphere, the square root of the ratio of the area decrease equates to the on-axis power gain experienced by the Murata transducer due to its increase in directivity. This correction factor (2 for a Murata transducer) can be applied to the analytical model to achieve a more realistic estimate for horn gain. Results of comparison between analytical and modelled horn gain using this correction factor is shown in FIG. 55.

A Cost-Effective 3D) Haptic System Constructed out of a 2D Haptic Sheet. FIG. 37 shows the concept of using the 2D haptic sheet emitted from a phased array with horns to construct a full 3D interaction zone by using the system detailed above to create a 2D haptic sheet, then rotating this sheet either using mechanical or phased array methods. In this way the cost reduction benefits are leveraged without the reduction in interaction zone.

Future Horn Designs. In the future, with ever decreasing sizes of transducers, the shared horn will become more useful. Having a transducer which is smaller in diameter than half its wavelength, has multiple advantages in phased array design. There is practically no benefit to going smaller than this size, other than to save material cost. With the shared horn structure, reducing transducer size below this level will still be a benefit, as the shared horn could be used without any sacrifice to phased array performance due to the increase in transducer spacing requirements will still maintain a spacing of wavelength/2, while also increasing the output power of the transducer.

Standard implementations of a shared amplification structure for multiple frequency inputs are reasonably common, however the center of origin for these methods remains the same for all amplified sounds. In the case of musical instruments all notes have the same radiative origin. This is not the case for the invention disclosed here, the origin of acoustic pressure is different for different sources, even though the acoustic amplification is shared between them. This ensures the same advantage for transducers smaller than the critical spacing.

The passive acoustic structure can be formed as a dedicated structure, or the same function could be obtained from the casing surrounding the transducers. Cover materials over the top of the transducer array is often used to make the solution more visually appealing as well as provide more rigidity. Forming the passive acoustic structure using the sides of a support structure in which an array is recessed below a cover material could provide a means for both structural support as well as passive acoustic amplification.

The embodiment of this invention, as shown in the diagrams, is based using sides and edges of a straight nature. It is possible to amplify sound using a flared, conical or curved structures. There may be advantages of curved surfaces for particular applications and when integrating into wider systems in order to meet the size restrictions.

Applications. This invention has application in fields where phased arrays are of interest such as mid-air haptic feedback, parametric audio applications as well as imaging are all potential applications for this invention. The 2D like nature of the shared horn invention lends itself favorably to applications which benefit from this shape of field. User interfaces which leverage 2D surfaces as well as imaging techniques which are mainly interested in imaging the world in 2D segments.

Further, adding a horn structure to the edge of an array given that mounting for a cover material is a potentially necessary part of product design may be used to modify the transducer wavefunction on the edge which provides some of the functionality demonstrated at no extra cost and without any redesign necessary, although for best effect the directivity function for the edge transducers may need to be compensated as previously described.

Novelty. A structure that passively (without electrical power) amplifies the acoustic power within a specific region by diverting acoustic energy from other regions into the Interaction zone (or zones).

A passive acoustic structure (PACS) which changes the power distribution over angle of a transducer or group of transducers in order to amplify acoustic power in a specific region.

The structure is shared between multiple elements in a phased array thereby increasing the effective area of the passive acoustic structure without needing to increase the phased array element spacing (which would be the case if an independent structure with a large effective area was used for each phased array element).

The structure is shared between multiple elements, but the center of origin for the acoustic waves emitted from the individual elements remains different between each element. Each individual element maintains a unique origin for wave emission, although it is sharing a passive acoustic amplifier with other active elements.

Single points on the structure are optimized to provide the acoustic energy redirection benefit to as many elements in the phased array as possible.

The structure can use, but not limited to, reflection, diffraction, refraction, effective refractive index difference, phase change, absorption and/or constructive interference in order to provide passive amplification of acoustic energy at a specific location, locations, zone or zones.

The structure is used in combination with a phased array, to further focus energy in specific zone or zones.

Use of a PACS structure to redirecting the acoustic energy away from regions which are not part of the interaction zone or zones, hence reducing the background acoustic energy for the benefits of safety, and prevention of unwanted interference.

A structure which creates a 2D sheet of acoustic pressure, where mid-air haptic sensations can be felt within this region. This 2D acoustic sheet of pressure can then be rotated in a raster scan method to create a full 3D region of acoustic pressure.

### V. Array Factor Null Points

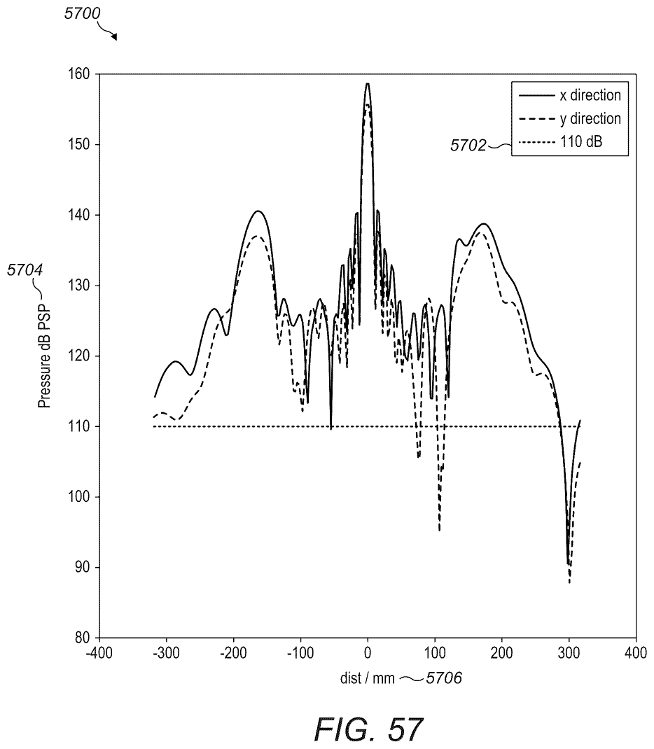

FIG. 57 is a plot 5700 of the directivity 5702 of an array with a single null point calculated with the formula proposed herein. The x-axis 5706 is distance in mm. The y-axis 5704 is pressure in dB PSP. The single zero at +100 mm shows verification of the null point.

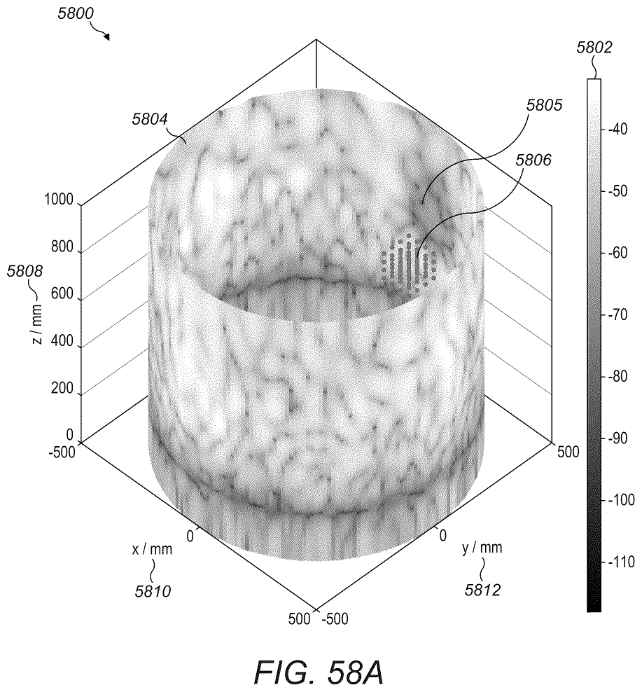

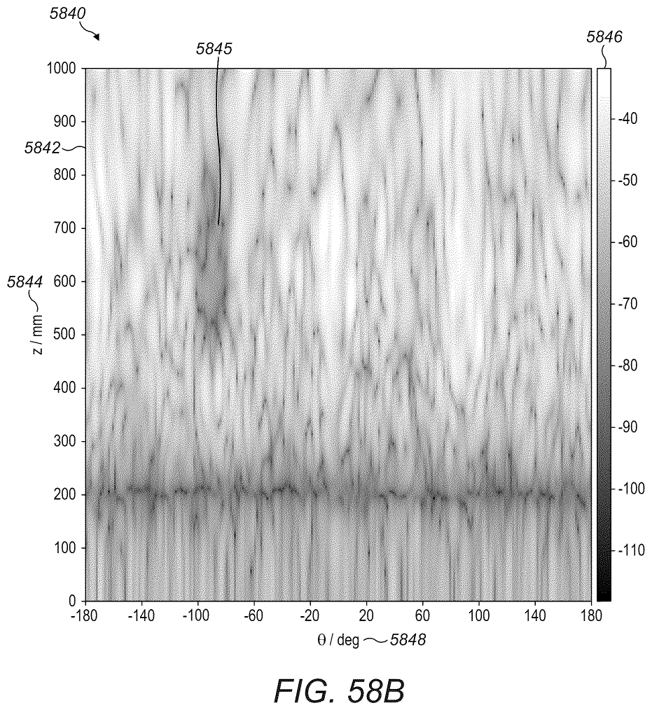

FIG. 58A shows a plot 5800 of an acoustic field from a cube of null points calculated with the proposed method. The field 5804 is shown via an x-axis 5810 in mm, a y-axis 5812 in mm, and a z-axis 5808 in mm comprising a coordinate space local to the transducer array. The key 5802 is in normalized dB, with the reference level set as the focus pressure. The acoustic field interacts with the cube of null points 5806, showing a distinct low-pressure region “shadow” 5805 appearing on the pressure measurements due to the null cube.

FIG. 58B shows a plot 5840 of an unwrapped acoustic field 5842 from a cube of null points calculated with the proposed method. The x-axis 5848 is in degrees (θ), the y-axis 5844 is z in mm, and the key 5846 is in dB. The “shadow” 5845 visible on the pressure measurements is more pronounced in this view, with a darker region visible around θ=−90 degrees and z=600 mm.

Blending with a Non-Zero Control Point Matrix

While this yields a simplified entry to the A matrix when the right hand side vector component is zero, bᵢ=0, representing a null point in the far field of the array, other components of the A matrix may be computed in the usual way, that is if points [1, . . . , m₁] are null points in the far field (or directions for null steering) and points [m₁+1, . . . , m₂] are near or far field control points for mid-air haptics, parametric audio or other purposes, then the A matrix may be formed as:

$$A = \text{} [ \begin{matrix}{e}^{- ik \vert {r}_{1} - {R}_{1} \vert} & ⋯ & {e}^{- ik \vert {r}_{1} - {R}_{N} \vert} \\ ⋮ & ⋱ & ⋮ \\ {e}^{- ik \vert {r}_{{m}_{1}} - {R}_{1} \vert} & ⋯ & {e}^{- ik \vert {r}_{{m}_{1}} - {R}_{N} \vert} \\ {A}_{1} ( {χ}_{{m}_{1} + 1} ) {P}_{1} ( {χ}_{{m}_{1} + 1} ) {H}_{1} ( {χ}_{{m}_{1} + 1} ) & ⋯ & {A}_{N} ( {χ}_{{m}_{1} + 1} ) {P}_{N} ( {χ}_{{m}_{1} + 1} ) {H}_{N} ( {χ}_{{m}_{1} + 1} ) \\ ⋮ & ⋱ & ⋮ \\ {A}_{1} ( {χ}_{{m}_{2}} ) {P}_{1} ( {χ}_{{m}_{2}} ) {H}_{1} ( {χ}_{{m}_{2}} ) & ⋯ & {A}_{N} ( {χ}_{{m}_{2}} ) {P}_{N} ( {χ}_{{m}_{2}} ) {H}_{N} ( {χ}_{{m}_{2}} )\end{matrix} ] ,$$

such that modelling of the pressure function of the transducer may be calculated as the combination of pressure falloff function P, directivity function H, only in cases that involve points that are not far field null points or null-steering directions.

### Reduced Representation—Using Per-Focus Basis Functions

Traditionally, the linear system is described in terms of linear combinations of complex-valued transducer generated fields and their drive coefficients. This produces a matrix, where for m control points and N transducers, the matrix A is N columns by m rows and consists of the generated complex valued signal by each transducer q∈{1, . . . , N} at the location of each control point j∈{1, . . . , m}. Previous work has generated increased power efficiency by adding regularization to this matrix A, but regularisation increases the size of the matrix and thus the compute requirements to solve the system significantly.

Using α_{q}(χⱼ) to describe a complex-valued scalar linear acoustic quantity a (of which an example may be pressure as p_{q}(χⱼ)) measured at a position offset from the transducer element q by the translation vector χⱼ, which may evaluate to be acoustic pressure or an acoustic particle velocity in a chosen direction, the matrix A may be written:

$$A = [ \begin{matrix}{α}_{1} ( {χ}_{1} ) & ⋯ & {α}_{N} ( {χ}_{1} ) \\ ⋮ & ⋱ & ⋮ \\ {α}_{N} ( {χ}_{m} ) & ⋯ & {α}_{N} ( {χ}_{m} )\end{matrix} ] ,$$

This, for a number of control points fewer than the number of acoustically active transducer elements can then be placed into a complex-valued linear system wherein a sample vector b={α₁ (χ1), . . . , αₘ(χₘ)} represents the desired total linear scalar complex-valued acoustic quantity where the amplitudes are desired amplitudes of the acoustic quantity and the phases are those taken from the phase oracle (which may have been user-influenced). In this linear system described as Ax=b, the x vector is then the initial field coefficients for each transducer element, which may be used to drive a real transducer element, resulting in the recreation of the acoustic field desired. This may then be solved in a loop to provide a system that changes over time.

As this is matrix A is not square, and the degrees of freedom number more than the constraints, this is termed a ‘minimum norm’ system. It is ‘minimum norm’ because as there are infinitely many solutions, the most expeditious solution is the one which achieve the correct answer using the least ‘amount’ of x—the solution x with minimum norm. To achieve this, some linear algebra is used to create a square system from the minimum norm system Ax=b:

$${A}^{H} A x = {A}^{H} b ,$$

$${( {A}^{H} A )}^{- 1} {A}^{H} A x = x = {( {A}^{H} A )}^{- 1} {A}^{H} b ,$$

This A^{H}A is now N columns by N rows and given that the number of transducers is often very large this is an equivalently large matrix, and since any solution method must invert it, with it, this is not an efficient method. A more accessible approach is to create a substitution A^{H}z=x, before applying a similar methodology:

$$Cz = A {A}^{H} z = Ax = b ,$$

$$z = {C}^{- 1} b = {( {AA}^{H} )}^{- 1} b ,$$

This time around, as C=AA^{H} is a mere m columns by m rows, this result is a much smaller set of linear equations to work through. The vector z can be converted into x at any time so long as A^{H} can be produced.

However, this does not end here. This approach is not just a fortuitous set of symbolic manipulations, the change of variables from the complex-valued vector that describes the drive of individual transducer elements x to the much lower dimensional z has further meaning. Each complex-valued component of z can be viewed as a complex-valued drive coefficient that pre-multiplies a focusing function which generates a focus from all of the individual transducer fields, wherein the focal point is co-located with each individual control point. For m control points therefore, there are m such focusing functions, and they can be viewed as defining a complex vector space [symbol] ^{m} where points in this space correspond to possible configurations of these m “focus points”.

### Numerical Verification

A series of experiments was conducted with illustrative systems to verify the system operates as described. Creating a system with a single focus or control point and a single far-field approximated null, as shown in FIG. 57, functions as intended. As seen in FIG. 57, labelling a phenomenon as far field is always an approximation to an idealized case, so placing points closer to the near field as seen on the y-transect in the figure results in reduced functionality, but equally there is a balance to be struck between near and far field behavior.

A further experiment was conducted with a large number of (in this case 64) far field null or zero points to create a region of reduced output or quiet zone, as shown in FIGS. 58A and 58B. In FIG. 58A, pressure output data is projected onto a cylinder, with the null points (red dots) plotted, showing that these points project a shadow region onto the cylinder which is the desired zone of reduced output. In FIG. 58B, this same cylinder projection is unwrapped to enable a more detailed inspection of the shadowed region.

It may be noted that in each case, as these are exploiting far field approximate behaviors, that successfully formed regions may be projected out to infinity as these will necessarily also represent a section of solid angle with the same desirable output reduction or quieting properties.

### VI. Acoustic Lenses and Waveguides to Improve Output Contrast of Ultrasonic Phased Arrays

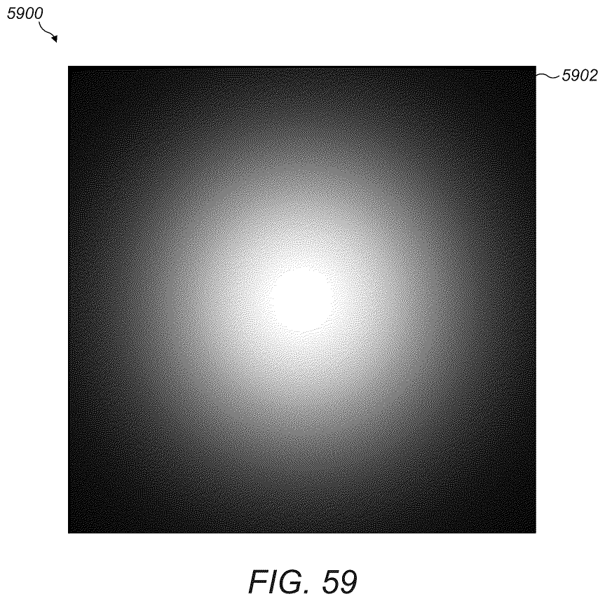

FIG. 59 shows a plot 5900 of a continuous function 5902. Taking a window function (such as for example this Gaussian window) in order to have a Fourier representation that is band-limited, it must be a continuous function. This is then applied to the amplitudes of transducer elements to apply the window function that reduces side lobe power.

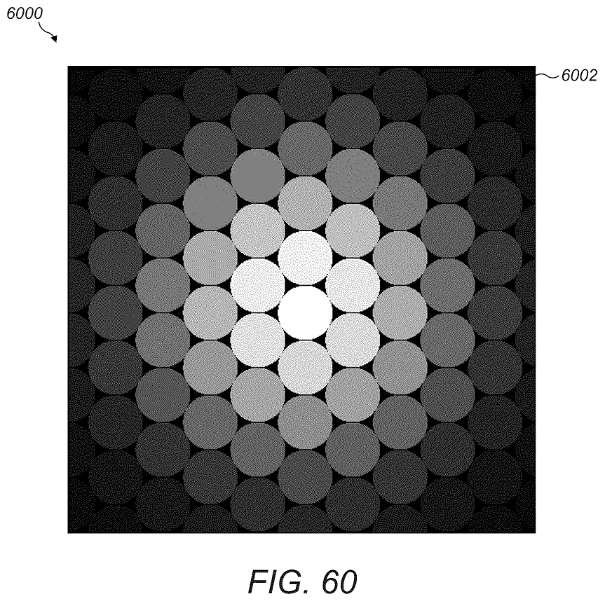

FIG. 60 shows a plot 6000 of a discrete window function 6002 wherein each circle notionally represents a transducer. Creating transducers wherein their amplitudes are taken from the average window function at their sampled locations allows discrete elements to minimize error with regards their output amplitude to best recover the window function. However, this necessary discretization reduces the effect of the window function.

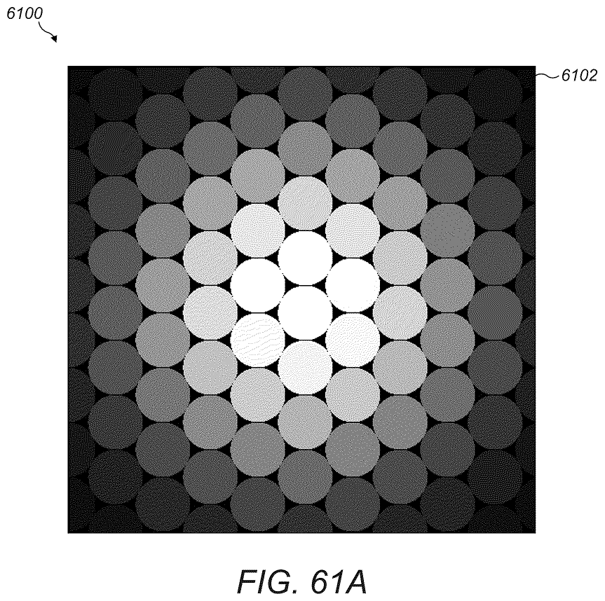

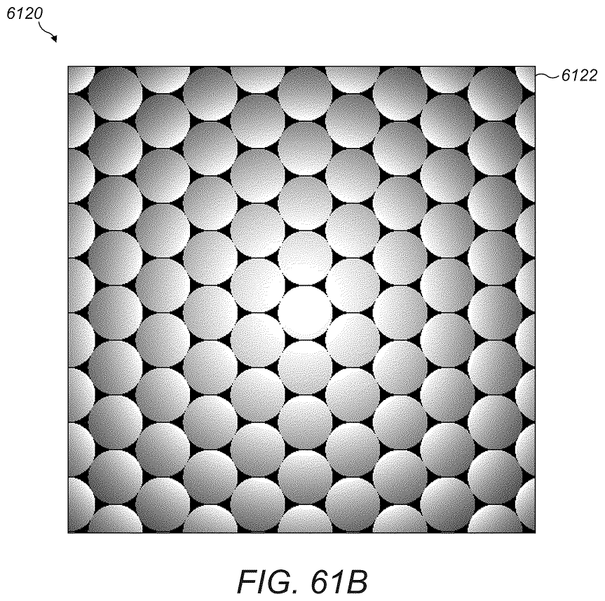

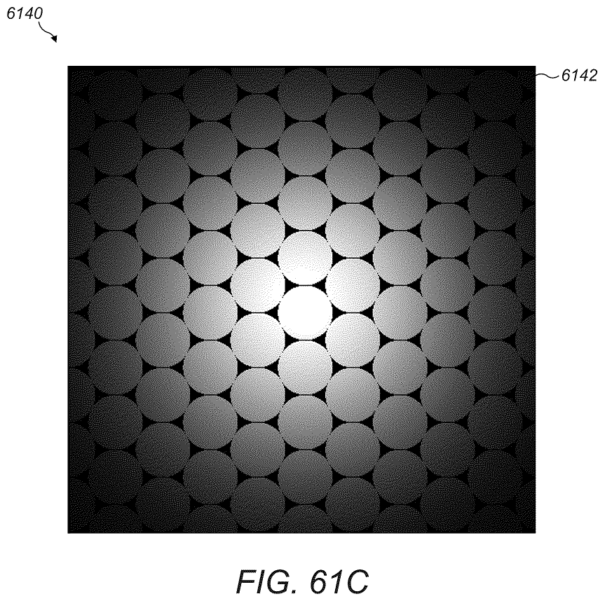

FIGS. 61A-61C illustrate a decomposition of the continuous function such that the continuous window function may be recovered in the regions of the transducer apertures even when the transducer array is comprised of discrete transducers. FIG. 61A shows a plot 6100 of setting the amplitude of each transducer to the maximum sample in each circular region 6102. FIG. 61B shows a plot 6120 of a fitting material with an attenuation modifier (which is obtained by dividing through the desired window by the maximum sample value) across the surface of each transducer 6122. FIG. 61C shows a plot 6140 of a much closer approximation to the original window 6142 that overcomes the limitations of discrete transducer elements, as the effects of the two attenuation mechanisms are multiplicative.

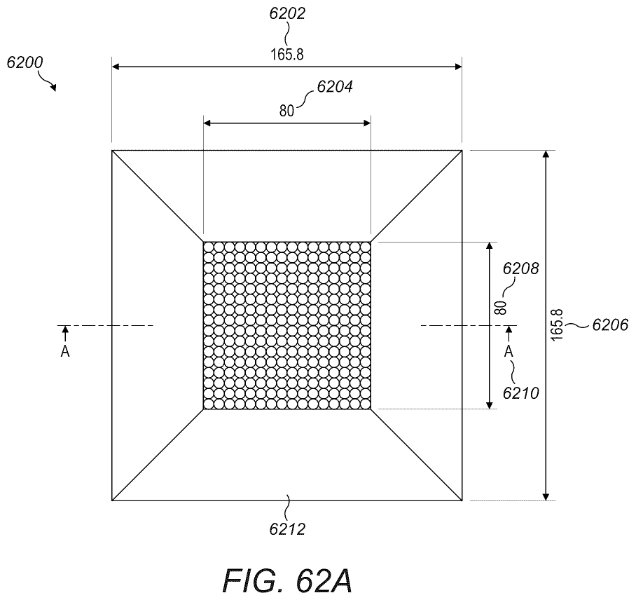

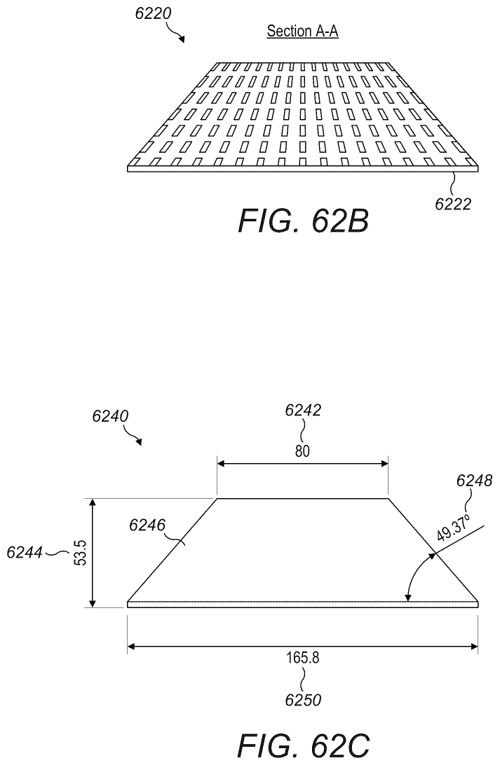

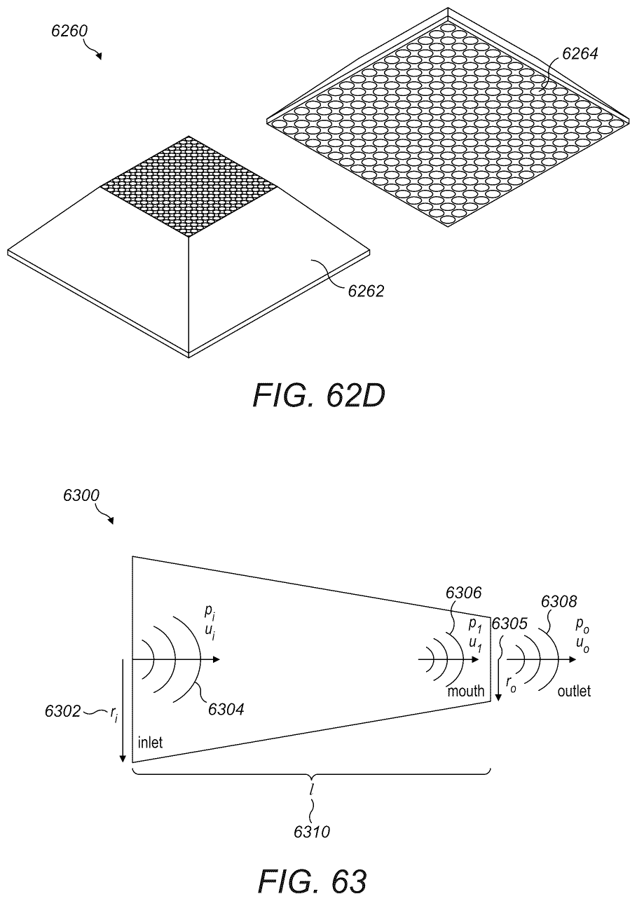

FIGS. 62A-62D show a schematic of a waveguide design to illustrate a single covering to reduce interelement spacing for arrays and apply a passive window apodization via the duct length attenuations. The waveguide is comprised of an assembly of individual ducts for each transducer mapping it to a new position with reduced interelement spacing. FIG. 62A shows a schematic 6200 of a top view of transducers 6212. Exemplary dimensions are 165.8 mm on each side with the base 6202 6206 and 80 mm on each side without the base 6204 6208. The placement of cross-section A-A 6210 is shown. FIG. 62B shows a schematic 6220 of the cross-section A-A 6222. FIG. 62C shows a schematic 6240 of a side view of transducers 6246. Exemplary dimensions are 80 mm across the top 6242, 168.8 mm across the bottom 6250, 53.5 mm height 6244, and an angle of 49.37 degrees 6248. FIG. 62D is a schematic 6260 of a perspective view 6262 and a bottom view 6264.

FIG. 63 shows a schematic 6300 for a single acoustic duct. The duct of length l 610 has an inlet radius of rᵢ 6302 and an outlet radius of r. 6305. The variables in the system are pressure, p, and the particle velocity, u. The variables at the inlet 6304 are denoted with a subscript i, the variables at the mouth 6306 denoted by subscript 1 and the variables radiating from the outlet 6308 are denoted by o.

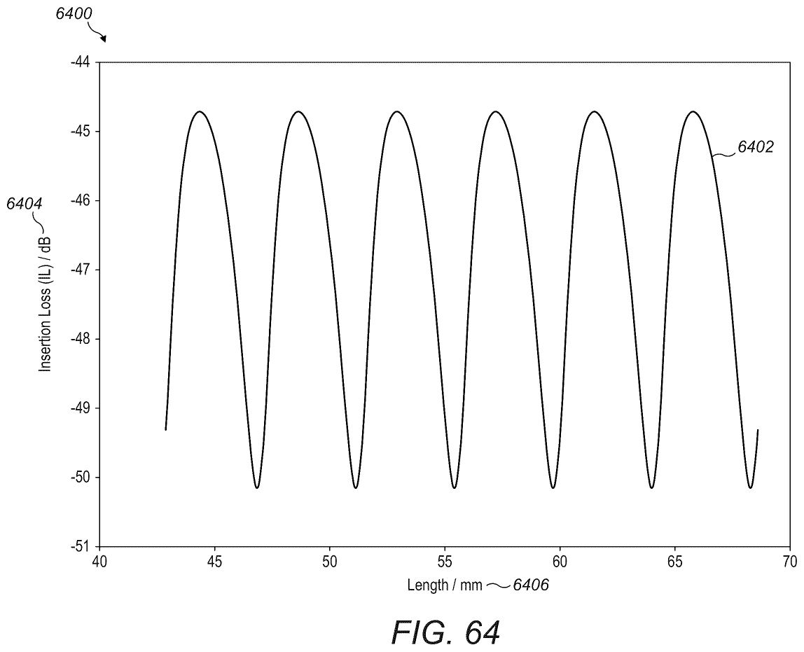

FIG. 64 shows a plot 6400 of a FIG. 6402 of the insertion loss calculated by a mathematical model of a 40 kHz ultrasonic acoustic field in a conical duct of varying length, modelled with the transfer matrix method (TMM). The insertion loss shows oscillatory behavior the duct lengths, which will need to be accounted for to produce an exact outlet amplitude. The x-axis 6406 is length in mm. The y-axis 6404 is insertion loss is in dB and describes the difference in far field pressure output between the input in a scenario without the duct and output with the duct present.

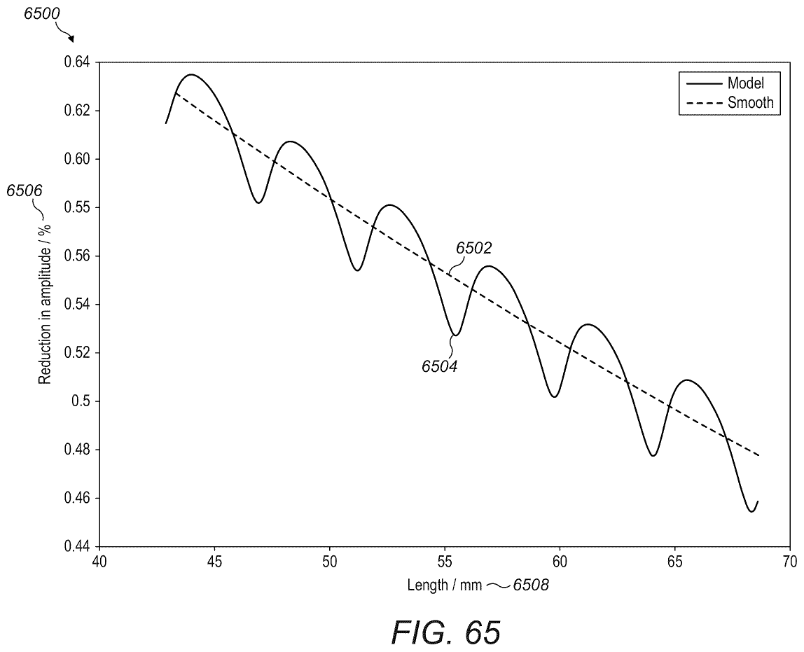

FIG. 65 shows a plot 6500 of a “model” FIG. 6504 and a “smooth” trend line FIG. 6502 showing the attenuation a 40 kHz ultrasonic acoustic field in a conical duct calculated by the TMM for varying length. The x-axis 6508 is length in mm. The y-axis 6506 is reduction in amplitude in %.

The attenuation model exhibits the oscillatory behavior seen in FIG. 64. An approximation to the attenuation in the duct may be found by taking the mean of the insertion loss model to give a constant attenuation coefficient, allowing one of the approaches outlined in the main body to manufacture a passive window waveguide.

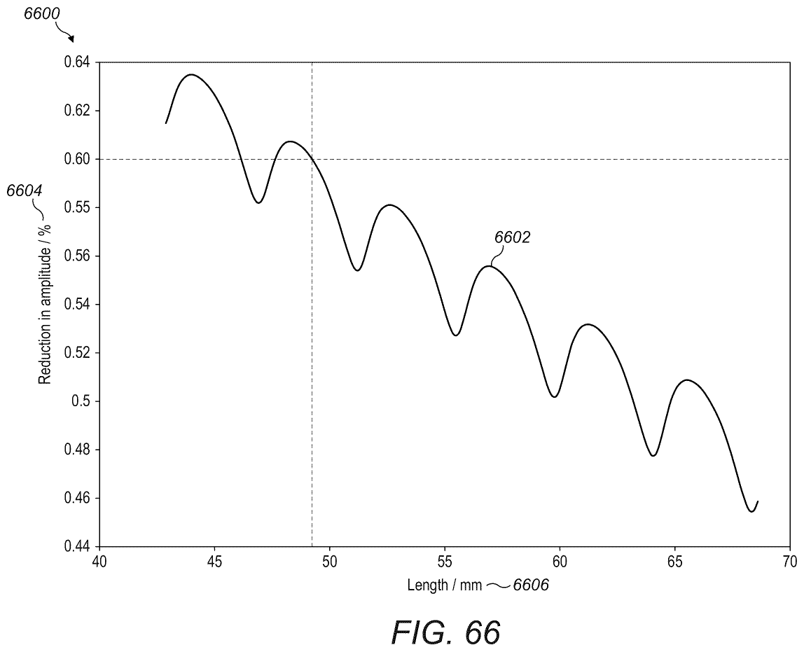

FIG. 66 shows a plot 6600 of a FIG. 6602 showing the attenuation of a 40 kHz ultrasonic acoustic field in a conical duct calculated by the TMM for varying length. The x-axis 6606 is length in mm. The y-axis 6604 is reduction in amplitude in %.

To demonstrate how the attenuation of a waveguide may be deliberately manipulated to generate an overall effect an example of amplitude of 0.6 is chosen. The nearest value to 0.6 is located and the duct length to produce it is derived as approximately 49 mm.

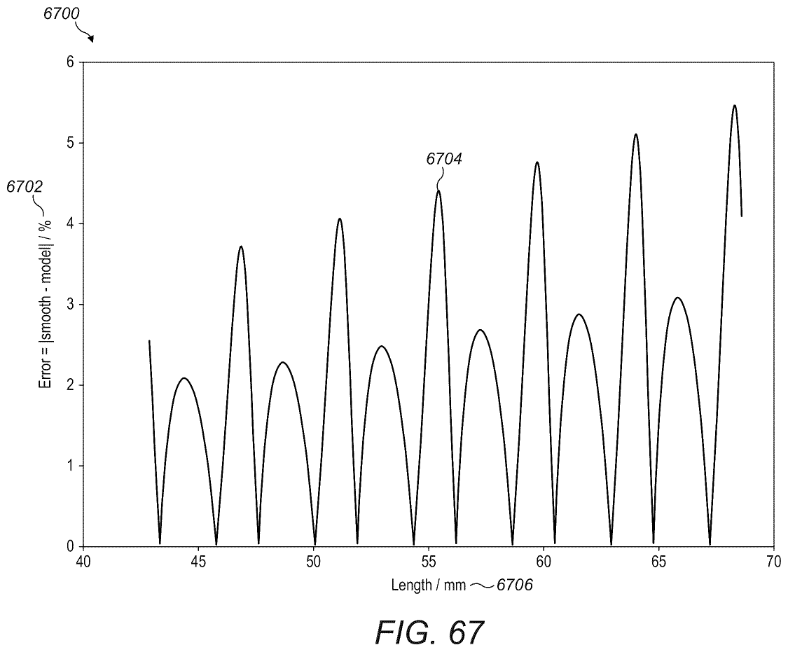

FIG. 67 shows a plot 6700 of the error 6704 between the constant approximation and the TMM calculated attenuation response of a conical duct. The x-axis 6706 is length in mm. The y-axis 6702 is % error measured by the absolute value of the difference between “smooth” trend line and “model” in reduction in amplitude in %. This error may also be calibrated out by varying the source amplitude accordingly.

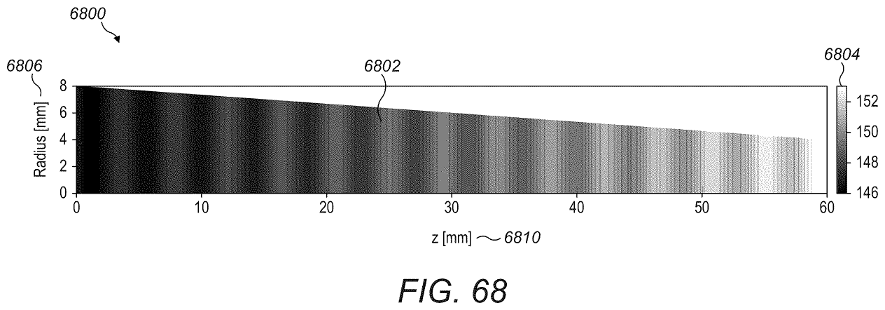

FIG. 68 is a plot 6800 showing a simulation 6802 of the acoustic field (in dB SPL 6804) within a conical duct at 40 kHz. The x-axis 6810 is z in mm. The y-axis 6806 is radius in mm. This simulation software was developed in B. Kolbrek, MMM-toolbox, kolbrek.hornspeakersystems.info/index.php/sw/mmm-toolbox., 21 Jan. 2022 (“Kolbrek I”), and verified in B. Kolbrek, Modal propagation in acoustic horns, kolbrek.hornspeakersystems.info/images/misc/evaluation_mpm_2012_bk.pdf, June 2012 (“Kolbrek II”).

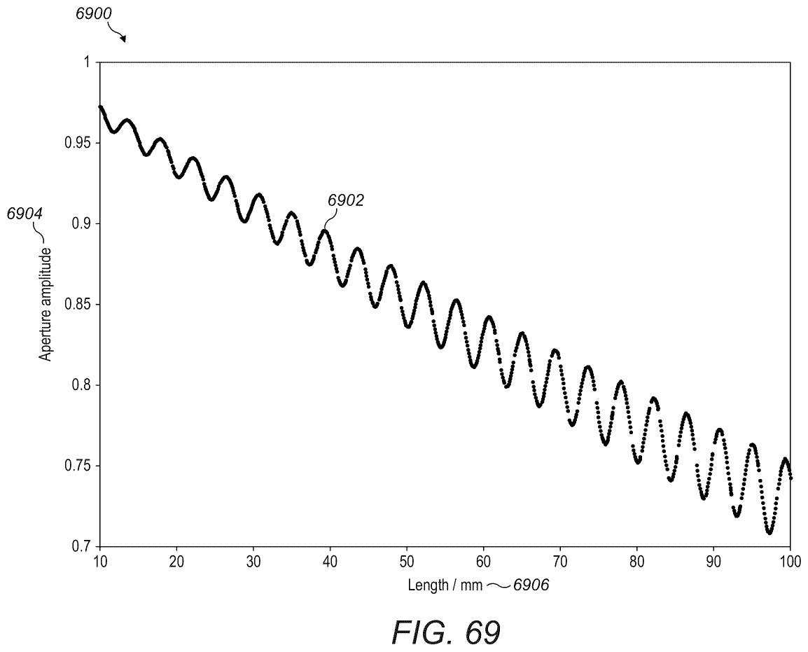

FIG. 69 is a plot 6900 of the outputted amplitude 6902 at the aperture of conical duct for varying length, for an acoustic wave simulated at 40 kHz. The x-axis 6906 is length in mm. The y-axis 6604 is aperture amplitude, the proportion of the output far field pressure with the duct present compared to the input in a scenario without the duct. The figure demonstrates the oscillatory attenuation response shown in the TMM, FIGS. 64-66.

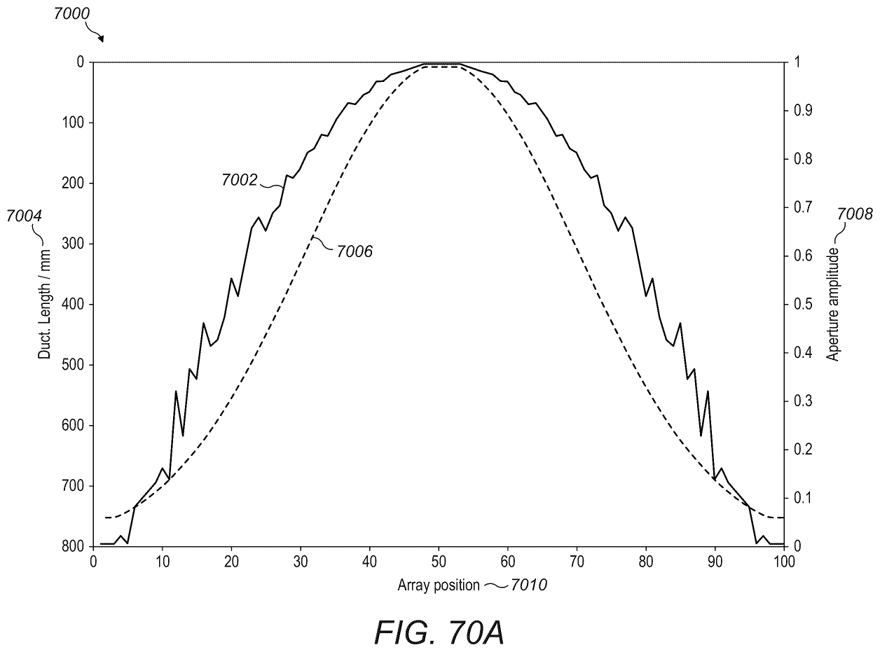

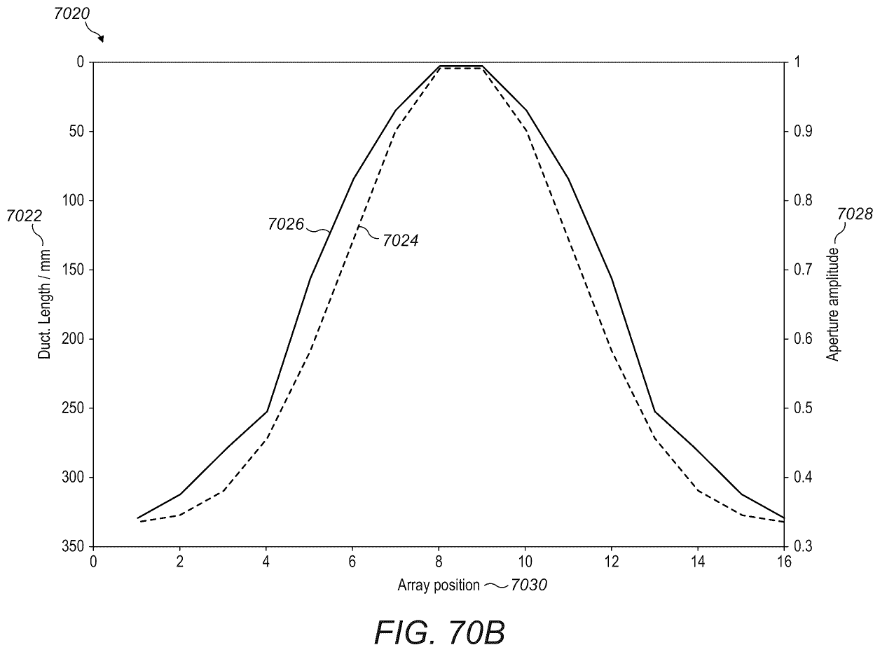

FIG. 70A is a plot 7000 of duct lengths required to generate a waveguide which acts as a passive Gaussian window for a 40 kHz acoustic wave with each source term at a uniform amplitude. The x-axis 7010 is the ordinal array position of the element along an in-plane axis of a rectilinear layout transducer array. The left y-axis 7004 is for the solid line plot 7002 that represents chosen ducts for each array position and is duct length in mm. The right y-axis 7008 is aperture amplitude is for the desired level of attenuation that the ducts must embody, represented by the dashed line plot 7006 and is aperture amplitude as the proportion of the output far field pressure with the duct present compared to the input in a scenario without the duct.

FIG. 70B is a plot 7020 of duct lengths required to generate a waveguide which acts as a passive Chebyshev window for a 40 kHz acoustic wave with each source term at a uniform amplitude. The x-axis 7030 is the ordinal array position of the element along an in-plane axis of a rectilinear layout transducer array. The left y-axis 7022 is for the solid line plot 7026 that represents chosen ducts for each array position and is duct length in mm. The right y-axis 7028 is aperture amplitude is for the desired level of attenuation that the ducts must embody, represented by the dashed line plot 7024 and is aperture amplitude as the proportion of the output far field pressure with the duct present compared to the input in a scenario without the duct.

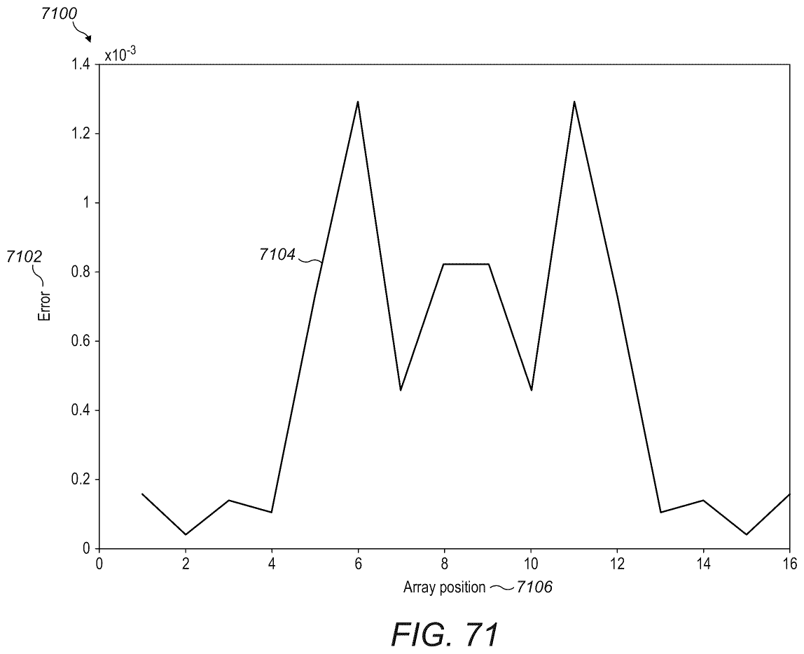

FIG. 71 is a plot 7100 showing the error 7104 between the Chebyshev window function and the outputted amplitude of the waveguide aperture. This results in the construction of desirable acoustic fields. The x-axis 7106 shows array position and the y-axis 7102 shows the error ratio.

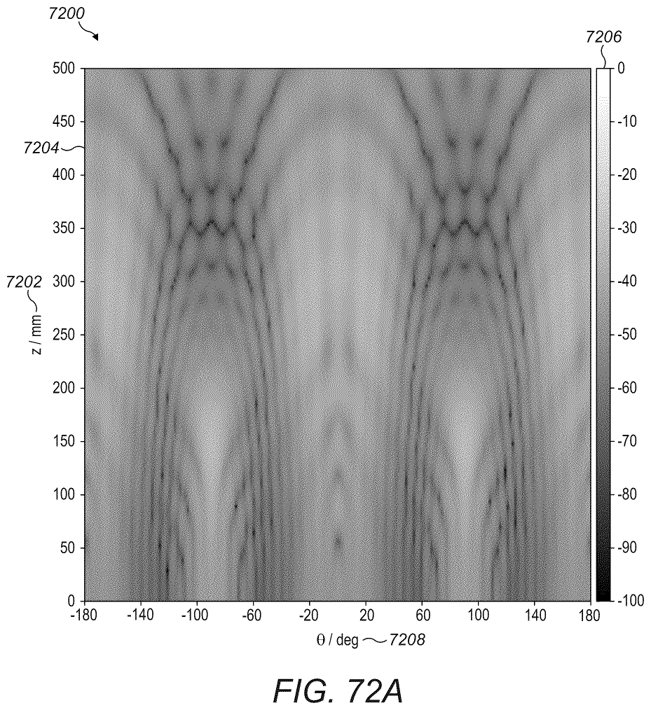

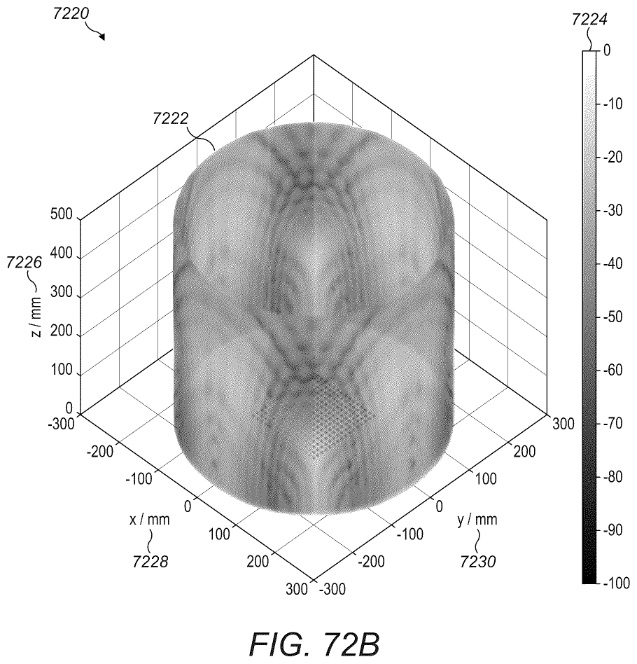

FIGS. 72A and 72B show the acoustic (fringing) field on a cylinder surrounding the array without a covering applied. The interelement spacing is greater than Nyquist and the 40 kHz ultrasonic transducers are driven with a uniform amplitude; these array characteristics results in both side lobes and grating lobes. FIG. 72A shows a plot 7200 of an unwrapped acoustic pressure field 7204 (in normalized dB 7206, with the reference level set as the focus pressure). The x-axis 7208 is θ in degrees. The y-axis 7202 is z in mm. FIG. 72B shows a plot 7220 of an acoustic pressure field 7222 (in normalized dB 7224, with the reference level set as the focus pressure). The x-axis 7228 is in mm. The y-axis 7230 is in mm. The z-axis 7226 is in mm. These x, y and z axes comprise a coordinate space local to the transducer array.

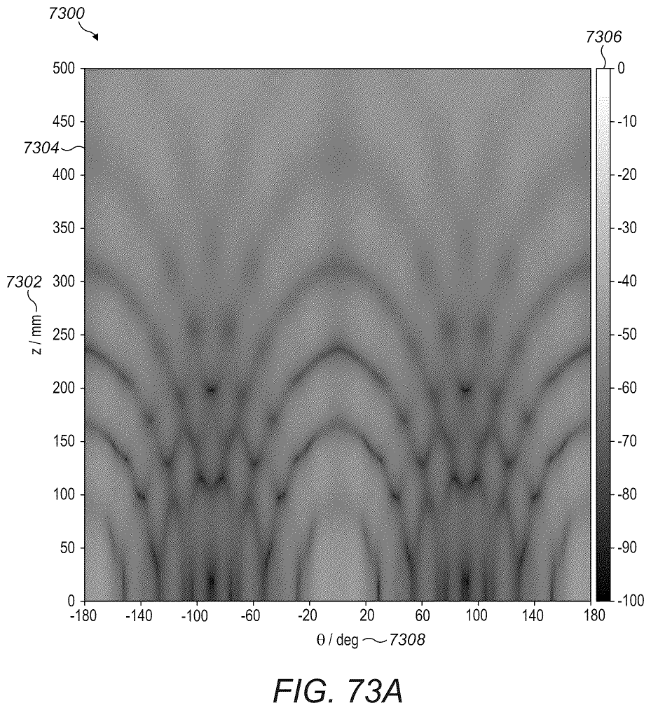

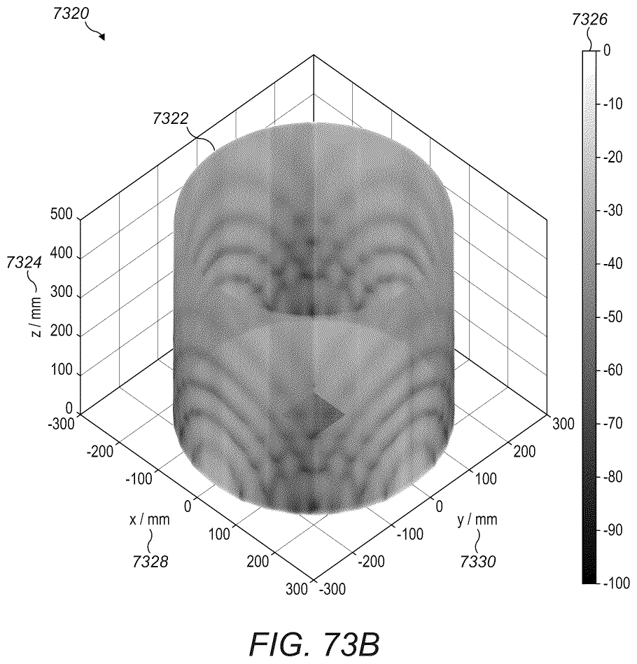

FIGS. 73A and 73B show the acoustic (fringing) field on a cylinder surrounding the array with the cover reducing spacing but no apodization is applied. The interelement spacing is less than Nyquist, the covering apertures are emitting 40 kHz ultrasonic waves with uniform amplitude; these array characteristics results in only side lobes. FIG. 73A shows a plot 7300 of an unwrapped acoustic pressure field 7304 (in normalized dB 7306, with the reference level set as the focus pressure). The x-axis 7308 is θ in degrees. The y-axis 7302 in z in mm. FIG. 73B shows a plot 7320 of an acoustic pressure field 7322 (in normalized dB 7326, with the reference level set as the focus pressure). The x-axis 7328 is in mm. The y-axis 7330 is in mm. The z-axis 7324 is in mm. These x, y and z axes comprise a coordinate space local to the transducer array.

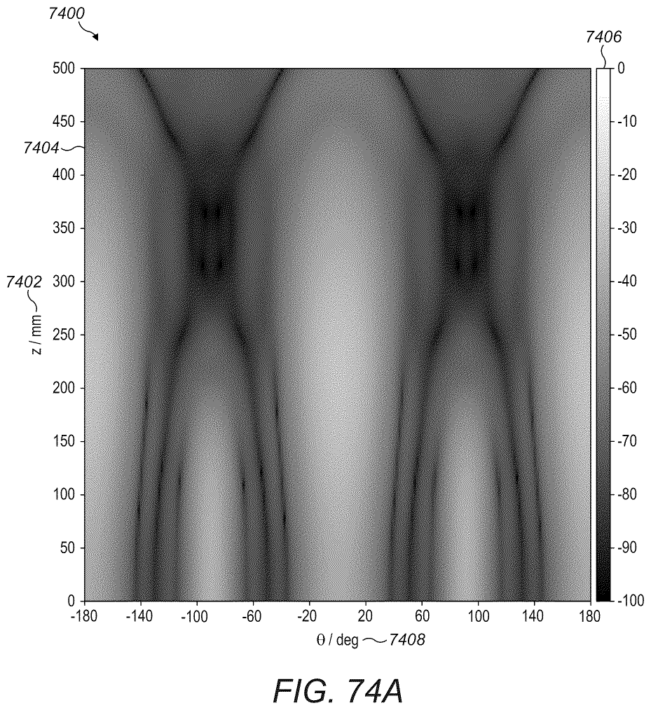

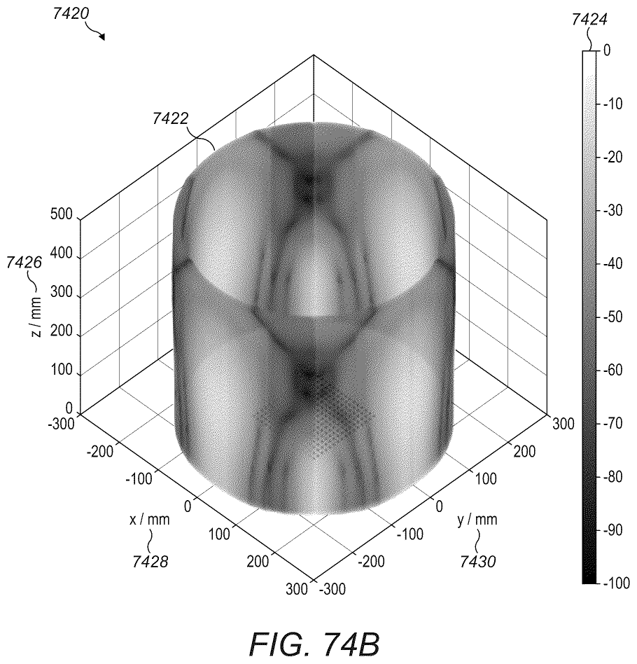

FIGS. 74A and 74B show the acoustic (fringing) field on a cylinder surrounding the array with the cover applying a window apodization but no reduction in spacing. The interelement spacing is greater than Nyquist, the covering apertures are emitting 40 kHz ultrasonic waves with Chebyshev apodized amplitudes; these array characteristics results in only grating lobes. FIG. 74A shows a plot 7400 of an unwrapped acoustic pressure field 7404 (in normalized dB 7406, with the reference level set as the focus pressure). The x-axis 7408 is θ in degrees. The y-axis 7402 in z in mm. FIG. 73B shows a plot 7420 of an acoustic pressure field 7422 (in normalized dB 7424, with the reference level set as the focus pressure). The x-axis 7428 is in mm. The y-axis 7430 is in mm. The z-axis 7426 is in mm. These x, y and z axes comprise a coordinate space local to the transducer array.

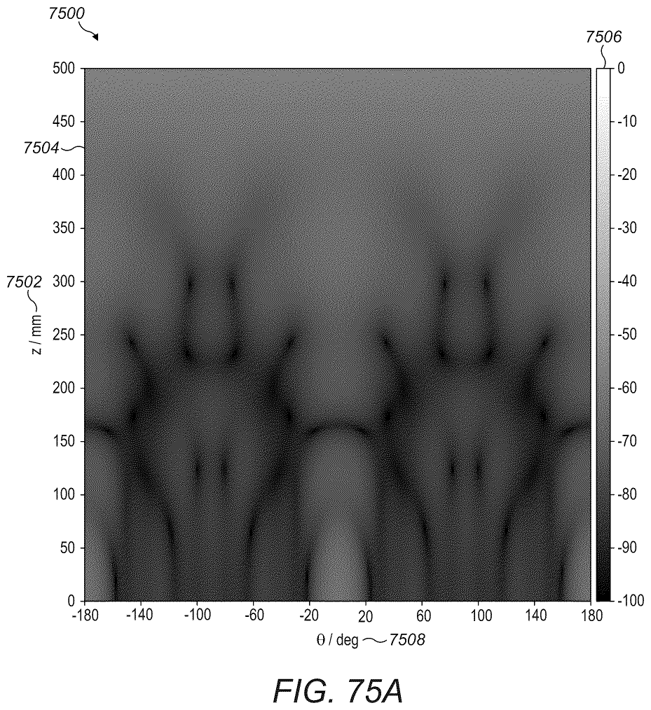

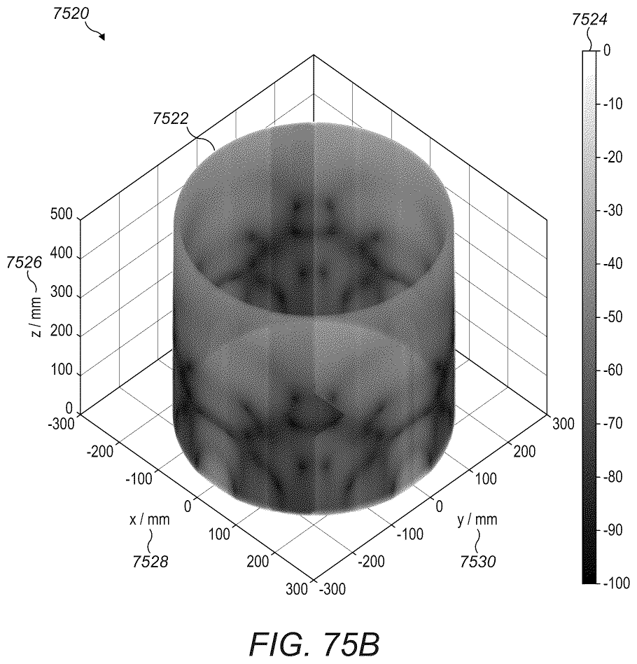

FIGS. 75A and 75B show the acoustic (fringing) field on a cylinder surrounding the array with the cover applying a window apodization and critical spacing. The interelement spacing is less than Nyquist, the covering apertures are emitting 40 kHz ultrasonic waves with Chebyshev apodized amplitudes; these array characteristics results in neither side lobes or grating lobes. Note this field is much darker than FIGS. 72A, 72B, 73A, 73B, 74A, 74B, showing the dramatic reduction of microphone interference due to the covering. FIG. 75A shows a plot 7500 of an unwrapped acoustic pressure field 7504 (in normalized dB 7506, with the reference level set as the focus pressure). The x-axis 7508 is θ in degrees. The y-axis 7502 in z in mm. FIG. 75B shows a plot 7520 of an acoustic pressure field 7522 (in normalized dB 7524, with the reference level set as the focus pressure). The x-axis 7528 is in mm. The y-axis 7530 is in mm. The z-axis 7526 is in mm. These x, y and z axes comprise a coordinate space local to the transducer array.

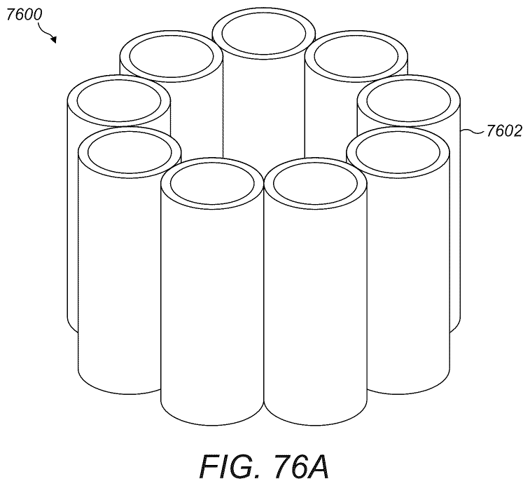

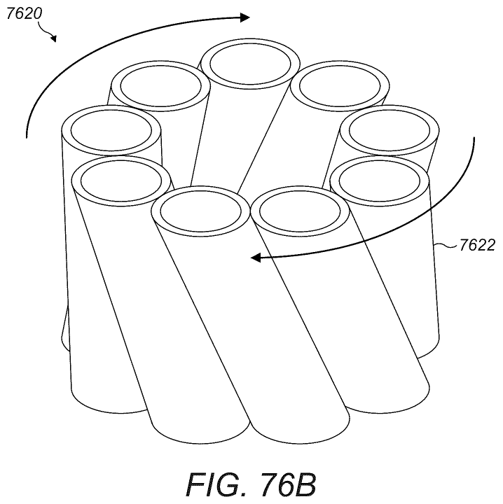

FIGS. 76A and 76B show an illustration of one possible way to encode a function of length (implying a function of attenuation) with distance from the center point of a desired window function (which may be discontinuous) whereby the inputs and outputs of the tubes constitute a continuous surface. FIG. 76A shows a schematic 7600 of a ring of waveguide tubes/horns 7602 in an annular configuration. FIG. 76B shows a schematic of waveguide tubes/horns 7620 which may have their lengths modified by twisting the ring 7622 in a helical fashion around the desired window function center point. While the individual elements in this arrangement are reconfigured, both inputs and outputs remain contiguous surfaces. This is ideal for the inputs for ease of fabrication and manufacture, whereas it is important for the outputs so as to not introduce complicated boundary conditions that may be more difficult to model and thus problematic to integrate into a given waveguide solution that embodies a window function.

An ultrasonic phased array is constructed from many individually actuated elements to generate an acoustic field via control of the phases and amplitudes of all transducer elements. If the array is concentrating energy into a focal point or beam, apodization schemes may be used to enhance the contrast between the intended high energy density region and the remaining volume. An apodization scheme essentially modulates the individual elements to create a synthetic aperture with an amplitude profile that as closely as possible resembles the time reversal of a created focus point to reduce side-lobe energy. High side-lobe energy can be viewed as being caused by ringing as a result of truncating the sampling of such a function across the synthetic aperture created by the concerted drive of the transducer elements.

While the phases and amplitudes may be modified to generated focus points and beams in different locations and directions, in general these must adhere to the amplitude profile of the time-reversal. As a result, the amplitude profile of the time reversal can be used as a spatial modulation “window function” of the driven elements which is in general similar to a two-dimensional Gaussian distribution in shape. However, as the driven elements are discrete, the samples in amplitude of the required distribution are also necessarily discrete.

By adding extra coverings on each transducer that preferentially attenuates by a small percentage in a particular spatial distribution over each discrete element which is in general driven strongly and preferentially attenuates by a large percentage in a particular spatial distribution over each discrete element which is in general driven weakly, a closer approximation to the desired amplitude profile may be obtained. This profile is then no longer spatially frequency limited to the amplitudes sampled at the discrete elements, therefore resulting in a substantial improvement in the background field generated as a consequence of concentrating energy into the high energy density region. The cost in energy due to attenuation and therefore cost in extra required transducer power is small as the strength of the required attenuation is inversely proportional to the weakness of the required drive of the discrete element.

An array must emit acoustic waves from ultrasonic transducers. Each transducer may be labelled by its position in the array, (i, j), where i=1, 2, . . . , N and j=1, 2, . . . , N permitting an N by N array. To illustrate the development of a cover material to eliminate unwanted noise the is considered where each element is driven with a complex amplitude, Âᵢⱼ. The argument or phase for each element is determined for focusing at a chosen focus location with the magnitude variable depending on the setting. Note that hatted variables denote the terms at the inlet and the unhated terms denote those at the outlet.

The grating lobes and side lobes give rise to unwanted ultrasonic interference in the fringing field and the cover material conceptualized here is designed to suppress either, or both lobes. The cover material illustrated is a waveguide, which is a duct where the transducer is at the inlet and the outlet is an open aperture. The grating lobes are eliminated by reducing spacing between each aperture to enable alias free reconstruction of signals in space. The side lobes are suppressed by designing the duct, with a given attenuation coefficient, and purposefully tapering duct lengths such that the amplitude at the aperture samples a band-limited function with favorable Fourier dual.

Fabricating the covering in a single volume is preferable to reduce manufacturing load. Thus, the waveguide may be considered a map from the inlet locations to the outlet locations, with duct lengths calculated to attenuate the so the field emitted from the aperture surface may have properties such as suppressed side lobes, minimized main lobe, or otherwise. Note the conception of a covering for both grating and side lobe suppression is illustrated, however, each may be mitigated independently with the proposed cover material. For example, a duct with no attenuation or ducts which do not vary the surface positions of the aperture.

To illustrate the waveguide, consider a rectilinear array of ultrasonic transducers, which may have varying distances between each element. The locations of the source terms are:

$${\hat{x}}_{ij} = {( i {d}_{ij} , j {d}_{ij} , 0 )}^{T} ,$$

and the waveguide mapping to the aperture location:

$${x}_{ij} = {( \frac{λ}{2} i , \frac{λ}{2} j , h )}^{T} ,$$

where dᵢⱼ is a position dependent distance parameter, λ is the wavelength and h is the height of the emitting array. Hence, the waveguide behaves as a map, W: \hat{X}→X, between the source locations and the aperture:

$$W ( {\hat{x}}_{ij} ) = {x}_{ij} .$$

The ducts of the waveguide may attenuate the acoustic wave, with the attenuation coefficient, α, given for the type of material used. The duct lengths are proportional to the difference of target amplitude and inlet amplitude to actively prescribe the amplitude at the aperture. The source amplitudes may be considered a variable and discussed later but are set as Âᵢⱼ=|1| for illustration. The aperture amplitudes are sampled from band-limited functions, or window functions, Aᵢⱼ=w(i, j). The duct lengths, lᵢⱼ, may be calculated from the following:

$${A}_{ij} = {\hat{A}}_{ij} {e}^{- α {l}_{ij}} ⇔ {l}_{ij} = \frac{- 1}{α} ln \frac{{A}_{ij}}{{\hat{A}}_{ij}} .$$

See the schematic in FIGS. 62A-62D for an illustration. Note that Âᵢⱼ may be interchanged with duct length lᵢⱼ as the parameter for ensuring the aperture amplitudes are correct. In FIGS. 62A-62D, it can be derived that the 2D planar distance rᵢⱼ the waveguide introduces is:

$$\begin{matrix}{r}_{ij} = ‖ ( {x}_{ij} , {y}_{ij} ) - ( {\hat{x}}_{ij} , {\hat{y}}_{ij} ) ‖ , \\ = ( {d}_{ij} - \frac{λ}{2} ) \sqrt{( {i}^{2} + {j}^{2} )} .\end{matrix}$$

The planar distance relates to the length and height of the duct through:

$$\begin{matrix}{h}^{2} = {l}_{ij}^{2} - {r}_{ij}^{2} , \\ = {l}_{ij}^{2} - {( {d}_{ij} - \frac{λ}{2} )}^{2} ( {i}^{2} + {j}^{2} ) .\end{matrix}$$

Rearranging gives the required source locations:

$${d}_{ij} = \frac{λ}{2} + \sqrt{\frac{{l}_{ij}^{2} - {h}^{2}}{{i}^{2} + {j}^{2}}} .$$

Alternatively, tapering of the aperture amplitudes may be achieved by varying the transducer amplitudes and accounting for the attenuation in the ducts with the following:

$${\hat{A}}_{ij} = {A}_{ij} e \sqrt[α]{{{h}^{2} + {( {d}_{ij} - \frac{λ}{2} )}^{2} ( {i}^{2} + {j}^{2} )}^{}} .$$

The analysis performed in the preceding section assumes an attenuation due to the waveguide, α, is a constant. However, the relationship of duct attenuation and length is much more complex, producing a nonlinear relationship as demonstrated in FIG. 64.

Sophisticated modelling is required to account for the nonlinear insertion loss generated by a conical duct with an outlet. In L. Beranek and T. Mellow, Acoustics: Sound Fields and Transducers, Academic Press, 20 Sep. 2012, the pressure and particle velocity of an acoustic wave in a duct may be derived from the transfer matrix method. The system considered is that in schematic 5, with the formula for a divergent conical duct given as:

$$[ \begin{matrix}{p}_{i} \\ {u}_{i}\end{matrix} ] = [ \begin{matrix}{a}_{11} & {a}_{12} \\ {a}_{21} & {a}_{22}\end{matrix} ] [ \begin{matrix}{p}_{m} \\ {u}_{m}\end{matrix} ] ,$$

where p, u represent the pressure and the particle velocity of the acoustic field and subscript i denotes inlet variables and m denotes variables at the mouth of the duct. The radius, r, surface area, s=πr², duct length, l, density, ρ₀, wavenumber, k, and speed of sound, c, parameterise the matrix entries. The matrix entries are:

$${a}_{11} = \sqrt{\frac{{s}_{m}}{{s}_{i}}} ( cos ( k l ) - \frac{sin ( k l )}{k {r}_{m}} ,$$

$${a}_{12} = i {ρ}_{{0}^{C}} ( \frac{sin ( k l )}{\sqrt{{s}_{m} {s}_{i}}} ) ,$$

$${a}_{21} = i ( \frac{\sqrt{{s}_{m} {s}_{i}}}{{ρ}_{0} c} ) [ ( \frac{1}{k {r}_{m}} - \frac{1}{k {r}_{i}} ) cos ( k l ) + ( 1 + \frac{1}{{k}^{2} {r}_{m} {r}_{i}} ) sin ( k l ) ] ,$$

$${a}_{22} = \sqrt{\frac{{s}_{m}}{{s}_{i}}} ( cos ( k l ) + \frac{sin ( k l )}{k {r}_{i}} ) .$$

This formula may be rearranged to the convergent conical duct setting here:

$$[ \begin{matrix}{p}_{m} \\ {u}_{m}\end{matrix} ] = {[ \begin{matrix}{a}_{11} & {a}_{12} \\ {a}_{21} & {a}_{22}\end{matrix} ]}^{- 1} [ \begin{matrix}{p}_{i} \\ {u}_{i}\end{matrix} ] .$$

The inclusion of an opening in a duct:

$$[ \begin{matrix}{p}_{0} \\ {u}_{o}\end{matrix} ] = [ \begin{matrix}1 & Z \\ 0 & 1\end{matrix} ] [ \begin{matrix}{p}_{m} \\ {u}_{m}\end{matrix} ] ,$$

$$with Z = \frac{π {f}^{2} {ρ}_{0}}{c} + i 0.2626 {ρ}_{0} , with frequency f .$$

The modelled relationship of a duct of varying length with an inlet radius of rᵢ=4.25 mm and an outlet radius of r₀=2.3 mm is shown in FIGS. 64-68. The range of duct lengths is restricted to manufacturable lengths to illustrate the attenuation response of duct length on the emitted pressure.

A smooth relationship may be found by applying a moving average to the data or by taking the mean of the oscillatory data to locate an underlying linear response. The derivation of a smooth approximation enables the manufacturability of duct length being proportional to the attenuation required to generate an overall apodization scheme across the array. The implication of the cover application means that the emitted acoustic field may have desirable properties such as grating and side lobe mitigation (Gibbs ringing). Note the smooth attenuation response approximation introduces an error in the target amplitudes which may be calibrated out by adjusting the amplitude of the source term, via a calculation or an experimental validation step.

Instead, to eliminate the calibration step to minimize error the duct lengths are derived accounting for the oscillatory behavior. To do so an algorithm has been developed. Initially simulation of conical duct behavior has been validated by comparison to the Mode Matching Method (MMM) which has been implemented in Kolbrek I and verified in Kolbrek II. The transfer matrix method and the MMM both exhibit oscillatory behavior in the attenuation of the acoustics within the duct. Therefore, not accounting for the oscillatory response in the determining duct lengths for an appropriate window would incur some error, which may be calibrated out by adjusting the source amplitudes. Alternatively, the duct lengths can be calculated to replicate a window function exactly by including the oscillatory behavior in deriving the duct lengths. To do so, a sufficiently sampled set of duct lengths is simulated, as seen in FIG. 69, then interpolated to a higher resolution. The nearest duct lengths to generate amplitudes from set of desired target amplitudes may be found by simply iterating and locating the minimum. The error is then controlled by the number of sample and interpolation points. Application of this process generates an exact replication of any window function, or band-limited function, by a passive waveguide design.

The approach undertaken here has focused on amplitude modulation via an acoustic waveguide of varying lengths. However, an alternative approach may be done through the manipulation of thermos-viscous losses within the ducts. Manipulation of thermos-viscous effects may be done through variation of the duct diameter or perforation of the duct walls.

The effect of this on the fringing field can be seen in FIGS. 72A, 72B, 73A, 73B, 74A, 74B, 75A, 75B. FIGS. 72A and 72B show the fringing field with no covering applied and a uniform set of transducer elements, resulting in a field which permits ultrasonic microphone interference. FIGS. 73A and 73B show a covering which does not apply a window but maps the source terms to be critically spaced, resulting in a reduction to FIGS. 72A and 72B but still permits interference. FIGS. 74A and 74B show a covering which applies an amplitude modulation but does not remap the element positions, this retains the interference causing grating lobes. Finally, FIGS. 75A and 75B show shows the covering conceptualized here, with critical spacing and a window applied; this covering results in field which produces no ultrasonic interference.

### Waveguide Helicity as a Strategy for Passive Waveguide Duct Length Control

One of the methods to enable control over duct length that permits both continuous and discontinuous changes in duct length with direct distance from a window function center point may be control over global helicity in duct outlet position. As shown in FIG. 76, changes the length of the duct may be achieved by increasing the helicity in particular annular rings of an array in an annular configuration—as each duct outlet is a set distance from the origin point, but also each duct inlet is a set distance also, each duct must have the same length modification applied which may be achieved using the shown method. By wrapping ducts with helicity around a hypothetical cylinder or cone portion centered on the origin point, their lengths may be changed by the same controlled amount, which allows each ring to be individually tuned. This may be considered to be a cone in the cases where the ducts are tapered or flared, and while the surface of the inputs and outputs remain contiguous in this case, the total area of these surfaces are modified—the output surface is increased if the ducts become larger towards the output, and decreased if the ducts narrow towards their output.

### VII. Conclusion

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method comprising:
implementing a phased array of at least two ultrasonic transducers for exerting an acoustic radiation force to at least one control point in midair, wherein phases from ultrasonic waves have at least one side lobe region emitted by the at least two ultrasonic transducers are adjusted such that the ultrasonic waves arrive concurrently at the at least one control point;
locating the at least one side lobe region by:
taking a series of sample points, wherein the series of sample points are at least 2 per wavelength of the ultrasonic waves;
removing a main lobe if it is present in the series of sample points to produce a second series of sample points;
calculating a Gibbs Metric for the second series of samples points.

2. A system comprising:
a phased array of at least two ultrasonic transducers for exerting an acoustic field to at least one control point in midair, wherein phases from ultrasonic waves having side lobes emitted by the at least two ultrasonic transducers are adjusted such that the ultrasonic waves arrive concurrently at the at least one control point, and wherein the acoustic field has at least one null region;
wherein apodization of the phased array in an orthogonal direction to the at least one null region reduces the side lobes.

3. The system as in claim 2, wherein the at least one null region comprises at least two different positions of quiet regions.

4. The system as in claim 2, wherein the at least one null region comprises superpositions of multiple quiet regions.

5. The system as in claim 2, wherein the apodization is only applied to a subdomain of the phased array.

6. The system as in claim 2, wherein the phased array has an x-axis and a y-axis, and wherein the apodization is targeted at a volume that is not directly aligned with the x-axis and the y-axis.

7. The system as in claim 2, wherein the apodization comprises superposition of axial apodization to generate at least two null regions.

8. The system as in claim 2, wherein the apodization is one-dimensional and has an apodization axis, and wherein the apodization axis is curved.

9. A system comprising:
a phased array of at least two ultrasonic transducers for exerting an acoustic field to at least one control point in midair, wherein phases from ultrasonic waves having side lobes emitted by the at least two ultrasonic transducers are adjusted such that the ultrasonic waves arrive concurrently at the at least one control point;
wherein at least one ultrasonic transducer is at least one inoperative transducer;
wherein apodization of the phased array is adjusted to reduce the side lobes while compensating for the at least one inoperative transducer.

10. The system as in claim 9, wherein the compensating for the at least one inoperative transducer comprises generating a two-dimensional window function that places a zero-driving amplitude for each of the at least one inoperative transducer.

11. The system as in claim 10, wherein the compensating for the at least one inoperative transducer further comprises local modification to the apodization around each of the at least one inoperative transducer.

12. The system as in claim 11, wherein the local modification uses boundary conditions in a discretized Helmholtz equation.

13. The system as in claim 11, wherein the local modification uses a boundary value problem on a discretized differential equation.

14. The system as in claim 11, wherein the local modification uses a discrete convolution with boundary effects and enforced amplitude on selected points.

15. The system as in claim 11, wherein the local modification uses a moving average with boundary effects and enforced amplitude on selected points.

16. A system comprising:
a phased array of at least two ultrasonic transducers for exerting an acoustic field to at least one control point in midair, wherein phases from ultrasonic waves emitted by the at least two ultrasonic transducers are adjusted such that the ultrasonic waves arrive concurrently at the at least one control point;
an acoustic structure that amplifies acoustic radiation within a specific region by diverting acoustic energy from other regions into the specific region without use of electrical power;
wherein the acoustic structure is shared between multiple elements in the phased array thereby increasing an effective area of the acoustic structure without increasing spacing between the at least two ultrasonic transducers.

17. A system comprising:
a phased array of at least two ultrasonic transducers for exerting an acoustic field to at least one control point in midair, wherein phases from ultrasonic waves having grating lobes and side lobes emitted by the at least two ultrasonic transducers are adjusted such that the ultrasonic waves arrive concurrently at the at least one control point;
wherein the at least two ultrasonic transducers are connected to at least two waveguide ducts, with each of the at least two ultrasonic transducers is an inlet for each of the at least two waveguide ducts, and an open aperture is an outlet for each of the at least two waveguide ducts;
wherein the grating lobes are reduced by reducing spacing between each open aperture to enable alias free reconstruction of the ultrasonic waves;
wherein the side lobes are reduced by tapering lengths of the at least two waveguide ducts such that an amplitude at each open aperture samples a band-limited function.

18. The system as in claim 17, wherein the at least two waveguide ducts attenuate the ultrasonic wave.

19. The system as in claim 17, wherein the outlet of each of the at least two waveguide ducts is a set distance from an origin point, and wherein the inlet of each of the at least two waveguide ducts is the set distance from the origin point.

20. The system as in claim 19, wherein each of the at least two waveguide ducts is wrapped with helicity around a hypothetical cylinder or cone portion centered on the origin point
